(19) United States
(12) Patent Application Publication
(10) Pub. No.: US 2026/0097897 A1
(43) Pub. Date: Apr. 9, 2026

(54) HANGING-BAG WAREHOUSE SYSTEM FOR STORING, PICKING, SORTING AND RETRIEVING STORAGE GOODS

(71) Applicant: EMHS GmbH, Karlsbad (DE)

(72) Inventors: Felix THEURER, Pforzheim (DE); Dominik GEYER, Keltern (DE); Michael SCHICK, Stuttgart (DE); Frederic MÜLLER, Karlsruhe (DE); Kai PFISTER, Lübeck (DE); Viktor HERZOG-LANG, Keltern (DE); Vincent David HERZOG, Konstanz (DE); Rene BRADE, Eppingen (DE); Robin LUCKEY, Lübeck (DE)

(73) Assignee: EMHS GmbH, Karlsbad (DE)

(21) Appl. No.: 18/997,765

(22) PCT Filed: Jul. 21, 2023
(86) PCT No.: PCT/EP2023/070281

§ 371 Date: Jan. 22, 2025

(30) Foreign Application Priority Data
Jul. 22, 2022 (DE) 10 2022 002 686.4
Jul. 22, 2022 (DE) 10 2022 002 687.2
Jul. 22, 2022 (DE) 10 2022 002 688.0
Jul. 22, 2022 (DE) 10 2022 002 689.9
Jul. 22, 2022 (DE) 10 2022 002 690.2
Jul. 22, 2022 (DE) 10 2022 002 691.0
Feb. 24, 2023 (DE) 10 2023 000 660.2

(51) Int. Cl. B65G 1/04; B65G 1/137

(52) U.S. Cl. CPC B65G 1/0457; B65G 1/137; B65G 2201/0238

(57) ABSTRACT

A hanging bag storage system serves to store, pick, sort and retrieve storage articles. A method includes providing a control device, by which the storing, picking and sorting of the storage articles can be controlled and/or a sequence of the storage articles for the retrieval can be specified. A plurality of roll adapters and hanging bags suspendible on the plurality of roll adapters, wherein the roll adapters or the hanging bags comprise respectively one cotraveling longitudinal and transverse dynamics control and a communication device and wherein at least one of the storage articles can be received and retrieved again in the hanging bags. The hanging bag storage includes a first level, a network, and at least one block, in which the hanging bags can be deposited, stored without movement, and fetched again.

### CROSS-REFERENCE TO RELATED APPLICATIONS

The present application refers to and claims the priorities of the German patent applications 2022 002 686.4, 10 2022 002 687.2, 10 2022 002 688.0, 10 2022 002 689.9, 10 2022 002 690.2 and 10 2022 002 691.0, all filed on Jul. 22, 2022, as well as 10 2023 000 660.2, filed on Feb. 24, 2023, wherein the disclosure content of all these patent applications in its entirety is hereby expressly incorporated as subject-matter of the present application.

### FIELD OF THE DISCLOSURE

The disclosure relates to a hanging bag storage system for storing, picking, sorting and retrieving storage articles, as well as roll adapters, hanging bags and hanging bag storage cooperating in this hanging bag storage system, and methods according to the device.

### BACKGROUND

In automated article storages, production facilities and during the transport of articles such as, for example, in the mail-order business, it is required to receive articles in article containers and unload articles from article containers in a manner that is as automated as possible. In these article containers, the articles can be stored before being delivered and will thus reach the station in which they are packaged for the onward transport to the customer. The transport inside the storages is usually executed by overhead conveying devices. Here, the article containers are mostly bags which are manufactured like fabric bags and are hooked into a rail system with a type of wire hanger at the top. Such an article container is known, for example, from WO 2014/012965 A1. A rod assembly is used to control the lateral wall elements of the article container such that the lateral wall elements, which are interconnected by a connection region, can be opened. In the region of a loading station, the containers are additionally brought into a horizontal or inclined position.

Comparable article containers and associated overhead conveying devices are known, for example, from DE 10 2004 018 569 A1, EP 2 130 968 A1 or EP 2 196 415 A. The transport bags described therein consist of flexible materials in the form of a loop, in which the article is held. For loading, these transport bags are opened from above in order to be able to insert the article into the loop. An unloading is done by the article being either removed or ejected sideways from the loop or the loop being opened downward, for example according to EP 2 130 968 A1. Further, an article carrier which has a relatively stiff and flat plastic wall with a cutout for loading and unloading articles is known from DE 103 54 419 A1.

Other article containers are manufactured like hanging, flat tubs of plastic which are unilaterally covered with elastic fabrics, whereby the article is wedged in.

It is known to load such article containers in a mechanized manner and unload them again manually. A transport cycle is determined by the slowest operation, which also depends on the quantity of transported articles. In particular a high number of individual articles can slow down the loading and/or unloading. For example, the unloading and/or the assembling of dismantled transport containers can determine the maximum possible transport cycle. EP 2 686 258 B1 relates to an overhead conveying system having a transport bag for the automated unloading of a loaded unit load and having an unloading station. The transport bag has a horizontal bottom on which the unit load can be stored for transport purposes. The bottom cooperates with a lifting device which is configured for lifting the bottom of the transport bag loaded with at least one unit load in a vertical direction when the transport bag is in an unloading position such that the at least one unit load can be centrally pushed out through an end face of a main body of the transport bag using a pushing device, wherein the pushing device comprises a slider which engages with an interior of the main body through a different end face of the main body where the at least one unit load is located when the bottom is lifted. This means that the two opposite, opened end faces, the bottom that is liftable in the vertical direction as well as the slider of the pushing device reaching through one of the end faces are required for unloading. Known from DE 20 2017 100 206 U1 is an article container for an overhead conveying device for transporting articles which can be adjusted between an opened position and a closed position. The article container has a bottom which is mechanically assigned to an ejection device. Using the ejection device, the bottom can be adjusted between a transport position, in which the article can be stored inside the article container, and an ejection position, in which the article can be ejected from the article container.

Known from DE 10 2018 105 795 A1 are a method for loading or unloading an article received on a flexible material of an article container using a station such as an unloading station and/or a loading station of an overhead conveying system, and an article container, unloading station and overhead conveying system according to the method. The article container is brought close to the station, where a force of attraction between the station and the article container for coupling the flexible material of the article container is then produced. The article container thus coupled is inclined and the article is ejected from the article container in a sliding motion.

DE 10 2018 128 417 A1 describes a method for transporting and sorting a sorter bag suspended on a roll adapter rolling on a rail network of a sorting plant for transporting a unit load, by provisioning the rail network of the sorting plant, provisioning the roll adapter of the sorter bag rolling on the rail network, provisioning an electrical drive energy for the roll adapter, converting the provisioned electrical drive energy to a kinetic energy for transporting the sorter bag using the roll adapter itself, and devices according to the method. The roll adapters serve to suspend and move the sorter bags. To that end, the roll adapters each comprise a chassis with two coaxially revolving wheels, a suspension arranged between the wheels and supported by the wheels on which the sorter bag is suspended, an electrical drive for driving the wheels and a control device or partial control device for autonomously or at least partially autonomously controlling the roll adapter along a travel path selected from a plurality of travel paths.

It is further known for industrial objects to communicate with one another according to a network standard, which is also referred to as the industrial internet of things (IIoT).

### OVERVIEW OF THE DISCLOSURE

Starting from this prior art, the object underlying the present disclosure is to improve the storing and retrieving of storage articles from a hanging bag storage having one or multiple levels in a specified or specifiable sequence, in particular shortening a picking time for retrieving a specified or specifiable sequence, preferably while providing a minimal sorting effort and/or minimal use of energy and/or a high flexibility, in particular to further improve the retrieval of storage articles in the specified or specifiable sequence, preferably continuous sequence, from the hanging bag storage, in particular to enable a handover to another element of the hanging bag storage while providing sorting, in particular to enable a more flexible response to any deviations from the sequence and/or a higher capacity utilization, in particular to enable a storage and retrieval with simultaneous sorting of storage articles in a hanging bag storage with as little effort as possible, preferably in a space-saving manner, and in as short a time as possible, in particular to enable a non-crossing or at least minimally crossing traffic for sorting and rearranging the storage articles on shunting routes and a relatively quick retrieval operation using express routes, and preferably to generally achieve a higher overall performance of the hanging bag storage in relation to storage and retrieval times and resorting operations of the storage articles, in particular, in a hanging bag storage having a high number of autonomously or at least partially autonomously displaceable hanging bags, in particular at least 10,000 and up to 1.5 million of the hanging bags, to be able to communicate with the autonomously or at least partially autonomously displaceable hanging bags in particular with a density of up to 20 participants per meter in x-direction, in particular between 10 and 20, individually with a transmitting power density that is as low as possible and a data rate that is as high as possible, in particular to coordinate the plurality of autonomously displaceable hanging bags located in the hanging bag storage, preferably to control flows of storage articles received in the hanging bags with an effort that is as low as possible.

The object is achieved in a hanging bag storage system for storing, picking, sorting and retrieving storage articles by a control device, by which the storing, picking and sorting of the storage articles can be controlled and/or a sequence of the storage articles for a retrieval of the storage articles can be specified, a plurality of hanging bags that are suspendible or suspended on roll adapters, wherein the roll adapters or the hanging bags comprise respectively one cotraveling longitudinal and transverse dynamics control and a communication device and wherein at least one of the storage articles, respectively, can be received and retrieved again in the hanging bags, a hanging bag storage, which cooperates with the plurality of hanging bags for storing, picking and sorting the storage articles, with: a level and a network, on which the hanging bags can be displaced autonomously or at least partially autonomously using the respectively cotraveling longitudinal and transverse dynamics control, and at least one block, in which the hanging bags can be deposited, stored without movement, and fetched again for the retrieval. When a sequence is specified, the combination of the autonomously traveling roll adapters and the block results in a particularly high flexibility, good picking times and a relatively low energy consumption. Hanging bags and/or storage articles that are currently not required need not be moved along, whereby a relatively low energy consumption and/or wear is enabled.

In an alternative embodiment of the hanging bag storage system, it is provided that the hanging bags stored in the block can be fetched again for the retrieval by a fetch command that can be received by the communication device. Stored articles can thus be fetched in a centrally controlled manner.

In another configuration, it is possible for the fetch command to be sent from the control device to the communication device of the respective hanging bag using a route or a wireless route. Generally, the fetch command can be executed using at least one route, in particular radio link, but preferably also using multiple routes, for example radio links. A transmission reliability can thus be improved.

Furthermore, it is conceivable that the network or at least the block of the network is designed so as to be horizontal or at least essentially horizontal. A space-saving hanging bag storage system can thus be realized. What is more, a parking brake on the hanging bags and/or the roll adapters can be relinquished, since a driveless, merely gravity-induced rolling cannot occur.

Another embodiment of the hanging bag storage system has at least one second level, in which the hanging bags and thus the storage articles can be received, respectively, wherein the hanging bags with the storage articles can be provisioned for the imminent retrieval in the respective level of the hanging bag storage, and a conveying plant, vertical conveying plant and/or circular conveying plant arranged between the levels for conveying the storage articles between the levels. A vertically available installation space for the hanging bag storage system can thus be utilized in an optimal manner, i.e. as many storage locations and/or sorting capacities as possible can be created on an available base area.

Another alternative configuration of the hanging bag storage system is characterized in that the specifiable or specified sequence of the storage articles for the retrieval across the level and the at least one second level can be created and/or is created using at least five elements of the hanging bag storage of the following group:—at least one of the blocks arranged in the level, at least another one of the blocks arranged in the at least one second level,—at least one handover configuration for creating and provisioning the hanging bags for the retrieval in a subsequence of the handover configuration of the level, and/or which is arranged downstream of the one of the blocks,—at least one second handover configuration for creating and provisioning the hanging bags for the retrieval in a subsequence of the second handover configuration of the second level arranged in the at least one second level, and/or which is arranged downstream of the at least one other one of the blocks,—the conveying plant, vertical conveying plant and/or circular conveying plant arranged between the levels and/or arranged downstream of the handover configurations for conveying the storage articles between the levels, and/or wherein the sequence can be created and/or put together and/or assembled from the subsequences of the provisioning devices by the conveying plant, vertical conveying plant and/or circular conveying plant. It is conceivable that parts provided for the storage and/or sorting, in particular closed routes and/or circuits which can be endlessly traveled on in the blocks and the handover configurations, are equally provided, in particular in different dimensioning. For example relatively larger in the blocks and relatively smaller in the handover configurations. The blocks and the handover configurations can be operated with the same strategy, wherein a control effort can be reduced. To optimize a and/or adapt to a flow direction of the storage articles through the hanging bag storage, the circuits and/or endless routes of the blocks and of the handover configurations can be designed so as to be oblong and arranged in parallel in a longitudinal direction, respectively, or at an angle of 90 degrees to one another.

Alternatively or additionally, it can be provided in the hanging bag storage system that the hanging bags can be displaced into the at least one block using the cotraveling longitudinal and transverse dynamics control and deposited, stored without movement and fetched again in a manner controlled by the control device. A complex conveying system such as drag chains, pusher dog systems and suchlike can thereby be relinquished. The network and/or the block of the hanging bag storage is/are preferably passive, so that adjustment elements at the network can also be relinquished. Control operations can be executed by the cotraveling transverse dynamics control without a central control effort by the control device.

Finally, it is conceivable that the hanging bags in the at least one block can be brought into a power-saving rest state. Additional energy can thus be saved. The idle state can preferably be used in the standstill during a storage in order to save energy. For a fetching and/or a retrieval, the hanging bags can be woken up again.

The object is furthermore achieved in a hanging bag storage of a hanging bag storage system or of a hanging bag storage system described above by the block having at least one or a plurality of closed route(s), wherein the closed route(s) can be endlessly traveled on by the hanging bags or by the roll adapters with suspended hanging bags, has/have an entry or the entry and an exit as well as a stopping point or an imaginary stopping point, at which one of the hanging bags can be stopped and/or be provisioned for a leaving of the closed route(s) depending on the control device and all other hanging bags in the respective closed route can also be stopped only depending on the state of the one of the hanging bags or only depending on the state of the one of the hanging bags and on respectively cotraveling longitudinal dynamics controls of the roll adapters of the other hanging bags. This enables a radio traffic density to be reduced further. The traveling on the closed route does not require global communication, the halting by the stopping at the stopping point merely a global communication between control device and the corresponding hanging bag. This communication can take place already before, during a transmitting of a travel command, preferably outside of the block. This enables a radio traffic density in the block which can execute a sorting of the hanging bags to be reduced further. Also the advantages described above result from the hanging bag storage system.

According to an alternative, it is conceivable that the hanging bags or roll adapters with suspended hanging bags located in the block are configured for taking the states of the following group and comprise at least one of them in the block: stored without movement by halting if a front hanging bag blocks the network of the block, depending on the cotraveling longitudinal dynamics control, preferably only depending on the cotraveling longitudinal dynamics control; stored without movement and stopped at the stopping point or the imaginary stopping point depending on the non-cotraveling control device and/or stopped and provisioned there for leaving the closed route; ready to receive from the non-cotraveling control device, preferably for traveling to the stopping point and/or a destination; addressed for a retrieval operation depending on the non-cotraveling control device; in motion for entering the closed route, preferably on the entry, depending on the non-cotraveling control device; in motion for leaving the closed route, in particular on the exit; in motion for leaving the stopping point or the imaginary stopping point, preferably on the exit, depending on the non-cotraveling control device; supplied with current by an electrical energy; in motion for the endless traveling on the closed route after the entering only depending on the cotraveling longitudinal and transverse dynamics control. The global control device is not required for the halting and the endless traveling on the closed route. This enables a radio traffic density to be reduced, wherein hanging bag storages with a large number of hanging bags, for example more than 500,000, in particular more than 1,000,000, and a good scalability become possible.

A preferred exemplary embodiment of the hanging bag storage is designed such that the imaginary stopping point can be transmitted to the roll adapter as a destination point of a travel instruction or can be transmitted to the roll adapter as a destination point of a travel instruction using the control device and/or the stopping point is part of the network and can be controlled by the control device. It is therefore conceivable that the stopping point is realized in a virtual and/or imaginary manner only through a control by the control device, in particular such that hanging bags entering the block receive the stopping point as a destination and travel autonomously to the stopping point. Alternatively, the stopping point can be a part of the network, for example in the form of a device which issues the command to halt to a hanging bag and/or to an approaching roll adapter with suspended hanging bag, in particular in a manner controlled by the control device. This can be executed, for example, by a mechanical intervention or an intervention in terms of data technology which can be acquired by the roll adapter and converted into the halting.

In another exemplary embodiment, it is possible that the closed route comprises a storage route, a shunting route crossing the storage route, another storage route crossing the shunting route, and another storage route. The closed route can be formed simply by crossing travel paths and be endlessly traveled on using the cotraveling transverse dynamics control.

The object is further achieved in a roll adapter for a hanging bag which cooperates with a hanging bag storage described above in that the longitudinal dynamics control of the roll adapter comprises a distance control, which controls a speed of the roll adapter depending on an object and/or front roll adapter located in front of the roll adapter viewed in a direction of travel and/or controls a distance to the other roll adapter. The distance control enables the roll adapter to halt without global communication. In particular whenever the closed route is blocked due to the halting at the stopping point. Here, it is possible to let other ones of the hanging bags enter the closed route despite the halting. To that end, the entry and exit can be arranged so as to be spaced apart from each other. The exit can have a distance that is as great as possible, preferably a maximal distance, downstream of the entry and a distance that is as small as possible, preferably a minimal distance, upstream. This enables the entry to remain vacant despite the halted hanging bags, so that as many of the hanging bags as possible can enter the closed route. This can keep an express route as free from congestion as possible for the purpose of the inflow or outflow.

In one exemplary embodiment of the roll adapter, it is provided that the longitudinal dynamics control of the roll adapter regulates the speed to zero if the front roll adapter has a speed of zero and an actual distance of the roll adapter to the front roll adapter is below a specifiable or specified minimum distance. A measurement required to that end can preferably take place without, or with a relatively low, radio power, so that the hanging bags on the closed route halt, wherein no, or only a minimal quantity of, radio power need be used.

Furthermore, it is provided in one exemplary embodiment that the roll adapter has at least one of the following states and/or is configured, designed and/or programmed for taking the states and/or these states can electively be taken by the roll adapter: automatic halting or decelerating if the front roll adapter blocks the network; storing a travel instruction for and/or endless traveling on a specified or specifiable closed route; halting at a specifiable or specified stopping point of the closed route or halting at the stopping point depending on the controller; leaving the closed route, preferably starting from the stopping point in a direction of a specifiable or specified destination point depending on the controller or crossing one of the shunting routes and/or turning into one of the express routes for leaving the closed route; entering the closed route depending on the control device. This enables the roll adapter, after a single programming with a travel instruction for entering the closed route, to travel autonomously on the closed route without any further connection to the control device and/or travel instruction until the control device addresses the roll adapter with a new travel instruction for retrieval. In this case, the autonomous traveling on the closed route can take place using the cotraveling longitudinal and transverse dynamics control. Particularly preferably, it is conceivable that the sorting and storing of the hanging bag takes place in a multi-stage manner, in particular in the blocks and in the handover configurations arranged downstream of the blocks. Preferably across multiple levels together with the vertical conveyor. The vertical conveyor transports the roll adapter together with the hanging bag and the storage article contained therein. Two or multiple sorting elements, in particular endless routes, can be arranged and/or used in succession and simultaneously in parallel. For example, it is conceivable to address two or multiple of the storage articles in parallel from two blocks or from two or multiple of the closed routes from one block and relocate them into another endless route of a handover configuration arranged downstream of both. This can electively take place additionally in multiple of the levels in parallel, whereby the sequence can be generated in the level or a plurality of subsequences can be generated in case of multiple levels, which subsequences can then be fitted together using the downstream vertical conveyor to form the desired sequence of the storage articles. Just like the blocks, the respective handover configuration comprises in particular multiple of the sorting elements, in particular sorting elements arranged in parallel, in particular the closed routes. This enables the storing, retrieving and sorting of the hanging bags and thus the storage articles contained therein to take place in parallel. A high performance of the hanging bag storage system can thus be achieved.

The object is further achieved in methods for controlling a hanging bag storage or for controlling a hanging bag storage described above by: entering the closed route by the roll adapter; transmitting an endless travel instruction to the roll adapter which says that the closed route is to be traveled on endlessly; endless traveling on the closed route; transmitting a retrieval travel instruction to a retrieval destination to the roll adapter for a retrieval; leaving the closed route and traveling toward the retrieval destination according to the travel instruction for the retrieval of the roll adapter. This enables the endless route to be traveled through autonomously without any other contact to the control device. To that end, only a maximum of two contacts to the control device are required: an instruction to enter the endless route and circulate there and another instruction to leave the endless route again. It is conceivable that, to that end, only locations are specified and the hanging bags and/or the roll adapters travel autonomously toward the specified locations, in particular with knowledge of the network, in particular of the block and the knowledge and/or a previously deposited routine to circulate there. The method can in particular be executed on and/or using the hanging bag storage described above. This results in the advantages described above.

One embodiment of the method is characterized by interrupting the endless traveling if the front roll adapter is located in front of the roll adapter and has a speed of zero; and resuming the endless traveling if the front roll adapter has a speed greater than zero again. This can be executed using the respectively cotraveling longitudinal dynamics control, i.e. without burdening the central control device.

In another alternative configuration of the method, a scheduling of the roll adapter for the retrieval, a transmitting of an intermediate travel instruction to the scheduled roll adapter with the stopping point as a destination, a moving of the roll adapter to the stopping point and a halting of the roll adapter at the stopping point are conceivable. In this case, the intermediate travel instruction of the control device enables all hanging bags located in the closed route to be halted. Here, a wear and an electricity need can be reduced until one of the hanging bags is actually to leave the closed route again. The hanging bag to leave is in particular the hanging bag located at the stopping point and/or already scheduled for the next retrieval.

The method can be executed in another alternative by scheduling the roll adapter for a retrieval, transmitting a retrieval travel instruction to a retrieval destination to the scheduled roll adapter after transmitting an intermediate travel instruction, leaving the stopping point and then leaving the closed route while traveling toward the retrieval destination according to the retrieval travel instruction. The retrieval travel instruction can in particular be issued with a delay, wherein the hanging bag communicated with by the control device through the intermediate travel instruction can already advance to the stopping point in preparation. The stopping point is preferably located close to the exit, so that the retrieval destination can be reached more quickly. Particularly preferably, the closed route can have a U-shaped design and be used as a first in, first out buffer, wherein the entry and the exit are preferably arranged at an open end of the U-shaped design. This ensures that a maximally long route and therefore maximal capacity available for the buffering of the hanging bags forms between the entry and the exit.

Another embodiment of the method can be executed by transmitting the intermediate travel instruction to a random roll adapter traveling on the closed route if no scheduling for the retrieval has been or is currently being executed, and/or transmitting the intermediate travel instruction to the stopping point as a destination and/or transmitting the endless travel instruction to the random roll adapter if the roll adapter is scheduled for the retrieval, and/or endless traveling on the closed route by the random roll adapter according to the endless travel instruction; direct leaving of the stopping point by the random roll adapter.

Finally, the method can be executed by repeating the method for a plurality of retrievals, transmitting the intermediate travel instruction to the random roll adapter traveling on the closed route or to the roll adapter scheduled for the retrieval and transmitting the endless travel instruction to all remaining ones of the roll adapters traveling on the closed route. This ensures that the roll adapters halt even if none of the hanging bags are currently scheduled and waiting for the final retrieval at the stopping point. In this case, the random roll adapter and/or hanging bag is sent to the stopping point and halted there, wherein all advancing hanging bags automatically halt too.

The object is further achieved in a method for retrieving storage articles from a hanging bag storage having hanging bags or a hanging bag storage of a hanging bag storage system described above by provisioning a first handover buffer in a first level of the hanging bag storage,
provisioning at least one second handover buffer in a second level of the hanging bag storage,
specifying a sequence of the storage articles for an imminent retrieval,
provisioning the storage articles in the handover buffers of the respective level of the hanging bag storage for the imminent retrieval,
provisioning a series of storage locations for receiving at least one of the storage articles, and directing the series of storage locations past the handover buffers while
handing over the storage articles provisioned in the handover buffers from the respective handover buffer to the storage locations, in the specified sequence, respectively.

This offers the advantage that storage articles can be retrieved from each level with only one series of storage locations while, in addition to the transporting away, also a sorting function can simultaneously be fulfilled. In the hanging bag storage, the articles are provided unsorted and can be sorted into the series by provisioning the articles in the handover buffers and singling the articles out of the handover buffers. After the transporting away, the storage articles are advantageously available in the series of storage locations in an ordinally specified and/or specifiable sequence.

In one exemplary embodiment, there is an assigning of ordinal sequencing criteria of the sequence to the empty storage locations of the series,
an assigning of the same sequencing criteria to the individual storage articles,
and a sorting of the storage articles into the series while being directed past as soon as the sequencing criteria of a storage location traveling past and of the storage article waiting in the handover buffer match. This means that storage locations will electively remain temporarily vacant and are filled as and when they travel past a storage article waiting accordingly in the corresponding following level. Therefore, it is advantageously possible to enable a continuous lining up of the storage articles in the series by a single directing past. This enables the storage articles to be provisioned, for example retrieved from the series, in the desired ordinal sequence. This sorting is executed very quickly and with low susceptibility to faults.

Preferably, storage articles waiting in the respective handover buffers are presorted according to the ordinal sequencing criteria. This ensures that a waiting time can be utilized until the corresponding storage article is picked up and/or handed over into the series. The method can furthermore be rendered more robust against disruptions in that an arrival time of a storage article can be uncoupled and/or can differ from a handover time from the handover buffer into the series.

In a particularly preferred exemplary embodiment, the storage articles are provisioned while respectively located in one of the hanging bags of the hanging bag storage and the respective entire hanging bag along with the respective storage article is handed over from the respective handover buffer into the storage locations. To sort the storage articles, the storage articles can advantageously remain in the hanging bags, wherein handling costs for a saved rearranging can be saved. Particularly preferably, there is an autonomous driving, controlling and/or moving of the entire hanging bag before the provisioning, during the provisioning and/or handing over of the hanging bag. The method is in particular executed without trail chains.

Alternatively or additionally, a circular conveying plant is used for interlinking the series. The circular conveying plant can be a vertical conveying plant, for example a paternoster which comprises storage locations arranged vertically on top of one another for precisely one hanging bag each. These storage locations are preferably circularly interlinked. This enables the storage articles, in particular along with the hanging bags transporting the storage articles, to be transported in a sequence and provisioned at a retrieval point of the circular conveying plant in this sequence.

Another embodiment is executed with a vertical conveying of the series using the circular conveying plant and arranging the handover buffers on top of one another in the levels of the hanging bag storage. This enables storage articles to be retrieved from multiple levels and simultaneously sorted. This provides the possibility of a high retrieval and sorting speed, wherein the storage articles can be stored unsorted and distributed over different levels of the hanging bag storage. The arrangement and/or distribution of the individual storage articles inside the hanging bag storage can therefore be selected freely, without the retrieval speed being affected at 100% sorting quality.

Another advantageous possibility is to hand over more than one of the storage articles from the respective handover buffer into the corresponding one of the storage locations of the series and/or handing over the storage articles so as to be already presorted. This enables a conveying speed to be scaled according to the available storage locations, wherein the advantageous sorting can nevertheless simultaneously be achieved and/or maintained during the transport.

The object is further achieved by a hanging bag storage configured, designed and/or programmed for executing a method described above. This results in the advantages described above.

Finally, the object is achieved by a hanging bag storage for storing storage articles that can be received in hanging bags. To that end, the hanging bag storage comprises a first handover buffer in a first level of the hanging bag storage, at least one second handover buffer in a second level of the hanging bag storage, wherein the storage articles in the handover buffers of the respective level of the hanging bag storage can be provisioned for an imminent retrieval, a control device, by which a sequence of the storage articles provided for the retrieval can be specified, and a circular conveying plant for provisioning a series, preferably an interlinked series, of storage locations for receiving at least one of the storage articles, wherein the series of storage locations can be directed past the handover buffers while the storage articles provisioned in the handover buffers can be handed over from the respective handover buffer into the storage locations in the specified sequence, respectively. The handover buffers enable a maximal capacity utilization of the circular conveying plant to be achieved despite any asynchronous arrival times of the storage articles in the different levels of the hanging bag storage. Here, a simultaneous sorting of the storage articles can advantageously take place. The hanging bag storage is in particular part of a hanging bag storage system described above. In this respect, this also results in advantages described above.

A preferred exemplary embodiment of the hanging bag storage is characterized in that the hanging bags along with the storage articles located therein can be received and transported using the circular conveying plant, wherein the handover buffers are arranged in an imaginary line to one another, preferably in a vertical line. In a simple manner, a retrieval across the levels of the hanging bag storage can be executed. The vertical arrangement ensures that a space-saving hanging bag storage can be provisioned. The hanging bag storage is preferably structured at least in regions or entirely without trail chains.

The object is further achieved in a handover configuration for retrieving storage articles from a hanging bag storage having hanging bags or from a hanging bag storage described above of a hanging bag storage system described above by a preferably segmented or segmentable first in, first out buffer for receiving the storage articles arranged downstream of the hanging bag storage, a pick buffer for receiving the storage articles from the first in, first out buffer arranged downstream of the first in, first out buffer and a handover buffer for removing the storage articles from the pick buffer in a specified sequence and for provisioning the storage articles for a removal from the hanging bag storage, which handover buffer is arranged downstream of the first in, first out buffer. The handover configuration enables the storage articles to be continuously removed from the hanging bag storage while simultaneously being sorted. Advantageously, the sorting takes place in a presorting stage, realized by the first in, first out buffer, in which storage articles can be received which, while at first continuous, have no strict sequence. These presorted storage articles are then transferred into a final sorting stage, into the pick buffer, where they are provisioned for the final sorting and can then be stored in the handover buffer in the sequence by picking. From there, they can be finally retrieved, electively with a delay, in the desired sequence and/or handed over to another element of the hanging bag storage, such as a conveyor, to that end. There is therefore a three-stage processing of the storage articles, which simultaneously enables a time buffering and continuous sorting at the input and output sides. If no time buffering is required at the output side, the picking can electively be executed directly into the conveyor in the specified sequence, relinquishing the provisioning buffer. Particularly preferably, the storage articles are located respectively inside one of the hanging bags. The first in, first out buffer, pick buffer and/or the handover buffer are therefore preferably designed for receiving the storage articles inside the hanging bags. This means that the storage articles are arranged in the first in, first out buffer, pick buffer and/or handover buffer respectively inside one of the hanging bags. Also the handovers between the buffers are preferably executed using the hanging bags, in particular autonomously or at least partially autonomously. Particularly preferably, precisely one of the storage articles, or alternatively precisely one of the storage articles or no storage article, is received in each of the hanging bags. The hanging bag storage is in particular part of a hanging bag storage system described above. In this respect, this also results the advantages described above.

A preferred exemplary embodiment of the handover configuration is characterized in that a preferably vertically conveying conveying plant, in particular circular conveying plant, for removing the storage articles from the hanging bag storage is arranged downstream of the handover buffer. From the handover buffer, the storage articles can be handed over into the conveying plant in the desired sequence. The conveying plant is preferably arranged vertically. This enables the storage articles, preferably received in the hanging bags, from different levels to be transported downward, for example into a packing station for removing the storage articles from the hanging bags and packaging the storage articles.

Another exemplary embodiment of the handover configuration is characterized in that the pick buffer comprises a reciprocating track, on which the storage articles, preferably the hanging bags in which the storage articles are received, are slidably relocatable between two end positions. At the end points, a reversal takes place. The storage articles, therefore, execute at least one preferably linear reciprocating motion in the most general sense. The relocating enables the storage articles to be brought to a position that is favorable for the further processing and/or sorting.

Alternatively or additionally, the reciprocating track has a branch-off between the two end positions which ends in the handover buffer. This branch-off enables the storage articles to be picked electively into the handover buffer for creating the sequence. To that end, the storage articles can be singled out and/or picked out in the sequence. During the reciprocating motion, the hanging bags travel past the branch-off, preferably back and forth multiple times. As soon as they are next in line, the storage articles and/or the hanging bags with the storage articles can turn from the pick buffer into the handover buffer.

Another preferred exemplary embodiment of the handover configuration is characterized in that the first in, first out buffers comprise sections of rails arranged in parallel, in which respectively one, preferably joint, entry rail of a level of the hanging bag storage or one, preferably joint, entry rail of the hanging bag storage adjoining the level ends at the input side and ends in respectively one, preferably joint, exit rail at the output side, wherein the joint exit rail forms a reciprocating track between the end positions and comprises the reciprocating buffer. To that end, rails of the handover configuration preferably have a rectangular pattern, which comprises the entry rail at an input side and the exit rail at a side opposite the input side. The rails are connected by a plurality of the first in, first out buffers. Particularly preferably, this is a rail network with rectangular meshes provided in the hanging bag storage anyway, wherein a plurality of rectangular meshes arranged next to one another are used for the handover configuration. Therefore, electively no structural effort is required for provisioning or assembling the hanging bag storage.

The object is further achieved in a method for retrieving storage articles from a hanging bag storage having hanging bags, in particular a hanging bag storage with a handover configuration described above, by: provisioning a first in, first out buffer arranged downstream of the hanging bag storage, presorted receiving of the storage articles from the hanging bag storage in the first in, first out buffer, provisioning a pick buffer arranged downstream of the first in, first out buffer, completely or at least partially receiving the storage articles buffered in the first in, first out buffer in the presorted state in the pick buffer, provisioning a handover buffer arranged downstream of the pick buffer, picking out the storage articles stored in the pick buffer into the handover buffer in the specified or specifiable sequence, provisioning a preferably vertically conveying conveying plant, in particular circular conveying plant, arranged downstream of the handover buffer, removing the storage articles from the hanging bag storage by handing over the storage articles into the conveying plant. Presorted receiving in the first in, first out buffer can be understood to mean that storage articles of a desired sequence are divided into partial intervals of the sequence and grouped accordingly. Groups thus formed can be stored irrespective of the sequence in the first in, first out buffer. For the final sorting, the groups can then be sorted in simpler sorting operations and put together again according to a group sequence specified by the partial intervals of the sequence. This results in a sorting method which is robust preferably at the input side and at the output side against delays of individual ones of the storage articles and can also be simply and quickly executed for very long, in particular continuous, sequences. Furthermore, this results in the advantages described above.

One embodiment of the method is characterized by relocating the storage articles between two end positions inside the pick buffer while removing and handing over respectively one of the storage articles into the handover buffer for creating the sequence. The relocating enables storage articles which are to be removed next in the sequence to be directed past the branch-off and thereby be provisioned for a picking operation into the handover buffer. The reciprocating therefore enables an optional access to all storage articles and/or hanging bags with the storage articles located therein which are located in the pick buffer.

Another embodiment of the method is characterized by specifying the sequence, assigning the sequence to the storage articles, subdividing the sequence into subsequences, unsorted depositing of all storage articles of one of the subsequences in the first in, first out buffer for presorting the storage articles. This enables the multi-stage sorting to be achieved. Here, it is conceivable that the depositing in the first in, first out buffer takes place within a relatively large time interval. Individually arriving storage articles are therefore advantageously not bound to a particular arrival time, since they need not arrive at the assigned first in, first out buffer in the desired sequence with respect to individual arrival times. Storage articles, in particular of a subsequence, can therefore arrive at the respective first in, first out buffer autonomously or at least partially autonomously at individual times, in particular independent of a traffic volume in the hanging bag storage. Nevertheless, the assigning to a particular first in, first out buffer and the allocating and/or assigning of the subsequence enables the presorting of the storage articles. In the respective first in, first out buffer, the storage articles, while chaotic with respect to the sequence, are nevertheless sortable in an ordinally continuous manner with respect to the subsequences and/or intervals. To produce the final superordinate sequence, the storage articles of the first in, first out buffer can be sorted ordinally and all subsequences of storage articles thus sorted can be linked together.

Electively, it is conceivable that also the subsequences are further subdivided into batches which preferably correspond to a packing unit. Each first in, first out buffer can electively also receive multiple batches, depending on capacity and design. A batch can consist, for example, of 5 storage articles on average. Yet, it is also conceivable that the batches, which are in particular important at the packing station, overlap the first in, first out buffers and are only available in the overall sequence. The advantages are achieved independent thereof. Finally, it is conceivable that only one batch is handed over from the individual first in, first out buffers into the pick buffer and the handover buffer. Electively, this can also take place in an unsorted manner inside the batch if this is not relevant for the packing into the packing unit. A retrieval time from the pick buffer into the handover buffer can then be shortened.

Finally, the object is achieved by a hanging bag storage. The hanging bag storage is configured, designed and/or programmed for executing a method described above and/or has a handover configuration outlined above. This results in the advantages described above.

One exemplary embodiment of the hanging bag storage is characterized in that the hanging bag storage has a plurality of the handover configurations arranged on top of one another, which are arranged upstream of a joint, preferably vertically conveying conveying plant, in particular circular conveying plant, for removing the storage articles from the hanging bag storage. The hanging bags with the storage articles or the storage articles can be transported away across multiple stories. The sorting operation can take place in parallel across multiple and/or in multiple stories.

The object is also achieved in a hanging bag storage or a hanging bag storage of a hanging bag storage system described above for storing storage articles received in hanging bags by a handover configuration for sorting and handing over the storage articles located in the hanging bags in a specified or specifiable sequence, a preferably vertically conveying conveying plant, preferably circular conveying plant, arranged downstream of the handover configuration for removing the storage articles received in the hanging bags from the handover configuration in the sequence and an express track for retrieving individual ones of the storage articles independent of the specified or specifiable sequence. The express track enables a flexible response to any deviations from the sequence. For example, it is conceivable that packing units which contain at least one of the storage articles are filled out of the hanging bag storage. To that end, the storage articles can be assigned to batches, wherein the batches, in turn, are assigned to only one of the packing units. It can happen that a batch is particularly important or consists of only one of the storage articles. In this case, the express track can be used to advantageously create a bypass of the usual sorting operation. This saves time and enables a faster retrieval on the one hand. What is more, any free resources which can remain free during the sorting, for example due to waiting times, in particular in a component arranged downstream of the handover configuration, can alternatively or additionally be used to thus improve also an overall capacity utilization of the hanging bag storage. A moving of the storage articles is preferably executed using the hanging bags. The hanging bag storage is in particular part of a hanging bag storage system described above. In this respect, this also results the advantages described above.

Preferably, the hanging bag storage comprises another preferably vertically conveying conveying plant, in particular another circular conveying plant, arranged downstream of only the express track for transporting away the storage articles coming from the express track independent of the sequence. Any individually requested ones of the storage articles can be retrieved even better and faster. Advantageously independent of a retrieval of the storage articles sorted in the sequence. No jointly used resources are required for the retrieval. Further, the capacities of the downstream packing stations can be utilized better. Finally, it is conceivable to retrieve particularly expedient batches or batches to be prioritized with more than one of the storage articles on this route.

In another exemplary embodiment, it is provided that the express track is arranged upstream of the conveying plant, or is arranged upstream of the conveying plant as required, for transporting away the storage articles coming from the express track independent of the sequence. The conveying plant can be used for dispatching in the sequence and simultaneously for the storage articles which were prioritized using the express track. Any gaps in capacity utilization of the conveying plant occurring due to a waiting time, i.e. until completing the sequence, can be closed by storage articles delivered via the express track.

Alternatively or additionally, the express track is arranged upstream of the conveying plant, or is arranged upstream of the conveying plant as required, for transporting away the storage articles coming from the express track independent of the sequence. There is the possibility that the storage articles to be prioritized are supplied from the express track directly into the conveying plant. It is conceivable for the express track to be arranged upstream of the conveying plant only as required. This enables the express track to be used otherwise if no expedient or individual ones of the storage articles are requested.

In another embodiment, the handover configuration itself comprises the express track. This results in a particularly short and fast route, via which the sorting operation for creating the sequence which electively takes place in the handover configuration can be bypassed. In particular, the bypassing is executed if no sorting is currently taking place. This may be the case whenever the handover configuration is waiting for one of the storage articles coming from the remaining hanging bag storage and the sorting is therefore currently pausing.

Another advantageous possibility is that the handover configuration comprises a first in, first out buffer arranged downstream of the hanging bag storage for receiving the storage articles, a pick buffer arranged downstream of the first in, first out buffer for receiving the storage articles from the first in, first out buffer and a handover buffer arranged downstream of the first in, first out buffer for removing the storage articles from the pick buffer in a specified sequence and for provisioning the storage articles for a removal from the hanging bag storage, wherein the first in, first out buffer, the handover buffer and/or the pick buffer comprise the express track as required and/or can be temporarily emptied and thereby be used as the express track. No additional routes are required for the express track. Rather, the express track is created as required by an at least partially empty running and/or emptying of the handover configuration itself. This ensures that the handover configuration can be passed without any waiting times. There is no additional hardware requirement in the network and/or rail network.

Finally, it is provided in one exemplary embodiment of the hanging bag storage that the express track and the handover configuration are arranged in parallel. This ensures that there is no mutual influencing when bypassing on the express track and/or by the sorting task of the handover configuration. Nevertheless, the express track can be designed so as to be relatively short.

The object is further achieved in a method for picking storage articles received in hanging bags by provisioning a handover configuration arranged downstream of the stored storage articles, receiving a plurality of the storage articles in the handover configuration, sorting the plurality of the received storage articles into a specified or specifiable sequence using the handover configuration, selecting at least one other one of the storage articles, at least partially or completely bypassing the plurality of the storage articles received in the handover configuration, in particular using an express track, and direct picking of the selected at least one of the storage articles. A specific number of the storage articles can be selected and received in the handover configuration. To that end, the storage articles can be located in the hanging bags, i.e. be transported using these and sorted together with these. Preferably, precisely one of the storage articles is located in each of the hanging bags. The at least one of the storage articles is first located in the hanging bag storage and/or in a hanging bag located in the hanging bag storage. The storage article can be classified as expedient, for example, in terms of a selection criterion and be picked particularly quickly by the bypassing. Alternatively or additionally, the storage article can also be identified and/or classified as an individually required storage article in terms of a selection criterion, for example for an individual shipment in a packing unit such as a mail package. It is then possible to identify any pauses during the sorting in the handover configuration and to pick, in particular prioritize, the selected storage article precisely in these pauses. The identifying can be executed using a control and/or measurement device, for example. This enables a capacity utilization of the hanging bag storage to be improved and simultaneously a picking time for the individual ones of the storage articles (single items) to be shortened. In particular on the express track, a direct picking of the selected at least one of the storage articles can therefore be executed independent of the sequence. The method is preferably executed using a hanging bag storage described above. In this respect, this also results in advantages described above.

A preferred embodiment of the method is executed with a provisioning of a downstream conveying plant, for example circular conveying plant, and a receiving and conveying of the storage articles, preferably of the plurality of the storage articles and of the at least one other storage article, from the handover configuration into the conveying plant and direct picking of the selected at least one of the storage articles using the conveying plant. The conveying plant can be used to retrieve the storage articles from the hanging bag storage. The conveying plant is in particular designed as a vertical conveying plant, preferably for connecting multiple levels of the hanging bag storage. The at least one other one of the storage articles can be supplied using the express track of the conveying plant with a particularly short access time and/or for filling free conveying capacities.

Alternatively or additionally, also an express conveying plant can be provisioned in addition to the conveying plant. The other conveying plant can also a be vertically conveying circular conveying plant. The plurality of the storage articles sorted in the handover configuration are conveyed using the conveying plant. The at least one of the storage articles is conveyed using the other conveying plant. There is therefore a direct picking of the selected at least one of the storage articles. This enables the at least one of the storage articles to be picked and/or retrieved in the handover buffer independent of the sorting operation. This renders the hanging bag storage more flexible, faster and more efficient in terms of capacity utilization. Any individual articles and/or single items which can be sent in a separate packing unit can be picked and dispatched independently.

In a preferred variant, it is conceivable that at least one component of the handover configuration is emptied and used as the express track or in addition to a separate express track. Therefore, the hanging bag storage comprises at least one of the express tracks, electively strictly specified or flexibly assigned. Additional route length for the express track can be saved. To that end, the infrastructure of the handover buffers can at least temporarily be used in addition. This results in a particularly flexible system, in which route sections and/or rail sections flexibly fulfill different tasks, for example are used either as buffers or as the express track. This enables waiting times in which none of the storage articles arrive in the handover buffer and consequently also need not be sorted into the sequence to be used for passing through individual ones of the storage articles using the temporarily designated express track. This enables capacity utilization and thus overall performance of the hanging bag storage to be increased. Preferably, the pick buffer, handover buffer and/or first in, first out buffer can be emptied and used as the express track.

The object is furthermore also achieved in a method for operating a hanging bag storage or a hanging bag storage of a hanging bag storage system described above with storage articles received in hanging bags by storing the storage articles received in the hanging bags in a series on a storage route of the hanging bag storage, scheduling one of the storage articles of the series for a retrieval, vacating a retrieval path for the scheduled one of the storage articles by relocating other storage articles of the series into a shunting route of the hanging bag storage, and retrieving the scheduled one of the storage articles from the series and along the vacated retrieval path. The storage articles can be stored in the storage route. To that end, the storage articles are received in hanging bags which are autonomously or at least partially autonomously displaceable on a network, in particular rail network. If one or multiple of the storage articles of the series are to be retrieved in the storage route, this/these storage article(s) can be scheduled for retrieving and/or sorting. What is more, it can be determined whether other ones of the storage articles, which are also stored in the series, block an exit of the storage route. These storages articles can be relocated into the shunting route, wherein the retrieval path can be vacated. On this retrieval path, the scheduled storage article(s) can be retrieved. Already the scheduling enables a specifiable or specified sequence for the retrieval to be observed. Other sorting stages can follow, wherein the scheduled storage articles of the storage route can be merged with other storage articles of other storage routes. There can be a simple storage, retrieval and simultaneous sorting of the storage articles. A special sequencing and/or arrangement of the storage articles in the storage route and/or somewhere in the hanging bag storage is not required but may be useful for further optimization of the retrieval and/or of access times. To vacate the retrieval path, the storage articles and/or the hanging bags with the storage articles can travel in convoy.

Preferably, a direction of motion of the other ones of the storage articles of the series is reversed and the storage articles are stored back into the storage route in this reversed direction of motion. This can take place after the traveling on the vacant retrieval path by the scheduled storage article, so that the shunting route can advantageously be vacated again afterwards, wherein the other ones of the storage articles of the series are displaced back into the shunting route again and can remain there until any further scheduling. This results in a minimal extraneous movement and/or a minimal handling effort for non-scheduled ones of the storage articles.

In a preferred exemplary embodiment, the storage route of the hanging bag storage is encircled by the other ones of the storage articles in the direction of motion and a relocating of the other ones of the storage articles of the series into the storage route takes place in the same direction of motion after the encircling. A sequence of the other ones of the storage articles in the storage route is thereby reversed. The relocating results in a highly dynamic warehouse operation, wherein those of the storage articles in lower demand tend to accumulate in the centers of the storage routes. This effect occurs generally with or without reversal of the direction of motion. This enables a retrieval effort and the retrieval time to be optimized. A control effort can be minimized, any conflicts with other hanging bags traveling autonomously on the network can be improved by maintaining the direction of motion.

Alternatively or additionally, a circulating or reciprocating of the other ones of the storage articles of the series is executed on the storage route, the shunting route, another storage route adjoining the shunting route and another shunting route adjoining the storage route and other storage route and/or by singling out the scheduled one of the storage articles during the circulating or reciprocating along the retrieval path vacated thereby. Preferably a relocating of the other ones of the storage articles of the series is executed from the storage route into the shunting route of the hanging bag storage and from there further into another storage route. In this application, circulating may also be understood to mean a motion on a closed conveyor which can electively comprise switches or branch-offs and/or deviate from a circular shape.

Any of the storage articles of the other series located in the other storage route can be relocated into another shunting route of the hanging bag storage and from there be relocated further into the series of the storage articles. This means that preferably a circular route is followed and/or the storage routes and shunting routes form a ring, which can preferably be traveled on by the storage articles of the series while maintaining the direction of motion until the retrieval path is vacant and/or the scheduled one of the storage articles has arrived at the shunting route and can leave the series through the shunting route. To that end, the shunting route can be crossed by the scheduled one of the storage articles or at least be traveled on in regions and then left, in the simple case. To that end, the shunting route can comprise at least one branch-off and/or crossing. The other ones of the storage articles simply travel further, back into one of the storage routes again, and thus ultimately remain in the stored state and/or in one of the storage routes. More specifically, the other ones of the storage articles temporarily also travel on the shunting route but are instantly directed back into one of the storage routes from there. Alternatively, it is conceivable to provide the ring and/or circular route only at least partially and achieve the same effect by reciprocating, i.e. alternate reversal of the direction of motion.

Another embodiment is executed by crossing the shunting route with the scheduled one of the storage articles, entering the express route by the scheduled one of the storage articles after the crossing and/or relocating of the scheduled one of the storage articles from the retrieval path vacated on the storage route using the express route of the hanging bag storage, a handover buffer of the hanging bag storage and a preferably vertically conveying conveying plant for retrieving the scheduled one of the storage articles. The conveying plant is used to transfer the scheduled one of the storage articles preferably into an unloading station of the hanging bag storage, where the scheduled one of the storage articles can be processed further, for example made ready to dispatch. The retrieval path can comprise parts of the storage route and a crossing over the shunting route. This enables a particularly simple and quick access to the scheduled storage article. The express route enables a particularly fast retrieval. In this application, an express route can be understood to mean a section of the network which can be traveled on by the hanging bags and which must be used only for transporting the storage articles. This means that no shunting tasks are executed there. What is more, a shunting route and/or express route can have a specification of direction, so that the hanging bags may travel on the shunting route and/or express route only in a predefined or predefinable direction of motion. Further, it is conceivable that an express route has relatively few crossings. A shunting route can be understood to mean a section of the network which can be traveled on by the hanging bags and which can be used for a variety of purposes, wherein preferably a sorting, picking, rearranging, handling, etc. of the storage articles and/or hanging bags can take place there. Preferably, shunting routes directly adjoin the storage routes. A storage route can be understood to mean a preferably longer and crossing-free section of the network on which the storage articles and/or hanging bags can be stored without movement. A motion can be reduced to a potential scheduling for retrieving and/or to a vacating of the retrieval path.

Another advantageous possibility is that a plurality of identical ones of the storage articles are stored distributed over the entire hanging bag storage, one of the storage articles from the plurality of identical ones of the storage articles is selected and the selected one of the storage articles is selected as the one of the storage articles of the series for the retrieval. Preferably a criterion for the selection can be specified, for example a depth inside the series of the storage route, a distance to an exit of the hanging bag storage. The dispersed storage of identical ones of the storage articles enables an access time to be shortened.

Generally, only one level is required for the method. Alternatively, the method can be executed by repeating the method for a plurality of scheduled ones of the storage articles and in a plurality of levels of the hanging bag storage, specifying a sequence for the plurality of the scheduled ones of the storage articles, presorting the plurality of the scheduled ones of the storage articles in the handover buffers of the levels, finally sorting the plurality of the scheduled ones of the storage articles in the sequence by handing over the plurality of the scheduled ones of the storage articles from the handover buffers of the levels into the conveying plant and/or autonomous or at least partially autonomous traveling of the hanging bags of the hanging bag storage on a network of the hanging bag storage comprising in particular the storage routes, shunting routes and the express route, and the retrieval path.

With a minimal infrastructural effort and/or for a conveying system, a storing and fast sorting of the storage articles can simultaneously take place. In particular in comparison to multi-stage inflow sorting plants, which can usually be arranged downstream of hanging bag storages known from the prior art with a permanently installed conveying system for sorting tasks, a space-saving overall system can be provisioned.

Finally, it is conceivable to put the hanging bags autonomously or at least partially autonomously displaceable on the network into an energy saving sleep mode for saving electrical energy during the storing of the storage articles, in which sleep mode they are preferably also still and at rest, and to wake them up again accordingly and preferably supply them with current accordingly for the autonomous or at least partially autonomous traveling and retrieving of the storage articles.

The object is further achieved by a hanging bag storage for executing a method described above. This results in the advantages described above.

Finally, the object is achieved in a hanging bag storage for storing and sorting storage articles that can be received in hanging bags. This hanging bag storage is characterized by a plurality of levels, respectively with: a network, on which the hanging bags can be displaced autonomously or at least partially autonomously, a plurality of storage routes of the network arranged in parallel for storing the storage articles received in the hanging bags, at least one shunting route in which the plurality of the storage routes end and/or which circularly surrounds the plurality of the storage routes, at least one express route which is arranged downstream of the plurality of storage routes and/or of the at least one shunting route, a handover buffer arranged downstream of the network and/or of the express route of the network for presorting the storage articles, a preferably vertically conveying conveying plant arranged downstream of the handover buffers of the levels for finally sorting the storage articles in a specified or specifiable sequence.

The hanging bag storage enables a highly dynamic processing of storage articles, in particular storing, fast sorting and retrieving, in a relatively small space. The hanging bag storage can be used to execute a method described above. In this respect, reference is made also to the advantages illustrated above.

The object is also achieved in a hanging bag storage or a hanging bag storage of a hanging bag storage system described above for storing and sorting storage articles which can be received in hanging bags by a network, on which the hanging bags can be displaced autonomously or at least partially autonomously, wherein the network comprises at least one express route, which can be traveled on by the hanging bags in a direction-based manner and with priority, at least one shunting route arranged parallel to the express route, which can be temporarily used for sorting tasks of the hanging bags, a plurality of storage routes arranged at an angle to the express route and to the shunting route which adjoin the express route and the shunting route via a retrieval path which can be freely traveled on preferably at least temporarily, i.e. can be at least temporarily created, for storing the storage articles received in the hanging bags in a series.

This configuration enables a non-crossing or at least minimally crossing traffic for sorting and rearranging the storage articles on the shunting routes and a relatively fast retrieval operation using the express routes. Overall, this enables a higher overall performance of the hanging bag storage in relation to storage and retrieval times and resorting operations of the storage articles. The retrieval path preferably extends from the respective storage route beyond the shunting route to the express route.

Preferably, the shunting routes are arranged vertically to the storage routes. This enables a simple symmetrical structure of a warehouse layout, as well as a simple assembly of the hanging bag storage and/or of the network. Particularly preferably, switches are provided at crossing points between the storage routes and shunting routes, which switches enable an optional motion of the hanging bags, i.e. a turning from the storage route in two selectable turn-off directions and/or a crossing over, i.e. straight on. When traveling straight on, the shunting route can therefore be crossed and the hanging bag can turn into the express route arranged parallel to the shunting route or can also cross the express route and thereby travel straight on into another storage route or electively turn off and enter another shunting route. In this case, one of the shunting routes is arranged respectively in parallel bilaterally of the express route and the storage routes are arranged respectively at the angle, preferably orthogonally, to the two shunting routes, also bilaterally. Switches can be provided also on the express route.

The switches can preferably be configured so as to be passive. In this context, passive can mean that, while the switch is part of the network, in particular rail network, a reversal can be caused by steering elements provided at the hanging bags and control devices operating the steering elements, similar to known routes, which can be used using traction and steered wheels. A control of the switches can thereby be relinquished and an individual, autonomous or at least partially autonomous traveling is enabled.

However, it is also conceivable that the switches have steering elements and are controlled, as known in classic rail traffic. In this case, the steering elements of the switch can be controlled by the hanging bags for an individual traveling on the network. This also enables an individual traveling on the network.

In the storage routes, the hanging bags are at rest and are waiting for a scheduling. Depending on the size and design of the warehouse and on specifications, this can take between a few hours and days, in particular a maximum of 7 days, preferably a maximum of 3 days, for example maximally one day.

The hanging bag storage can therefore electively be used as a pure sorting device for creating the sequence, as a storage or with at least partially empty hanging bags also be reserved as a buffering capacity. In the storage routes, there can therefore be hanging bags filled with the storage articles or electively also empty hanging bags. Here, it is conceivable to provide separate storage routes for empty and full hanging bags. This ensures that extraneous movement of empty hanging bags can be avoided when scheduling the storage articles. However, it is advantageously also possible to mix empty and full hanging bags in order to obtain a higher flexibility and shorter average distances in the hanging bag storage. Depending on what is required, these strategies can also be combined in a hanging bag storage.

In a preferred exemplary embodiment of the hanging bag storage, it is provided that the at least one storage route and the at least one express route are interconnected by a plurality of cross connections which can be traveled on by the hanging bags. The hanging bags can use the cross connections to change electively back and forth between the express route and the shunting route. A relatively short distance, for example between 70 cm and 3 meters, preferably corresponding to a mutual distance between the storage routes, particularly preferably respectively one of the connections per ending storage route, enables a rearranging, sorting, storing and/or retrieval of the storage articles and/or of the hanging bags to be realized in a highly flexible manner and in relatively short times. If required, the cross connections can be used to form the retrieval path and/or the retrieval path can extend along the cross connections and thus end directly in the closest express route.

Another exemplary embodiment of the hanging bag storage can be configured such that respectively one of the shunting routes is arranged bilaterally of the at least one express route and abutting on the respective one of the shunting routes and the plurality of storage routes are arranged ending in the respective one of the shunting routes at the angle, respectively. Therefore, each of the storage routes is connected to the shunting route, wherein an optional access to the storage articles of a respective one of the storage routes and thereby a relatively simple handling are enabled.

Preferably, it is conceivable that respectively one of the shunting routes is arranged bilaterally of the at least one express route and abutting on the respective one of the shunting routes and the plurality of storage routes are arranged ending in the respective one of the shunting routes at the angle, respectively. The capacity of the express route can be utilized better, as it is accessible from two blocks of storage routes. The fact that the express route is surrounded by shunting routes in parallel bilaterally enables any shunting traffic to be kept away from the express route completely.

The connection of the shunting route to the respective storage route can be used to buffer, sort, transport away and/or supply the hanging bags and/or storage articles in the shunting route, wherein furthermore an entering of the express route and thus final retrieving can take place by crossing the shunting route. Or vice versa for a storing. The storage routes, which are respectively surrounded by the express routes and storage routes, form in particular blocks, which can be provided in the hanging bag storage in any dimensioning and number. It is conceivable that such a block can be added as an expansion of an existing hanging bag storage. Existing traffic rules can be taken over block by block and the hanging bag storage can be structured and/or expanded in a modular manner.

Finally, it is conceivable that the hanging bag storage comprises a plurality of the express routes, which are arranged at an angle, preferably orthogonally, to one another and crossing one another, wherein the express routes are arranged grid-like and preferably with alternating specifications of the direction of motion to one another. The grid meshes and/or blocks formed by the express routes comprise the storage routes and orthogonally to the storage routes the express routes and shunting routes. Also express routes, preferably shunting routes and express routes, are arranged at front ends of a block thus formed. This means that these routes extend parallel to the storage routes, are in particular arranged adjacent to a top and bottom one of the storage routes of the respective block and/or grid mesh. The blocks thus formed, which each comprise a plurality of storage routes which are surrounded by the shunting routes and the express routes, can be provided in any number. Generally, they are provided on at least one level of the hanging bag storage, yet alternatively also distributed over multiple levels of the hanging bag storage and/or arranged on top of one another. This enables relatively small handling, access and/or sorting times per block. This ensures that the hanging bag storage can be scaled relatively simply and without any noteworthy performance loss, wherein the performance with respect to the handling, access and/or sorting times is only minimally impacted with increasing size, namely merely by any transport times on the express routes, which increase merely by a few seconds with the size, however. For example, in a hanging bag storage with a surface area of 10,000 m² per level, a maximal distance is 50 m from an innermost point up to a periphery of the respective level, which at an assumed speed of up to m/s can be covered in only 10 seconds. Due to the repetitive structure in the blocks and the providing of the express routes, the blocks and the transport on the express routes in this arithmetic example enable a scaling to up to 100,000 hanging bags per level with a slight difference in performance of maximally 10 seconds of transport time in centrally arranged storage articles to a periphery of the level.

In one exemplary embodiment, a plurality of levels are provided, respectively with: the network, on which the hanging bags can be displaced autonomously or at least partially autonomously, the plurality of storage routes of the network arranged in parallel for storing the storage articles received in the hanging bags, the at least one shunting route in which the plurality of the storage routes end and/or which circularly surrounds the plurality of the storage routes, the at least one express route which is arranged downstream of the plurality of storage routes and/or the at least one shunting route, a handover buffer arranged downstream of the network and/or of the express route of the network for presorting the storage articles, a preferably vertically conveying conveying plant arranged downstream of the handover buffers of the levels for finally sorting the storage articles in a specified or specifiable sequence. The hanging bag storage is scalable within wide limits in a vertical direction due to the levels and inside the respective level due to the blocks described above. Advantageously without any noteworthy impact on an overall performance of the hanging bag storage. Further, due to a dimensioning of the blocks, the hanging bag storage can furthermore be designed freely also with respect to the criteria of performance, dwell time and storage density.

The object is furthermore achieved in a method for operating a hanging bag storage with storage articles received in hanging bags by storing the storage articles received in the hanging bags in a series on a storage route of the hanging bag storage, scheduling one of the storage articles of the series for a relocating and/or sorting, relocating the scheduled one of the storage articles, and inserting the scheduled one of the storage articles into an additional storage route of the hanging bag storage in a specified or specifiable sequence. This enables a sorting and/or resorting inside the hanging bag storage, namely in the storage routes. Specifically, the storage articles are rearranged in the additional one of the storage routes in the sequence as a result. Here, it is possible to rearrange the storage articles from different storage routes into the additional one of the storage routes. However, it is also conceivable to thereby rearrange all storage articles from one of the storage routes in the other one of the storage routes. The thus rearranged ones of the storage articles can be provisioned in the new sort order and/or sequence and be retrieved at a later point in time particularly quickly and simply, for example in a convoy and/or traveling in convoy and arranged in succession in the sequence.

One embodiment of the method is characterized by vacating a retrieval path for the scheduled one of the storage articles by relocating other ones of the storage articles of the series into a shunting route of the hanging bag storage, relocating the scheduled one of the storage articles along the vacated retrieval path into the other storage route of the hanging bag storage. The vacated retrieval path can be traveled on quickly and simply by the scheduled one of the storage articles and/or the corresponding hanging bag with the scheduled one of the storage articles. For the vacating, storage articles blocking the retrieval path can be relocated and electively relocated back again after using the retrieval path.

In another possible embodiment, a repeating of the method for a plurality of scheduled ones of the storage articles and a plurality of other storage routes, a specifying of a sequence for the plurality of the scheduled ones of the storage articles, and a respective inserting of the plurality of the scheduled ones of the storage articles in the plurality of other storage routes according to the sequence are provided. This enables at least part of the warehouse stock, preferably the entire warehouse stock, in the storage routes to be rearranged and/or rearranged according to the specified or specifiable sequence. For example, a retrieval requirement and/or the sequence can be determined and specified cyclically in a preparation phase and arranged and provisioned by rearranging in the storage routes. Subsequently, the retrieval of the storage articles in the sequence can take place in a retrieval phase unimpeded by any sorting operations running in parallel. This enables a high performance to be achieved. This procedure can take place in a plurality of levels of the hanging bag storage, preferably respectively for a whole level, at least for specifiable or specified sections of a level/of the hanging bag storage or of the entire hanging bag storage.

In another embodiment, a crossing over or crossing of the shunting route with the scheduled one of the storage articles and an entering of the express route by the scheduled one of the storage articles after the crossing can take place. Preferably, the retrieval path extends beyond the shunting route. The express route enables a quick intra-warehouse transport of the scheduled one of the storage articles. A traveling on the shunting route by the scheduled one of the storage articles is not required. The scheduled one of the storage articles can enter the express route directly from the storage route by crossing. Alternatively, it is also conceivable, however, that the scheduled one of the storage articles travels first on the shunting route for part of the way and then changes onto the express route in order to cross over the express route.

Further, in another embodiment, a storing of a plurality of identical ones of the storage articles distributed over the entire hanging bag storage, a selecting of one of the storage articles from the plurality of identical ones of the storage articles and a scheduling of the selected ones of the storage articles as the one of the storage articles of the series for the sorting can take place. This results in a quicker access to the selected and scheduled one of the storage articles. In particular, the sequence can be achieved more quickly by making the selection such that the destination of the rearranging, i.e. the other one of the storage routes, is located particularly close.

The retrieving of the plurality of the scheduled ones of the storage articles in the sequence can take place by handing over the plurality of the scheduled ones of the storage articles from the plurality of other storage routes using the handover buffers of the levels into a conveying plant.

The hanging bags comprising the storage articles can move freely by traveling autonomously or at least partially autonomously on the network of the hanging bag storage, in particular comprising the storage routes, shunting routes, the express routes and the retrieval path. It is conceivable to put the hanging bags than can be displaced autonomously or at least partially autonomously on the network into an energy saving sleep mode during the storing of the storage articles and/or if the hanging bags are available empty, and to wake them up again for retrieving or resorting.

The method can in particular be executed using the hanging bag storage described above and/or using a hanging bag storage system described above. In this respect, reference is made also to the advantages illustrated above.

The object is furthermore achieved in a hanging bag storage or a hanging bag storage system described above with at least partially autonomously or autonomously displaceable hanging bags, with a network, on which a plurality of hanging bags can be displaced autonomously or at least partially autonomously, by a control device, by which the hanging bag storage and/or flows of unit loads inside the hanging bag storage can be controlled and/or monitored, a first communication configuration, using which a communication path A between the control device and an addressee, in particular a random, individual one of the hanging bags as the addressee, can be set up and a second communication configuration, using which another communication path B, which is independent of communication path A, can be set up between the control device and the addressee, in particular the random, individual one of the hanging bags. The two independent communication paths ensure that overall more messages can be sent to and received by the hanging bags. The communication paths can be used flexibly and depending on a location of the respective hanging bag inside the hanging bag storage. This enables a transmitting power density to be minimized and a data rate to be maximized. This enables a particularly large number of hanging bags, in particular approximately 1,000,000, preferably up to 1,500,000, to be communicated with and controlled. Once communicated with and/or issued an instruction, the individual hanging bags can travel through the hanging bag storage autonomously or at least partially autonomously without any further messages. As soon as the instruction has been executed, there can be a waiting phase/rest phase of the hanging bag communicated with and a new message with a new instruction can be sent and received by the addressee later or directly subsequently.

Preferably, it is possible for the communication paths A and B to comprise a hanging bag with a cotraveling first transceiving device configured for the communication path A and a cotraveling second transceiving device configured for the communication path B, a control device for centrally controlling the hanging bag storage, generating, sending and receiving messages via the communication paths A and B, a plurality of intermediate controllers, which are arranged downstream of the control device, preferably hard-wired, respectively equipped with an independent computing capacity and configured for the communication path A, a cluster of two to 10, preferably two to six, preferably four, beacons I, which is arranged downstream of one of the intermediate controllers, preferably hard-wired, and wherein the beacons I are respectively configured for the communication path A, a cluster of two to 10, preferably two to six, preferably three, beacons II, which is arranged downstream of one of the beacons I and wherein the beacons II are respectively configured for the communication path A and/or a plurality of beacons III, which are arranged downstream of the control device, preferably hard-wired, and configured for the communication path B.

The cluster of the beacons I is preferably installed at the hanging bag storage, in particular at a peripheral region. This enables the hanging bags to be reached and/or addressed in the entire hanging bag storage from the peripheral region into the interior with relatively short routes, in particular radio links. To that end, a selection of the corresponding one of the beacons I can be executed such that there is a distance that is as short as possible between the beacon I and the addressee. It is conceivable to provide the cluster of the beacons I as a module, in particular house it in a joint housing. A wiring effort can thus be saved. The further course of the respective communication path from the beacons I to the beacons II can be executed so as to be wireless using a route, in particular radio link, wherein the respective route can preferably always be established identically, so that a selection effort of the individual elements of the communication path A can be reduced. This means that it must merely be determined to which of the beacons II the addressee has the smallest distance. The communication path A then extends to that point, either directly or using any number of other ones of the hanging bags as intermediaries. The communication path from the respective beacon II to the central control device then extends along the preselected and/or preferably establishable route to an assigned one of the beacons I and through the hard wires via the assigned intermediate controller and from there to the central control device.

Alternatively, it is conceivable, for reducing the transmitting power density even further, to communicate with very closely located hanging bags and/or addressees directly with a route from the beacons I as an exception to the communicating using the respective assigned one of the beacons II.

Preferably, the beacons II inside the hanging bag storage, in particular at traffic hubs, are arranged downstream of the respective beacon I, in particular according to a distance pattern, in particular so as to be distributed almost evenly or distributed evenly, inside the hanging bag storage, preferably via a radio link. The beacons II can be arranged, for example, at transitions and/or crossings between regions in which the hanging bags are stored, i.e. moved little, to shunting routes, in which the hanging bags are sorted, and/or express routes, on which the hanging bags travel relatively quickly between the storage areas and an entry/exit and/or sorting device and/or circular conveying plant.

It is possible to arrange the plurality of beacons III hard-wired downstream of the control device. The beacons III can also respectively be installed at the hanging bag storage, in particular at a peripheral region of the hanging bag storage. In contrast to the beacons II, the beacons III can be installed at the entries/exits and/or sorting device and/or circular conveying plant and/or handover buffer. Using the beacons III, the communication required for a sorting operation and/or retrieval operation can take place locally and so as to be bundled and thereby be particularly resource saving, i.e. with a relatively low power density and high data rate.

Another preferred possibility is that the communication path A can be directed from the central control device to an addressed one of the hanging bags and/or to the addressee via one of the intermediate controllers, one of the beacons I, one of the beacons II, or directly from one of the beacons I, using which a route to the addressee and/or to the beacon II can respectively be set up, and/or a plurality of the hanging bags to the addressee, i.e. in particular to the addressed one of the hanging bags, and, independent of that, the communication path B can be directed from the control device via one of the beacons III to the addressee and/or simultaneously to another addressee, wherein the communication paths A and B have different communication protocols and/or routes. Data can be transmitted using two paths, wherein the routes used to that end can be kept particularly short in order to reduce the overall transmitting power density and thus also an electricity consumption of the hanging bag storage.

The intermediate controllers can be equipped with an independent computing capacity and are preferably hierarchically subordinate to the central control device. The intermediate controllers themselves can therefore take over tasks and unburden the central control device.

The beacons III can also be arranged downstream of the central control device and enter into a communication with the addressee via the route as soon as the addressee is within a range of the beacon III. The route can be a bidirectional transmitting/receiving route, wherein data can be transmitted to the central control device also by the addressee and/or by the corresponding hanging bag.

In a particularly preferred exemplary embodiment, the hanging bag storage is designed for and/or comprises at least 500,000, in particular at least 750,000, at least 1,000,000, at least 1,500,000, preferably between 500,000 and 1,500,000, hanging bags, wherein the hanging bags can be electively addressed, communicated with and/or controlled by the control device by and using the two communication paths A and B. This enables the entire hanging bag storage to be controlled flexibly.

In another exemplary embodiment, the beacons I, the beacons II and the hanging bags each comprise a first transceiving device configured for the communication path A, which are electively configured for receiving, sending or relaying messages, wherein a number of the transceiving devices used for transmitting an individual message via the communication path A is flexible. The communication path A can therefore be adapted to the location of the addressee inside the hanging bag storage, wherein a splitting into multiple individual routes can reduce the transmitting power over the entire distance in comparison to a single route, in particular radio link. A power of the individual transceiving devices can be designed so as to be relatively low and thus resource saving.

Further, it is conceivable that the intermediate controllers are arranged hard-wired downstream of the control device, the clusters of the beacons I are arranged hard-wired downstream of the respective intermediate controller, the clusters of the beacons II are arranged or arrangeable downstream of the respective beacon I using a preferably establishable one of the routes and the addressee can be addressed and/or communicated with using one of the beacons II or from the beacon II using any number of other ones of the hanging bags. The communication between the control device and the addressee takes place preferably partially wired and partially using the route, in particular radio link. The partially wired communication additionally enables the transmitting power to be reduced to a minimum without having to relinquish the advantages of an individual radio communication with the hanging bags independent of the current location.

It can finally be provided that the beacons III and the second transceiving devices of the hanging bags have the Bluetooth Low Energy (BLE) standard and the communication path B can be established according to this standard. This can take place directly between the respective beacon III and the addressee. There can be a communication which is quick, limited to regions of the hanging bag storage and preferably bidirectional, in particular for special tasks such as sorting or storing and retrieving. Other tasks, such as the controlling of a simple relocating between two locations inside the hanging bag storage, in particular over longer distances, can take place using the communication path A, which, due to its high flexibility and range, can communicate with any addressee at any location inside the hanging bag storage. The communication path A can preferably be used for a waking up and rearranging of one of the hanging bags after a longer inactive phase, for example for a storage of a storage article or storing of the empty hanging bag.

It is also conceivable that immobile beacons II are provided in the hanging bag storage in addition to the cotraveling transceiving devices. The beacons II can preferably comprise transceiving devices which have identical structures and/or an identical or at least similar protocol as the cotraveling transceiving devices. The beacons II can preferably be used for the communication between the respective beacons I and the respective beacon II. This has the advantage that the communication path A of the first channel can be set up electively using a stationary radio link between the beacons I and the beacons II or directly from one of the beacons I to one of the cotraveling transceiving devices. This means that it is not imperatively required to establish the communication path A via one of the beacons II. Electively, one of the cotraveling transceiving devices of one of the hanging bags can also be radioed directly by one of the beacons I.

For a selection of the communication path A to be established, an artificial intelligence can be used. It is also conceivable to use existing systems and protocols for this purpose which are known as the industrial internet of things (IIoT). The intermediate controller can also comprise and/or be adapted to such a protocol and be designed for communicating with the beacons I accordingly.

Using this communication path A, all hanging bags of the hanging bag storage can be addressed flexibly, preferably bidirectionally. Namely in order to send the hanging bags a message starting from the central controller, for example the route instruction, or in order to transmit a message in the opposite direction, for example to report congestion and/or a breakdown. Particularly advantageously, a radio traffic and/or a transmitting power inside the hanging bag storage can be reduced by providing another channel and/or communication path B at specific points, in particular at peripheries of the hanging bag storage, preferably in the region of retrieval devices, for example conveying plants, in particular circular conveying plants, conveying in a vertical direction. A communication need occurring there for the retrieval can in particular take place using a second radio system and/or using relatively short routes, for example over a few centimeters up to approximately 10 meters. Such technology is known, for example, by the term Bluetooth Low Energy, Bluetooth LE (BLE in short). It extends from a beacon III respectively bidirectionally to one of the hanging bags. Preferably, different messages in comparison to the first communication method can be exchanged with the hanging bags. However, it is also conceivable for reasons of simplification that at least the messages sent to the hanging bags such as the route directions are identical. This enables a complexity of the communication and an effort for the control of the hanging bags themselves to be reduced further.

As soon as one of the hanging bags reaches a reception range of one of the beacons III, in particular one of the conveying plants, a handshake can take place and the beacon III takes over the communication. The beacons III are preferably subordinate to the same central controller and can electively comprise another independent control/computing capacity and a corresponding other protocol.

The communication can take place, preferably in the region of the entire hanging bag storage, using the communication path A, which can have a cooperative and highly flexible network and/or can respectively be set up using this network. This highly flexible network can have both stationary and moving participants, which is also known by the term Meshnet. Here, the participants can be designed and/or configured respectively as senders, recipients and as intermediaries for relaying a message. A multiple communicating with surrounding radio network participants is therefore electively also possible. However, this Meshnet, in turn, can be hierarchically structured in itself in terms of the non-movable intermediate controllers subordinate to the central controller, the subordinate and permanently mounted beacons I and the also permanently mounted beacons II. As a particularity, the beacons II, while preferably being equivalent in terms of protocol, are stationary, so that the beacons II can have a prominent role in the flexible structuring of the connection paths, i.e. of the respective communication path A, which reduces a radio load without increasing a complexity of the system. To that end, the network can be designed so as to be self-learning and automatically identify non-moving participants and preferably use them to set up the connection. The hierarchy of the communication path A can therefore preferably be generated by a self-learning process and/or adaptation.

A communication density inside the hanging bag storage can be automatically and dynamically adapted, for example a communication density and a traffic volume are usually relatively low in pure storage areas, as the storage articles are stored there without movement for multiple hours to days.

The communication path B can provide an additional relief by being used in regions with a high communication requirement, for example in conveying plants and sorting devices inside the hanging bag storage. To that end, the communication path B can have a radio channel and/or radio frequency and/or radio standard deviating from the communication path A.

In the region of a conveying and/or sorting plant, there is an increased need for communication and traffic in a relatively small space, which can be easily managed using the second bidirectional protocol (BLE) of the second communication path B, whereby the highly flexible Meshnet of the first communication path A can advantageously be unburdened. What is more, an overall radio power of the hanging bag storage can be reduced. What is more, this enables time critical operations to be controlled better.

The object is furthermore achieved in a method for operating a hanging bag storage equipped with at least partially autonomously or autonomously displaceable hanging bags by at least partially autonomous traveling of the hanging bags and wireless, in particular partially wireless and partially wired, handing over of messages to the hanging bags for controlling the at least partially autonomous traveling using a communication path A and a communication path B independent thereof. The communication can take place in parallel, electively and flexibly and/or task-specific on two channels and with a relatively high data rate and a relatively low transmitting power density. The method is preferably executed with a hanging bag storage described above. In this respect, this results in the advantages described above.

In a preferred embodiment of the method, a handshake is executed as soon as a respective one of the hanging bags is within a range of one of the beacons III and the control of the respective one of the hanging bags is taken over using the communication path B for executing a sorting operation, retrieval operation and/or storage operation of the hanging bag storage. The communication path A can be executed throughout the entire hanging bag storage, wherein the communication for the operation(s) can take place with the communication path B. To that end, the communication path B can take over in case of an approach, wherein the communication path B can be designed for relatively short distances, in particular according to a known industrial standard such as BLE. A handover can take place as soon as the respective hanging bag approaches one of the beacons III.

Alternatively or additionally, it is possible to use the respective cotraveling second transceiving devices of the hanging bags configured for the communication path B for a travel dynamic control, a distance control and/or collision avoidance. To that end, hanging bags located in a vicinity inside the hanging bag storage or on a joint travel path can additionally contact one another using the communication path A, preferably derive a mutual distance therefrom, in particular in order to make decisions on that basis as to which measures such as adapting a travel speed to one another and/or halting to avoid a collision and/or traveling in convoy are required. Therefore, a second task can be fulfilled on the short distances. An additional effort can be relinquished and/or an overload of one of the communication paths A or B be avoided. Further, it is conceivable that time responses of the communication paths A and B differ from each other, wherein the communication path B can have a time response adapted to the tasks and/or better time response than the communication path A, for example for managing the tasks, in particular the longitudinal control.

The first channel and/or communication path A is used to send messages, for example such as a route instruction, from the central control device to individual hanging bags. These individual hanging bags then control at least partially autonomously a route on a network in order to reach a destination contained in the route instruction. This can be executed by the central control device via a plurality of subordinate intermediate controllers, from these respectively via a plurality of beacons I, and from these via transceiving devices, which interconnect network-like and act as intermediaries up to a specific addressed one of the hanging bags. The intermediate controllers can have an independent computing capacity.

The communication between the central control device, intermediate controller and the beacons I can be wired and the other communication can take place through the transceiving devices using a plurality of radio links which can be set up over short distances of a few meters, in particular maximally 100 meters, preferably maximally 20 meters. This enables a transmitting power to be kept and/or set up low and the then respectively actually realized communication path A of the first channel to be kept and/or set up flexible.

Preferably, the transceiving devices of the communication path A and/or B can cotravel with the hanging bags, i.e. the hanging bags can comprise the transceiving devices.

The same messages can be sent using communication paths A and B and preferably the information as to distance to the other hanging bags can additionally be obtained using the communication path B.

In this application, a beacon can be understood to mean an immobile signal fire which addresses traveling participants, in particular a transceiving device, which can set up a communication with the traveling hanging bags, in particular a bidirectional communication and/or Meshnet, preferably according to a BLE and/or IIoT standard. It can also be understood to mean a stationary transceiving device which relays messages and electively amplifies messages in the sense of a relay station and/or repeater, i.e. enables a greater range with a relatively low overall transmitting power.

Using the communication path A, it is conceivable to send a message electively to multiple of the hanging bags simultaneously or to only one of the hanging bags. To that end, the hanging bags which are to receive one of the messages together can have a joint identifier to which the joint message can be addressed. Similarly to the broadcasting principle, this enables individual messages and thus radio traffic to be saved.

In one embodiment of the hanging bag storage, it can be provided that a density of the hanging bags and/or roll adapters on the network viewed in an x-direction and/or direction of travel and in case of a traveling in convoy or a storage in standstill, is up to 20 of the hanging bags, in particular between 10 and 20 of the hanging bags, per meter and/or the network comprises a plurality of travel paths with this density arranged in parallel viewed in a y-direction and/or z-direction, wherein the hanging bags and/or roll adapters and/or the addressee can be electively addressed, communicated with or controlled by the control device by and using the two communication paths A and B. A relatively large number of the storage articles can be stored, sorted and moved in a small space, wherein a radio power density can be kept so low despite the high density of hanging bags that a reliable addressing remains possible.

What is more, it is possible in an alternative that the communication path A can be set up over a first greater distance or over the first greater distance which extends in the region of the entire hanging bag storage and the communication path B can be set up over a second smaller distance or over the second smaller distance which extends in regions of the hanging bag storage with a high communication requirement and/or can be set up inside the hanging bag storage in conveying plants and sorting devices with the high communication requirement. This enables a communication adapted to the communication tasks occurring during autonomous traveling, storing, sorting and retrieving. In this manner, the radio power density can be kept low.

Further, it is conceivable that the communication path A has a highly flexible and/or self-learning Meshnet, and/or wherein a hierarchy of the communication path A can be adapted and/or generated by a self-learning operation. A programming and control effort for a routing can thereby be relinquished in addition.

Finally, it is alternatively or additionally possible that the communication paths A and B have different time responses, and/or the communication path A has a relatively slower time response than the communication path B, which time response is adapted to the storing and addressing at rest, and/or that the communication path B has a faster time response than the communication path A, which time response is adapted to the sorting or sorting and controlling in conveying plants and sorting devices with a high communication requirement inside the hanging bag storage. The communication tasks inside the hanging bag storage can be flexibly adapted to regions with a high communication requirement and simultaneously high requirements for the time response.

Further advantages result from the subclaims as well as from the description of a preferred exemplary embodiment below.

### BRIEF DESCRIPTION OF THE FIGURES

Below, the disclosure is explained in more detail on the basis of an exemplary embodiment represented in the figures. These show:

FIG. 1 a schematic three-dimensional lateral oblique view from the top front of a hanging bag storage system having a hanging bag storage;

FIG. 2 a schematic lateral view of a hanging bag for the hanging bag storage shown in FIG. 1;

FIG. 3 a schematic lateral view of multiple of the hanging bags shown in FIG. 2 on a rail network;

FIGS. 4A to 4H a schematic view of a circular conveying plant in phases A to D during a sorting operation of storage articles;

FIG. 5 a flow chart of a method for retrieving storage articles from the hanging bag storage shown in FIG. 1;

FIG. 6 another flow chart of a method for retrieving storage articles from the hanging bag storage shown in FIG. 1,

FIG. 7 a block diagram of a handover configuration of the hanging bag storage shown in FIG. 1 to illustrate a material flow when sorting and retrieving storage articles;

FIGS. 8A-8C a schematic view of the handover configuration in different operating phases to illustrate a sorting operation when retrieving storage articles from the hanging bag storage shown in FIG. 1;

FIG. 9 a flow chart of a method for retrieving storage articles from the hanging bag storage shown in FIG. 1;

FIG. 10 the block diagram represented in FIG. 7 but in combination with another handover configuration for retrieving individual storage articles;

FIG. 11 the handover configuration shown in FIG. 10 in interaction with another handover configuration analogous to the block diagram from FIG. 8;

FIG. 12 a handover configuration analogous to the one described in FIGS. 5 and 6 with a preferably flexibly assignable express track;

FIG. 13 a flow chart of a method for picking storage articles received in hanging bags, a schematic view of a level of a hanging bag storage to illustrate a retrieval FIG. 14 with a reversal of a direction of motion;

FIG. 15 a schematic view of the level of the hanging bag storage to illustrate a retrieval with an encircling of a storage route;

FIG. 16 a schematic view of the level of the hanging bag storage to illustrate a retrieval with an encircling/a reciprocating;

FIG. 17 a schematic view of the level of the hanging bag storage to illustrate a rearranging of a storage article;

FIGS. 18, 19 flow charts of a method for operating the hanging bag storage shown in the preceding figures,

FIG. 20 a view of a part of a level of the hanging bag storage shown in the preceding figures with a first and second communication configuration for realizing two communication paths A and B;

FIG. 21 a partial view of the level represented in FIG. 20,

FIG. 22 a tree diagram of a hierarchical structure of the first and second communication configurations of the hanging bag storage shown in the preceding figures,

FIG. 23 a partial view of the tree diagram shown in FIG. 22 with the communication path B; and

FIG. 24 a flow chart of a method for operating a hanging bag storage equipped with at least partially autonomously or autonomously displaceable hanging bags.

### DETAILED DESCRIPTION OF PREFERRED EXEMPLARY EMBODIMENTS

The disclosure will now be explained in more detail by way of example with reference to the enclosed drawings. However, the exemplary embodiments are only examples, which are not to limit the inventive concept to a particular configuration. Before describing the disclosure in detail, it should be noted that the disclosure is not limited to the respective components of the device and the respective method steps, as these components and methods may vary. The terms used here are merely intended to describe particular embodiments and are not used restrictively. If in addition the singular or indefinite articles are used in the description or in the claims, this also refers to the plural of these elements, unless the overall context unambiguously illustrates otherwise.

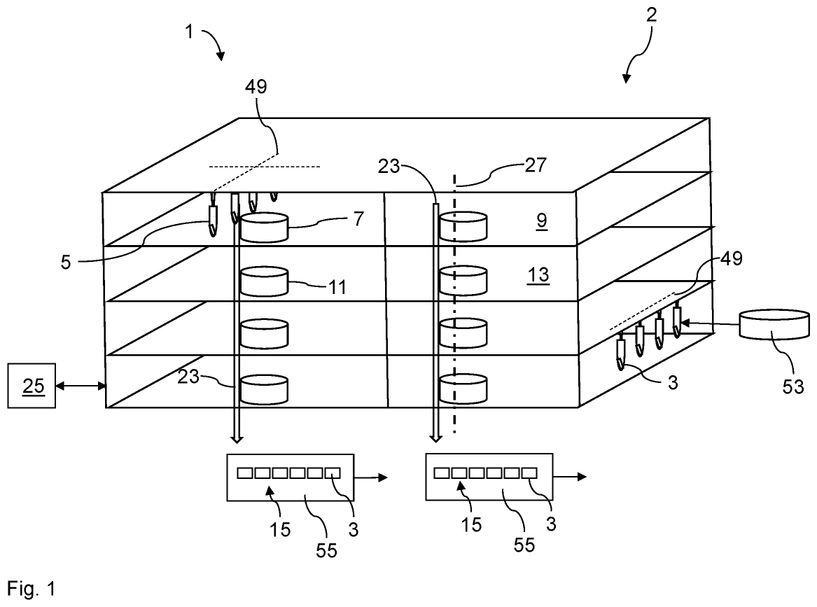

FIG. 1 shows a schematic three-dimensional lateral oblique view from the top front of a hanging bag storage system 2 with a hanging bag storage 1.

Depending on the use case, the hanging bag storage 1 can have precisely one level, in particular have at least one level or preferably at least two levels 9, 13, represented here is a total of four, wherein a first level 9 and a second level 13 are provided with reference numbers by way of example. More or fewer levels are conceivable, for example 10 levels or more, which are arranged vertically on top of one another.

Each of the levels 9, 13 of the hanging bag storage 1 respectively have a handover buffer 7, 11, of which also only a first handover buffer 7 and a second handover buffer 11 are provided with reference numbers.

The hanging bag storage 1 serves to receive, store, sort and/or retrieve storage articles 3, electively as a pure storage or sorting device. The handover buffers 7, 11 are preferably arranged vertically on top of one another, which is symbolized by a line 27. However, it is also conceivable to arrange only at least two of the handover buffers 7, 11 on top of each other and/or arrange them obliquely to a perpendicular direction in space along the line 27.

Along the imaginary line 27 along which the handover buffers 7, 11 are arranged extends also a circular conveying plant 23, preferably a plurality of circular conveying plants 23. The handover buffers 7, 11 are arranged adjacent to the circular conveying plant 23 such that the storage articles 3 can be handed over into the circular conveying plant 23 by the handover buffers 7, 11 and/or can be stored in the levels 9, 13 and/or in the handover buffers 7, 11 of the levels 9, 13 by the circular conveying plant 23.

In one exemplary embodiment, the storage articles 3 are handed over directly into the circular conveying plant 23. Preferably, the storage articles 3 are handed over into the circular conveying plant 23 while located in a hanging bag 5 of the hanging bag storage system 2. Particularly preferably, there is an autonomous driving, in particular using a cotraveling electrical drive, controlling and/or moving of the entire hanging bag 5 before the provisioning, during the provisioning and/or handing over of the hanging bag 5. The method is preferably executed using electrical drives, in particular without trail chains and/or pusher dogs. To that end, the hanging bag storage 1 is structured without trail chains and/or pusher dogs for example at least in regions or entirely, preferably at least inside the levels 9, 13.

To that end, the hanging bag storage 1 has a network 49, for example a rail network with connecting sections and ramifications such as crossings and/or switches. Preferably, the network 49 is a grid with straight-lined rails that are interconnected by the crossings and/or switches. For example with rectangular network meshes.

To store the storage articles 3 in the hanging bag storage, the hanging bag storage has a handover point 53, at which the individual storage articles are handed over into individual hanging bags 5. Preferably, only respectively one of the storage articles 3 per hanging bag 5 is handed over. However, multiples ones are also conceivable, provided that there is sufficient space for them in the corresponding hanging bag 5. In the handover point, the storage articles 3 can electively be buffered and handed over directly into the hanging bags 5, which travel toward the handover point 53 to that end and then travel onward, preferably autonomously, to a storage location of the hanging bag storage 1.

At an unloading station 55 of the hanging bag storage 1, the storage articles 3 are removed from the circular conveying plant 23 again and are available there, preferably in a specified or specifiable sequence 15. It is conceivable that a convoy of hanging bags 5, in the desired sequence 15, enter the unloading station 55 from the circular conveying plant 23 and/or are handed over into the unloading station 55 by the circular conveying plant 23, unloaded at the unloading station 55 and then travel back to be loaded again. The unloading station 55 can be arranged inside or outside one of the levels 9, 13, preferably in a lowest level.

However, it is alternatively also conceivable that the hanging bags 5 are conveyed using the circular conveying plant 23 and unloaded at the unloading station 55 in the desired sequence and immediately transported back into the hanging bag storage 1 empty using the circular conveying plant 23, i.e. without the respective hanging bags 5 remaining in the unloading station or being available there, for example to travel or be transported onward to the handover point 53 after the unloading.

Particularly preferably, the hanging bags 5 are designed such that they travel autonomously on the network 49. Hanging bag storages 1 with autonomously traveling hanging bags 5 are known and described in DE10 2018 128 417 A1, for example, so that a detailed description is relinquished here. Preferably, a control device 25 of the hanging bag storage system 2 is provided for a monitoring and controlling of the hanging bag storage 1, in particular for specifying the desired sequence 15 and controlling the circular conveying plant 23, which control device exchanges information with the functional units of the hanging bag storage 1.

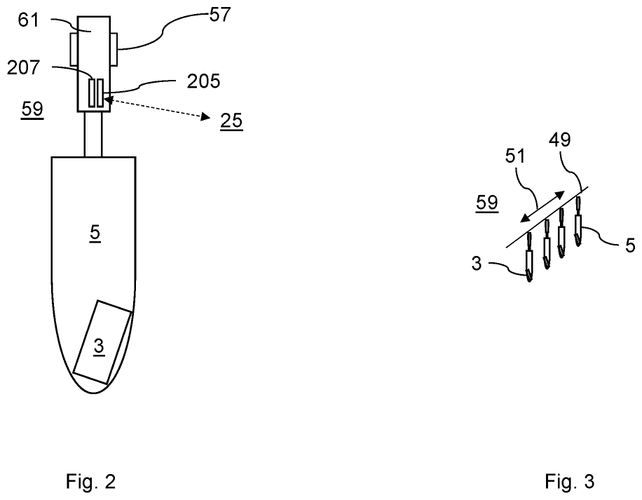

FIG. 2 shows a schematic lateral view of such a hanging bag 5 for the hanging bag storage 1 shown in FIG. 1.

FIG. 3 shows a three-dimensional view of multiple of the hanging bags 5 shown in FIG. 2, hooked into the network 49 for example designed as a rail network.

To that end, the hanging bags 5 have wheels 57 and can be driven by a drive energy merely indicated by reference number 59 and by a drive using this drive energy. The hanging bags 5 can be configured having two parts and can comprise a roll adapter 61 and a bag material, in particular flexible and/or foldable material, in which a storage article 3 can be received and which is and/or can be suspended on the roll adapter 61 and released again, in particular nondestructively. In FIG. 3, a double arrow 51 indicates possible directions of motion of the hanging bags 5 in the network 49. The hanging bags 5, in particular their roll adapters 61, are configured, programmed and/or designed for the autonomous or partially autonomous traveling on the network 49. To that end, the hanging bags 5, in particular the roll adapters 61, can have the independent drive, preferably electrical drive, and respectively one independent longitudinal and transverse dynamics control. The hanging bag storage system 2 therefore comprises the roll adapters 61 and the hanging bags 5 suspended or suspendible on the roll adapters 61. For reasons of simplification, the word hanging bag or roll adapter can be used on its own in this application to describe states of motion, wherein this may simultaneously also refer to the traveling combination and/or unit of a roll adapter 61 with the hanging bag 5 suspended on it.

Preferably at least two states of motion of the following group can be set using the longitudinal controller: stopping and traveling forward. Preferably from the group: traveling backward, stopping and traveling forward. Particularly preferably, respectively different speeds and/or transient states of motion can be set here, in particular in combination with a longitudinal acceleration regulator/controller. In one particular configuration, the longitudinal dynamics control can comprise an electric motor, in particular as an independent drive, and set at least one state of motion of the group: “traveling forward, traveling backward, stopping, accelerated traveling forward, accelerated traveling backward, braked traveling forward, braked traveling backward.”

The transverse dynamics control can in particular comprise electrically controllable steering elements and set at least one state of motion of the group: traveling straight, turning left, turning right.

Preferably, the network 49 can be designed passive, i.e. without adjustment elements. Without adjustment elements can be understood to mean that the network 49 comprises no active adjustment elements which impact a transverse dynamic of the roll adapters 61 and/or hanging bags 5 and on which wheels or contact surfaces can be supported transverse to the direction of travel for causing a change of direction adjustable on the network side, such as they are known from classic adjustable switches, for example.

Particularly preferably, the network 49 is structured so as to be horizontal or essentially horizontal. Essentially horizontal can be understood to mean here that the roll adapters 61 traveling on the network 49 do not roll away automatically, induced by gravity, during a standstill, i.e. they can preferably be structured without parking brakes. Therefore, the drive and/or the drive energy 59 is/are in this case gravity free, hence not gravity-induced. What is more, the drive can be designed as an electrical drive, wherein the longitudinal dynamics control and/or the drive can be executed/provided without trail chains, gravity and/or pusher dogs.

In FIG. 2, the hanging bag 5 is represented with a storage article 3 received therein. The storage article 3 is located inside a material, in particular flexible material, suspended in a U-shape. A loading and unloading can in particular take place from above or laterally.

To the extent that the terms x-direction, y-direction and z-direction are used in this application, they can be understood to mean a Cartesian coordinate system cotraveling with the hanging bags 5 and/or roll adapters 61, in particular their drive, wherein the x-direction can mark a direction of travel, the y-direction can mark a direction transverse to the direction of travel extending horizontally in case of a level travel motion and the z-direction can mark a direction perpendicular to the remaining axes extending vertically and/or vertical axis of the roll adapter 61 and/or of the hanging bag 5.

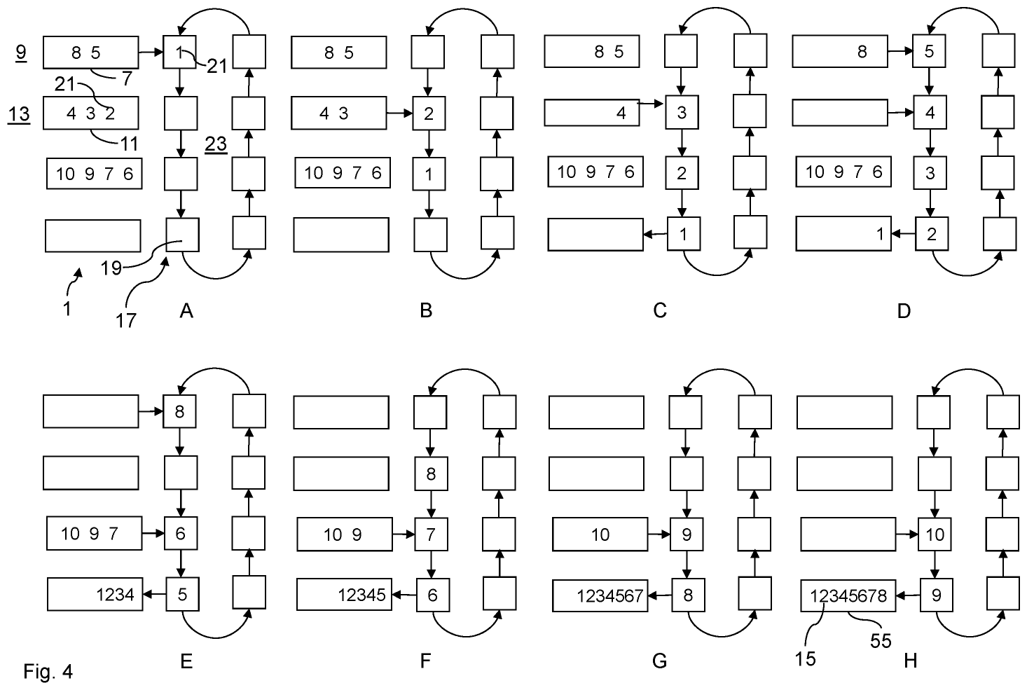

FIGS. 4A to 4H show a schematic view of a circular conveying plant 23 analogous to the one described in FIG. 1 in phases A to H to illustrate a sorting operation of storage articles 3. FIG. 4 shows a part of the hanging bag storage 1 in a schematic representation with four handover buffers, distributed over four levels, respectively designated first to fourth from top to bottom. To improve clarity, reference numbers, which correspond to the ones in FIG. 1, are provided only in the phases A and E, wherein reference numbers for the third and fourth level were also relinquished for simplification.

The storage articles 3 are handed over into the circular conveying plant 23 by the handover buffers 7, 11 of the levels 9, 13 and conveyed into the unloading station 55 by the circular conveying plant 23.

Simultaneously, a sorting of the storage articles 3 according to a sequencing criterion 21, in this case for example numbers from 1 to 10, takes place.

The circular conveying plant 23 comprises storage locations 19, which are arranged in succession along a series 17, for conveying, receiving and transferring storage articles 3. Here preferably interlinked and driven circumferentially using a drive not represented in more detail, which is indicated in FIG. 4 by straight and curved arrows. Preferably, the series 17 of the storage locations 19 of the circular conveying plant 23 is arranged vertically, similar to a paternoster. However, it is also conceivable to arrange the series 17 obliquely.

Preferably, the sequencing criteria 21 are assigned both to the individual storage articles 3, which is symbolized by digits in FIG. 4, and to the storage locations 19 of the series 17. This assignment is a possibility to control and can also be executed in a purely virtual manner and/or by a random assignment. This enables the storage articles 3 to be sorted into the storage locations 19 in the specified sequence 15. The designations #1 to #10 are used to describe the sequencing criterion. As soon as a, in particular empty, storage location 19 with the same sequencing criterion 21 as in one of the handover buffers 7, 11 is directed past the one of the handover buffers 7, 11, a handover into the corresponding storage location 19 takes place. In FIG. 4, handovers are symbolized by arrows.

In phase A, the storage article #1 is sorted into the storage location #1 by the first handover buffer 7 on the first level 9.

In phase B, #2 is sorted in direct succession, starting from the second level 13. To that end, the circular conveying plant 23 has moved onward by two positions, so that there is an empty storage location 19 in the first level and the storage article #5 waits there. There is no handover, as the storage location 19 of the first level in phase A is provided for receiving the #3, i.e. there is no match.

This becomes clear also in phase C, where the series 17 has moved onward by one position. In the first level, the storage location #4 is now located in front of storage article #5. Again, there is no handover. In the second level, however, the sequencing criteria match and #3 is handed over.

Partial representation D of FIG. 4 shows three actions, #5 is handed over in the first level, and #4 in the second level. In the third level, there is no action, as the storage location #3 is already filled and also the storage article #6 waits there. This means that there is also no match. When the provisioning and assigning of the sequencing criteria 21 of the storage articles in the handover buffers are executed correctly, a check as to whether the storage location 19 is already occupied as well as a corresponding sensor system can therefore electively be relinquished. However, such a checking step can alternatively be provided for good measure.

In the fourth level, there is a handover and/or a transfer of the #1 into the unloading station 55. The unloading station 55 can be arranged as part of the fourth level or outside the levels of the hanging bag storage.

In phase E, a handing over is only resumed after the series 17 has moved onward by three positions, as the sequencing criteria of the handover buffers then match the storage locations. Irrespective of this, there is a continuous transfer into the unloading station in the fourth level, in which unloading station #1 to #5 are already stored after phase E. #8 is received in the first level and #6 in the third level. In the second level 13, there is no action, as the second handover buffer 11 is already empty. It is noticeable that storage location #7 has remained empty due to the assigned sequencing criteria 21.

As can be seen in phase F of FIG. 4, storage location #7 is filled from the third level and from the third handover buffer. Also the storage articles #8 to #10 which remained in the third handover buffer are handed over from the third level, which is represented in phases G and H. It can be seen in phase H that the storage articles 3 have arrived in the unloading station in the sequence #1 to 10.

It can be seen that a storing and/or handover into the series 17 does not necessarily take place every time the series 17 moves onward by one position, so that storage locations 19 electively remain empty at first but are then continuously filled up in levels located below. This means that a capacity utilization of 100% of the storage locations 19 arriving at the unloading station 55 is possible.

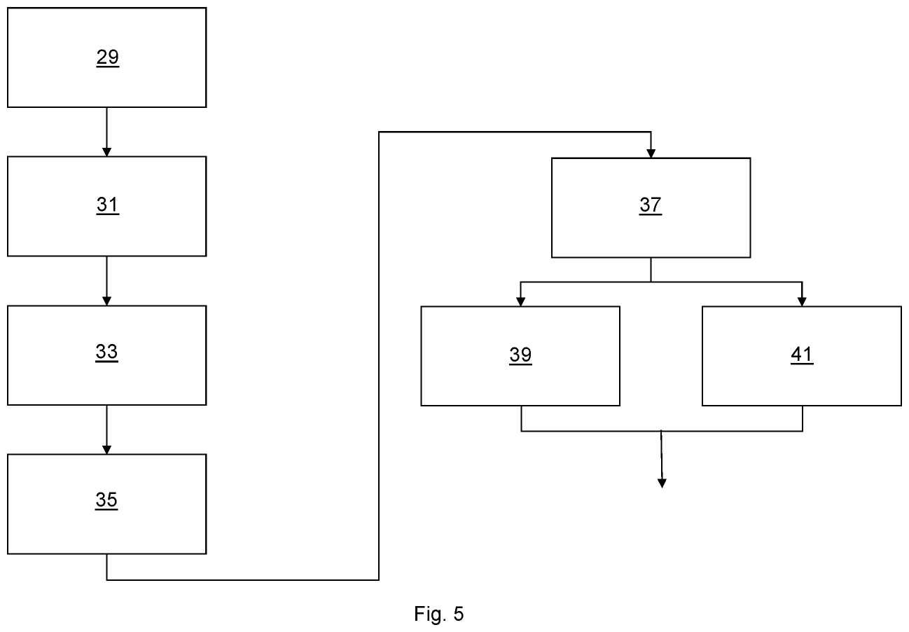

FIG. 5 shows a flow chart of a method for retrieving storage articles 3 from the hanging bag storage 1 shown in FIG. 1. Also the preceding figures are referenced.

In the first step 29, the first handover buffer 7 is provisioned, which is located in the top first level 9 of the hanging bag storage. Below the first handover buffer 7—in particular vertically below, along the imaginary line 27—the second handover buffer 7 is located in the second level 13, which handover buffer 7 is also provisioned in a second step 31.

In a third step 33, the sequence 15 of the storage articles 3 for the imminent retrieval is specified. The sequence 15 can have any sequencing criterion 21, for example a series of numbers or letters, in particular be virtually assigned.

A fourth step 35 comprises a provisioning of the storage articles 3 in the handover buffers 7, 11 of the respective level 9, 13 of the hanging bag storage 1 for the imminent retrieval. Preferably, the storage articles 3 in the handover buffers 7, 11 are presorted according to the sequence 15 and/or at least presorted there and/or provisioned in the sequence 15 so as to be pickable.

As a fifth step 37, a series 17 of storage locations 19 for receiving at least one of the storage articles 3 is provisioned. This may be an interlinked series 17. In particular an annular and circumferentially drivable chain with the storage locations 19 of the circular conveying plant 23.

Then, a directing of the series 17 of storage locations 19 past the handover buffers 7, 11 is executed as a sixth step 39 and a simultaneous handing over of the storage articles 3 provisioned in the handover buffers 7, 11 from the respective handover buffer 7, 11 into the storage locations 19 in the specified sequence, respectively, is executed as a seventh step 41. Here, the desired sequence 15 is mapped in the series 17 of the storage locations 19.

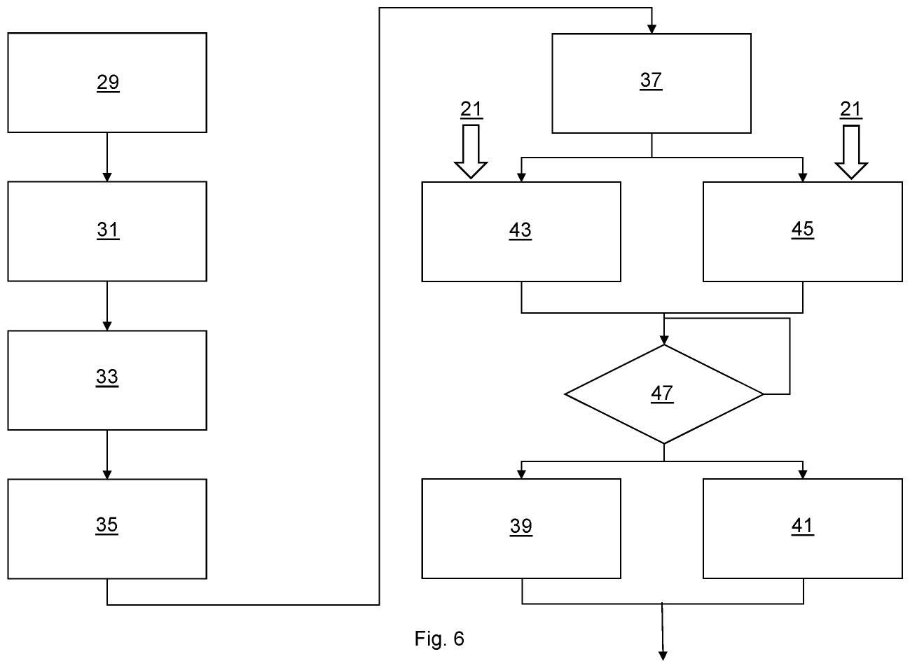

FIG. 6 shows another flow chart of a method for retrieving storage articles 3 from the hanging bag storage 1 shown in FIG. 1. The exemplary embodiment is based on the method shown in FIG. 5, to which reference is also made. Only the differences are explained.

In contrast, the method of FIG. 6 additionally has an eighth step 43, a ninth step 45 and a query 47, which are arranged before steps 39 and 41. There is a double assigning of the ordinal sequencing criteria 21. This enables pairs for the handovers to be formed. The empty storage locations 19 of the series 17 are assigned the ordinal sequencing criteria 21 in the eighth step 43, in particular virtually, using the control device 25. In the ninth step 45, the ordinal sequencing criteria 21 are likewise assigned to the individual storage articles 3 which are waiting and/or arriving in the respective handover buffer 7, 11.

The query 47 follows, which branches back on itself if a storage location 19 is directed past a waiting storage article 3 and the sequencing criteria do not match. If the sequencing criteria match, however, the query branches out into the steps 39 and 41, and the storage article 3 or storage articles 3 waiting in the respective handover buffer 7, 11 are sorted into the series 17. This results in a continuous filling of the storage locations of the series 17.

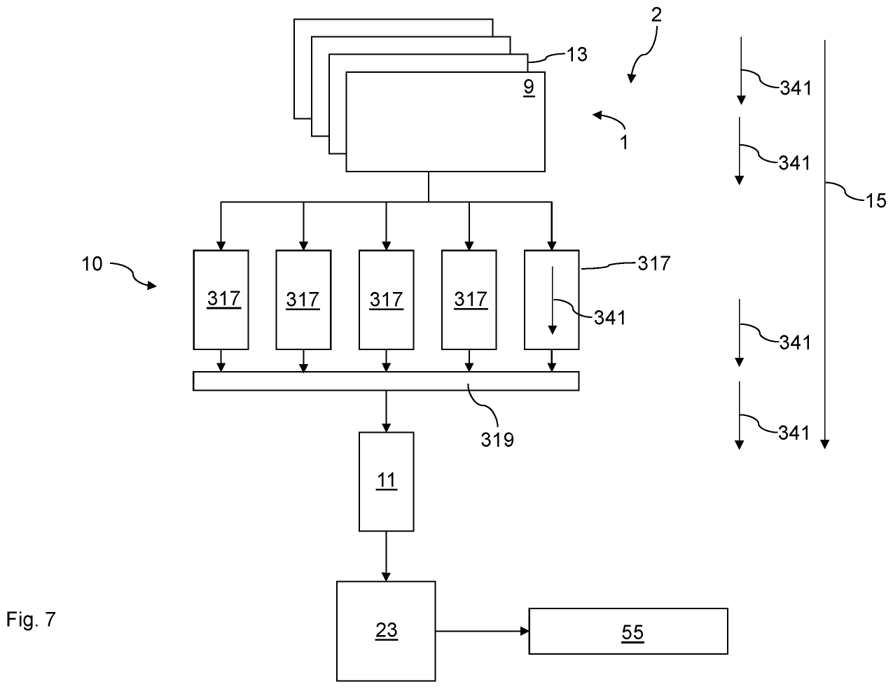

FIG. 7 shows a block diagram of a handover configuration 10 of the hanging bag storage 1 shown in FIG. 1 to illustrate a material flow when sorting and retrieving the storage articles 3; The four levels 9, 13 of the hanging bag storage 1 shown in FIG. 1 can be seen as four blocks represented on top of one another. Viewed in a direction of the material flow of the storage articles 3, a handover configuration 10 is arranged downstream of the levels 9, 13, respectively. For simplification, FIG. 7 shows only one of the handover configurations 10. It is conceivable that only one of the levels 9, 13 comprises a handover configuration. Also, more than one, in particular one handover configuration per level, can be provided. Finally, multiple of the handover configurations 10 can be provided in one or multiple of the levels.

In the exemplary embodiment of FIG. 7, a total of five first in, first out buffers 317 are arranged downstream of the second level 13, in which the storage articles 3 coming from the level 13 can be stored. The sequence 15 can be specified for the storage articles, which sequence 15 can be subdivided into a plurality of subsequences 341. In FIG. 7, the material flow taking place on the basis of the sequence 15 and subsequences 341 is symbolized by arrows. Preferably, all storage articles 3 of one of the subsequences 341 are stored in one of the first in, first out buffers 317. This is symbolized in FIG. 7 at one of the first in, first out buffers 317, which is arranged on the right. The subsequence 341 can also be sorted ordinally, wherein it is irrelevant for the method whether this ordinal order is maintained inside the first in, first out buffers 317. The storage articles 3 of one of the first in, first out buffers 317 can electively be transferred into a pick buffer 319 arranged jointly downstream of the first in, first out buffers 317. The maintaining of the subsequence is therefore not relevant. The depositing of the storage articles 3 of the subsequences 341 from the respective first in, first out buffer 317 into the downstream pick buffer 319 is executed in the ordinal sequence of the subsequences, but preferably respectively intrinsically unsorted.

The respective subsequence 341 of the storage articles 3 can be created using the pick buffer 319 in combination with the second handover buffer 11 arranged downstream of the pick buffer 319. The storage articles 3 stored in the pick buffer 319 particularly preferably reciprocate back and forth and, in doing so, are handed over into the handover buffer 11 in the subsequence 341. After removing the last storage article 3, the subsequence 341 is then provided there. It is conceivable that the handover buffer 11 can receive multiple of the subsequences 341 or fewer of them. This depends electively on an overall design of the hanging bag storage 1.

It can be seen that a presorting using the subsequences 341 is first executed by the first in, first out buffers 317. The subsequences 341 are then finally brought into the superordinate sequence 15 of all storage articles 3 by the handover into the pick buffer 319, which handover is sequenced according to the ordinal sequence of the subsequences, and the picking from the pick buffer 319 into the handover buffer 11, which picking is sequenced according to the respective subsequence.

It can be seen that the superordinate sequence 15 is not limited, can electively have multiple thousand, for example up to 1,000, preferably up to 5,000, in particular up to 30,000 of the storage articles per hour. This is possible as the first in, first out buffers 317 enable an arrival of the storage articles 3 that is scattered over time. The storage articles 3 can then be collected and thereby presorted independent of the arrival time within an interval of the sequence 15 specified by the subsequence 341.

Using the first in, first out buffers 317, it is also conceivable to respond flexibly to disruptions and/or severely delayed arrivals of individual ones of the storage articles 3. In such a case, a subsequence 341 that was actually to be dispatched later can be given priority. To that end, it is advantageous according to one exemplary embodiment if the sequence 15 and/or the subsequences 341 are subdivided into batches, not represented in more detail, which preferably consist of a packing unit of ones of the storage articles 3 to be packaged jointly. The splitting of the sequence 15 can be executed such that the batches are specified as the smallest storage unit inside one of the first in, first out buffers 317, i.e. batches are always provided complete inside the first in, first out buffers 317. This can result in an under-occupancy of the first in, first out buffers 317, wherein, however, the improved robustness against delayed arrivals of individual ones of the storage articles 3, i.e. the exchangeability of the contents of the first in, first out buffers 317, can be achieved without incomplete batches having to be delivered at the unloading station 55. Furthermore, it is conceivable to hand over the first in, first out buffers 317 only partially into the pick buffer 319, wherein it is ensured that complete batches are specified as the smallest quantity of storage articles 3 to be retrieved. Thus, too, a flexibility can be increased without incomplete batches having to be delivered at the unloading station 55. An emergency buffer otherwise required there is not required. This means that batches then electively reach the unloading station 55 with a reduced sorting quality but in a desired intrinsic batch sequence.

The circular conveying plant 23 is arranged downstream of the handover buffer 11. The handover buffer provisions the storage articles in the desired sequence. It is conceivable to relinquish the handover buffer 11 and pick the storage articles 3 directly into the circular conveying plant 23 as described above. The handover buffer 11 enables an improved temporal robustness in relation to a handover time into the circular conveying plant 23, in particular if the circular conveying plant 23 picks off the storage articles 3 electively across the levels 9, 13 and completes the sequence across the levels 9, 13 in a time-coordinated manner. Therefore, storage articles 3 of a batch can then be stored distributed across the levels 9, 13. The handover buffer 11 preferably also has a first in, first out structure.

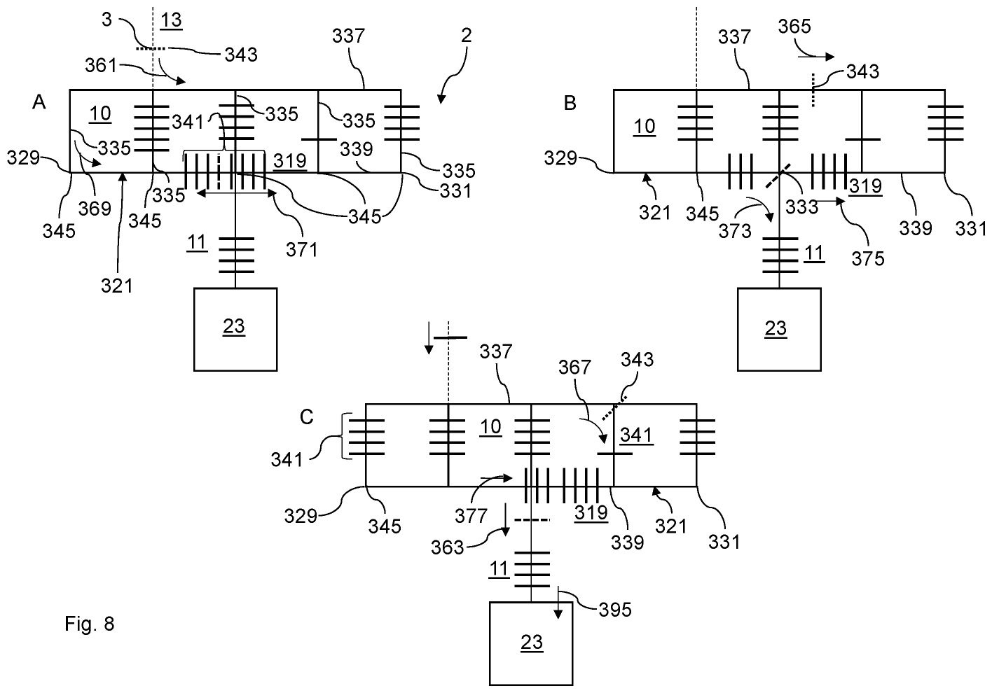

FIG. 8 shows a schematic view of the handover configuration in different operating phases A to C to illustrate a sorting operation when retrieving storage articles from the hanging bag storage shown in FIG. 1. Lines in FIG. 8 symbolize the hanging bags conveying the storage articles 3. The network 49, on which the hanging bags 5 travel preferably autonomously or at least partially autonomously, is symbolized by lines.

In phases A to C, a sorting operation using the handover configuration 10 is explained in more detail below by way of example. First, the path of a hanging bag 343 with a received storage article 3 represented by dashed lines is shown. In phase A, the hanging bag 343, coming from the level 13, moves toward and turns into an entry rail 337 of the handover configuration 10, which is symbolized by a curved arrow 361. The entry rail forms an inflow for the first in, first out buffers 317 arranged downstream of the handover configuration 10. FIG. 8 shows a total of five of the first in, first out buffers 317, which are respectively designated with the same reference number but as first to fifth first in, first out buffer 317 from left to right. The handover configuration 10 is therefore segmented into at least two, in this case five, first in, first out buffers 317 arranged in parallel. Each of the segments has a section of rail 335, in particular part of the network 49, that can be seen in FIG. 8. In phase B, the hanging bag 343 travels onward in a direction of the fourth first in, first out buffer 317. In doing so, the hanging bag 343 passes a junction leading into the second and third first in, first out buffers 317, respectively. A junction is arranged upstream of each of the first in, first out buffers 317 of the handover configuration 10. The journey of the hanging bag 343 on the entry rail 337 is symbolized in phase B by an arrow 365.

Finally, the hanging bag 343 then turns into the fourth first in, first out buffer 317 at a junction 345, which is symbolized in phase C of FIG. 8 by a curved arrow 367. There, another one of the hanging bags, which belongs to a fourth subsequence 341 assigned to the fourth first in, first out buffer 317 in phases A to C, is already waiting. In phase C, it can furthermore be seen that another one of the hanging bags is already approaching the handover configuration 10. The other one of the hanging bags also belongs to the fourth subsequence and is accordingly stored in the fourth first in, first out buffer 317. The presorting described above is thus executed, independent of an arrival sequence of the hanging bags at the entry rail 337. It can be seen in phase C that other hanging bags have meanwhile arrived in phase C, which belong to a sixth subsequence 341 of the first first in, first out buffer 317, although the fourth first in, first out buffer 317 in this example is still waiting for other hanging bags, which are not depicted.

Parallel to this presorting, the creating of the sequence 15 takes place. In phase A, it is shown by a curved arrow 369 that all hanging bags belonging to a first subsequence 341 have traveled onward from the first first in, first out buffer 317 into an exit rail 339 using a first junction 345. A junction 345 leading into the exit rail 339 is respectively assigned to and/or arranged downstream of each of the first in, first out buffers 317.

What is more, it is shown in phase A by a double arrow 371 that the hanging bags belonging to the first subsequence 341 and removed from the first first in, first out buffer 317 are stored slidably and/or can be moved back and forth between a first end position 329 and a second end position 331 on the exit rail 339. The exit rail is part of a reciprocating track 321, on which the hanging bags 3 are movably relocatable and/or displaceable back and forth between the end positions 329 and 331. This can enable the functionality of the pick buffer 319.

Here, the hanging bags of the first subsequence 341 travel past a branch-off 333 starting at the pick buffer 319 and ending in the handover buffer 11. As soon as one of the hanging bags is next in line, i.e. fulfills the sequence 15 in the handover buffer 11 and arrives at the branch-off 333 during the reciprocating motion, the hanging bag branches off into the handover buffer 11, which is demonstrated in phase B by a curved arrow 373. A part of the hanging bags travels electively onward in a direction of the second end position 331 in order to make room for the turn-off maneuver into the handover buffer 11, arrow 375.

In phase C, it is shown that, after the turning, the remaining hanging bags advance again, arrow 377, and the hanging bag handed over into the handover buffer 11 advances to hanging bags already waiting there, arrow 363. The hanging bags already waiting belong to another subsequence, which is adjoined by the first subsequence.

This enables the specified or specifiable sequence 15 to be ensured in the handover buffer 11 in a continuous and time-buffered manner and handed over to the circular conveyor 23, arrow 395, in particular such as requested by the control device 25.

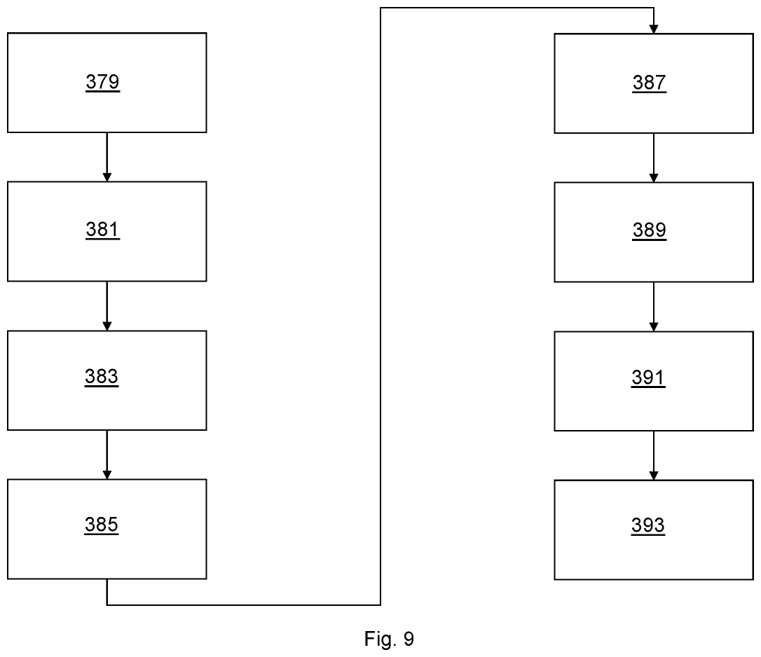

FIG. 9 shows a flow chart of a method for retrieving storage articles 3 from a hanging bag storage 1 having hanging bags 5, in particular a hanging bag storage 1 with a handover configuration 10 described above. To the extent that it serves a better understanding, reference is additionally made to the preceding figures.

In a first step 379, a provisioning of a first in, first out buffer 317 arranged downstream of the hanging bag storage 1 is first executed. The first in, first out buffer 317 can comprise at least one section, in particular rail section, of the network 49. Preferably segmented into multiple rail sections arranged in parallel, which preferably each comprise an inflow and an outflow, in particular a joint inflow and outflow. In this respect, a parallelized first in, first out principle can be realized, in which the storage articles 3 can electively be supplied and discharged at least in sections and/or in relation to the entirety of the respective individual first in, first out buffers 317.

In a second step 381, the storage articles 3 are received in the first in, first out buffer 317 presorted from the hanging bag storage 1. Presorted can be understood to mean here that the storage articles are assigned to the intervals and/or subsequences 341 and stored in a respective one of the individual first in, first out buffers 317, in particular in a respective segment of the first in, first out buffer 317, according to the affiliation to a respective one of the subsequences 341.

What is more, a pick buffer 319 arranged downstream of the first in, first out buffer 317 is provisioned, which is represented in FIG. 9 as a third step 383.

As a fourth step 385, a complete or at least partial receiving of the storage articles 3 buffered in the first in, first out buffer 317 in the pick buffer 319 in the presorted state is executed.

Further, the handover buffer 7, 11 arranged downstream of the pick buffer 319 is provisioned, fifth step 387. The handover buffer adjoins the pick buffer 319 and can receive and time buffer the storage articles 3 from the pick buffer 319 in the sequence 15.

This is executed in a sixth step 389 by picking out the storage articles 3 stored in the pick buffer 319 into the handover buffer 7, 11 in the specified or specifiable sequence 15. From there, the storage articles 3 can be processed further, for example transported onward and/or packaged and shipped.

In a seventh step 391, a conveying plant arranged downstream of the handover buffer 7, 11 and preferably vertically conveying, in particular the circular conveying plant 23, can be provisioned.

This serves to remove the storage articles 3 from the hanging bag storage 1 by handing over the storage articles 3 into the conveying plant, which can be executed as an eighth step 393.

This results in a sorting method which is robust preferably at the input side and at the output side against delays of individual ones of the storage articles and can also be executed simply and quickly for very long, in particular continuous, sequences. The seventh and eighth step are arranged downstream, explained here by way of example, and can preferably also be achieved alternatively, for example by a targeted picking out of the storage articles 3 from the provisioning buffer using a picking device, releasing the sorted storage articles 3 into an inclined outfeed track or similar.

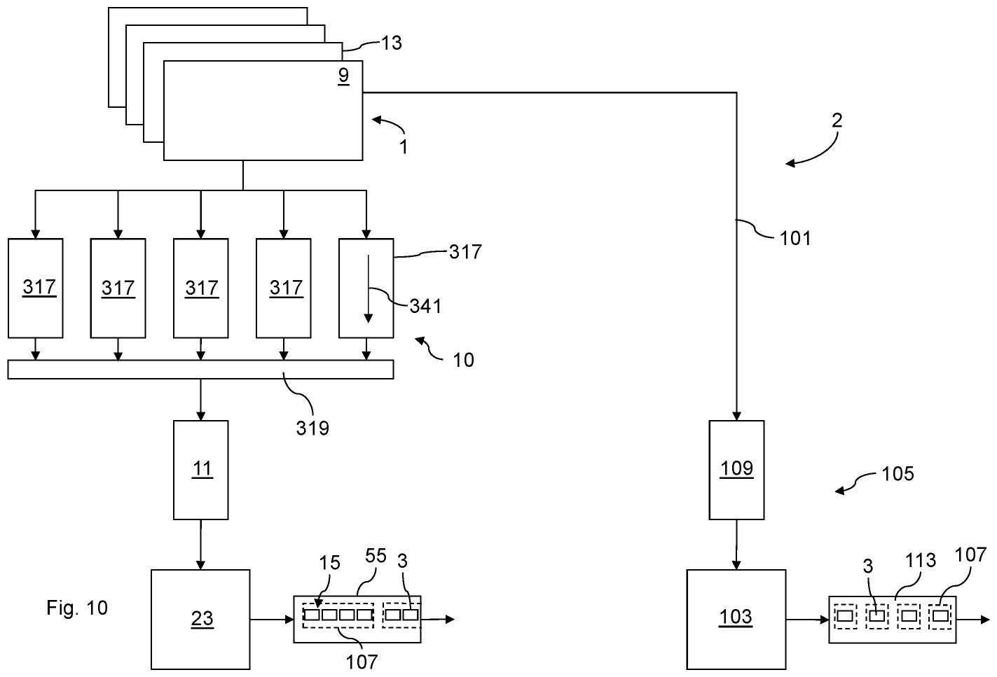

FIG. 10 shows the block diagram represented in FIG. 7 but in combination with an express handover configuration 105 for retrieving individual ones of the storage articles 3. Below, the differences are explained and reference is furthermore made to the description of FIG. 4.

In contrast, other than the sorting and dispatching of the storage articles 3 in the sequence 15, individual ones of the storage articles 3 are dispatched and/or picked using the express handover configuration 105. To that end, these storage articles 3, in derogation from the sequence referred to as individual articles and/or also as single items, which can be shipped in a separate packing unit 107 can be identified.

The express handover configuration 105 merely comprises an express handover buffer 109 arranged upstream of the express circular conveying plant 103. The ones of the storage articles 3 identified as individual articles are handed over from the second level 13 directly into the express handover buffer 109 and/or enter it autonomously. Alternatively, it is conceivable to also relinquish the express handover buffer 109, wherein the individual articles travel directly toward the express circular conveying plant 103 and are conveyed into a downstream express unloading station 113 using the express circular conveying plant 103. The representation in FIG. 5 is exemplary for retrievals from the second level 13 of the hanging bag storage 1. The individual articles can electively be picked and dispatched independently. Packing units 107 are symbolized in FIG. 5 by dashed rectangles by way of example.

The configurations represented in FIGS. 7 and 10 can analogously be provided for at least one other, preferably for all levels 9, 13, of the hanging bag storage 1.

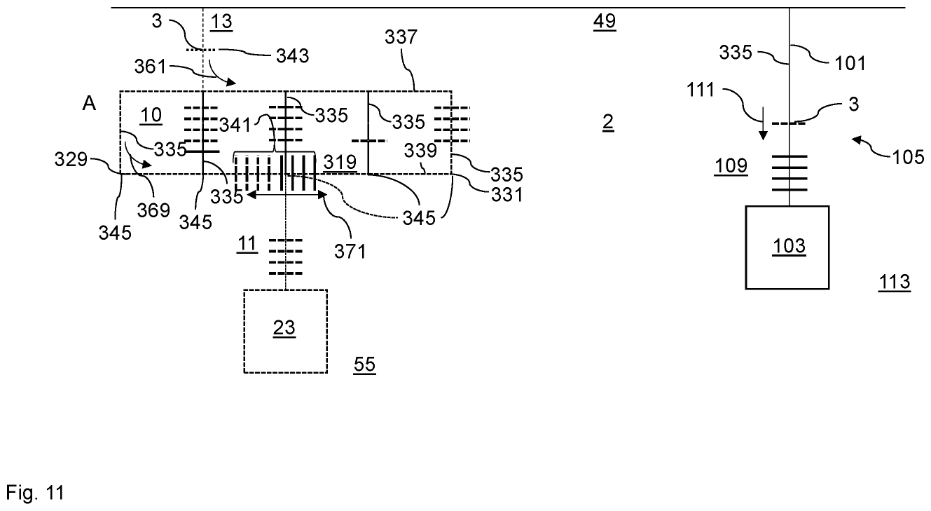

FIG. 11 shows the handover configuration 10 shown in FIG. 8 in interaction with the express handover configuration 105, analogous to the block diagram from FIG. 10 according to phase A. For simplification and like in the preceding figures, the situation of only one of the levels 9, 13 of the hanging bag storage 1 is represented. Only the differences are shown and reference is otherwise made to the preceding figures.

As can be seen in FIG. 11, the express circular conveying plant 103 has an inflow in the form of a section of rail 335 of the network 49. One of the storage articles 3, preferably received in a hanging bag which is not represented in more detail, is in the inflow, which is indicated by an arrow 111. Four other ones of the storage articles 3 are already waiting in front of the express circular conveying plant 103. It can be seen that the express handover buffer 109 is formed by a subsection of an express track 101 itself which is arranged upstream of the express circular conveying plant 103. If the subsection of the express track 101 runs empty, the storage articles 3 can also be conveyed directly and without waiting times, i.e. wait-free and buffer-free, into the express circular conveying plant 103. To that end, the individual articles can travel on the network 49 at such times that they arrive at and are conveyed by the express circular conveying plant 103 at a specified or specifiable time and/or time interval.

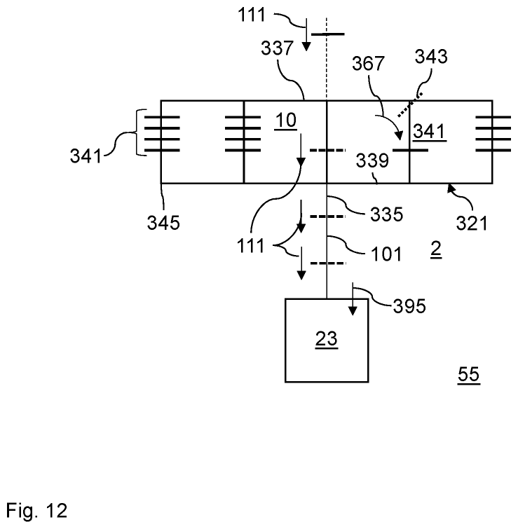

FIG. 12 shows a handover configuration 10 analogous to the one described in FIGS. 8 and 11 with a preferably flexibly assignable express track. Only the differences are explained. In contrast to the handover configuration 10 shown in FIGS. 8 and 11, one of the total of five first in, first out buffers 317 of the handover configuration 10 has run empty and serves as the express track 101. In the operating mode represented in FIG. 12, a total of four of the storage articles 3 and/or of the hanging bags 5 are in the inflow, which is symbolized by the arrows 111. It can further be seen that the section of rail 335 is continuously vacant and can be used as the express track 101 and electively as the express handover buffer 109 as required, which is illustrated by way of example in FIG. 12, or as one of the first in, first out buffers 317 and the adjoining handover buffer 7, 11, as shown on the left in FIG. 11 and in FIG. 12. As soon as one of the first in, first out buffers 317 has run empty, it can be used as the express track 101. This can therefore take place as an alternative, or electively also in addition to, the express track 101 represented in FIGS. 10 and 11.

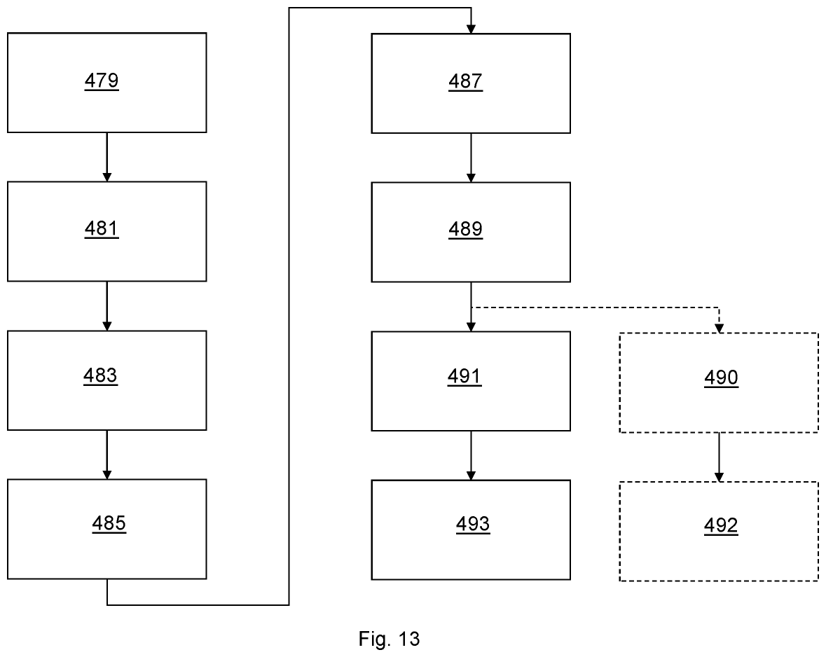

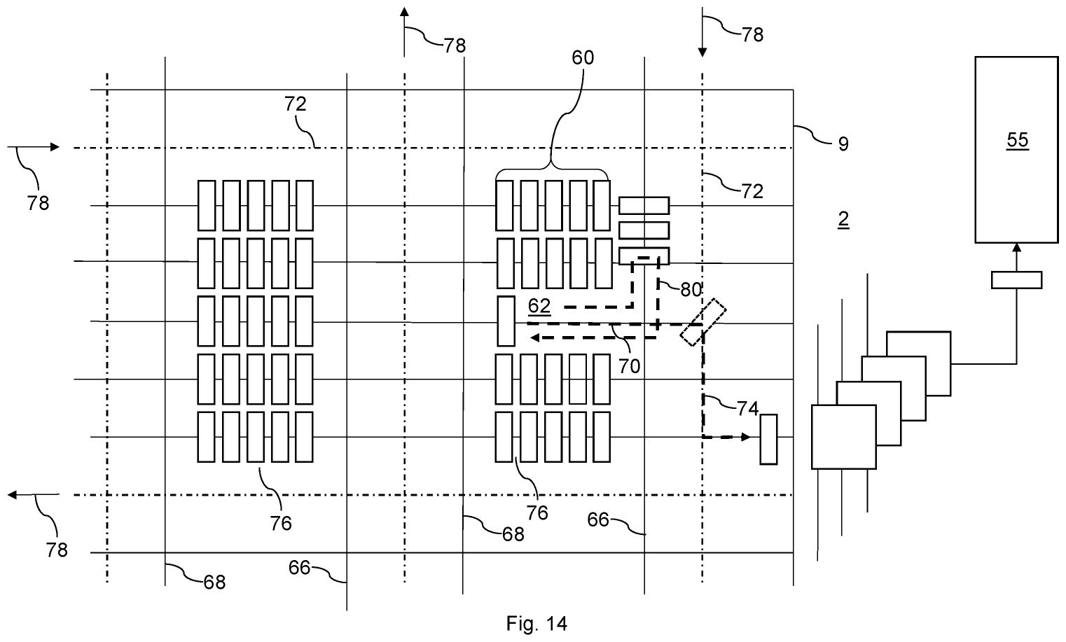

FIG. 13 shows a flow chart of a method for picking storage articles 3 preferably received in hanging bags 5. The method can preferably be executed using a hanging bag storage 1 described above. Reference is made also to the preceding figures as well as their description.

As a first step 479, there is a provisioning of a handover configuration 10 arranged downstream of the stored storage articles 3. The handover configuration 10 can take over different tasks, in particular the storage articles 3 can be sorted, presorted and finally sorted and/or buffered there.

To fulfill these tasks, a plurality of the storage articles 3 are received in the handover configuration 10 and/or the plurality of the storage articles 3 travel there from the remaining hanging bag storage 1 in a second step 481.

As a third step 483, the plurality of the received storage articles 3 are sorted in the specified or specifiable sequence 15 using the handover configuration 10.

What is more, at least one other one of the storage articles 3 is selected in a fourth step 485, preferably in parallel to the third step 483. The selected one of the storage articles 3 can be an individual article which is to be retrieved particularly quickly and/or can be transported onward separately in a packing unit, for example.

The selected one of the storage articles 3 bypasses at least partially or completely the plurality of the storage articles 3 received in the handover configuration 10 and processed and/or waiting there, which is symbolized as a fifth step 487. This can be executed using and/or traveling on the express track 101 described above. The selected storage article 3 can therefore be transported onward more quickly without the waiting and processing time of the handover configuration 10.

Without this waiting and processing time, as an eighth step 493, a direct picking of the selected at least one of the storage articles 3 can take place.

In FIG. 13, two alternatives for the direct picking are represented.

In a first possibility, which is represented by solid lines, a conveying plant arranged downstream of the handover configuration 10 is provisioned in a sixth step 489. The direct picking of the selected at least one of the storage articles 3 in the eighth steps 493 is then executed by receiving and conveying the storage articles 3 from the handover configuration 10 into the conveying plant. This operation is marked in FIG. 13 as a seventh step 491. The conveying plant can comprise or be provisioned as a circular conveying plant 23 described above.

In the alternative second embodiment, which is represented by dashed lines in FIG. 13, the other conveying plant, for example the express circular conveying plant 103, is additionally also provisioned in a ninth step 490. This means that the conveying plant and the express conveying plant are provisioned. Therefore, there are two possibilities for picking the storage articles 3. The plurality of the storage articles 3 are picked using the handover configuration 10. For direct picking of the selected at least one of the storage articles 3 (tenth step 492), the selected at least one of the storage articles 3 is received in and conveyed using the express conveying plant. The express track 101 is arranged upstream of, preferably arranged directly upstream of, the express conveying plant.

The at least one of the storage articles 3 enters the express track 101 and is separated from the remaining, i.e. the plurality of, the storage articles 3 and supplied to the express conveying plant, preferably wait-free or at least with a reduced waiting time, using the express track 101.

FIG. 14 shows a schematic view of a level of a hanging bag storage, for example the level 9 of the hanging bag storage 1 described above. The level 9 is only partially represented, wherein dimensions and number of individual elements of the level 9 described here can be varied depending on requirements for the hanging bag storage 1. Also the number of the levels itself can be varied.

To the extent that this has not been explicitly mentioned, reference is made also to the following figures. The only partially represented level 9 comprises the network 49 with a plurality of rails. By way of example, the network 49 has rectangular meshes formed by the rails and crossings, wherein corresponding four-way switches can be provided at mesh nodes. The wheels 57 of the hanging bags 5 can roll on the rails of the network 9. Here, a motion of the hanging bags 1 can take place autonomously or at least partially autonomously. To that end, each of the hanging bags 5 can comprise an independent drive acting on the wheels 57 and a corresponding controller.

The network 49 can generally be traveled on randomly by the hanging bags 5, wherein preferably the switches are configured passive and the hanging bags 5 cooperate with the switches through corresponding steering devices, which are not represented in more detail, such that desired reversals can be caused. Motions of hanging bags 5 are represented in the figure by bold dashed lines.

Preferably, however, the network 49 is used and traveled on by the hanging bags 5—irrespective of the possibilities of free traveling and use described above—according to specified or specifiable rules. To that end, for example directions, speeds and preferably types of use can be specified for particular sections of the network 5. In the present case, the network 49 can comprise at least one storage route 62 for storing the hanging bags 5. In the storage routes 62, one or multiple of the hanging bags 5 can be stored in a series 60, which is symbolized by a curly bracket by way of example. To that end, the one or multiple of the hanging bags 5 remain, preferably in a power-saving rest state, at rest and parked in succession, in the series 60 of the corresponding one of the storage routes 62.

For retrieval, all hanging bags 5 of the hanging bags 5 which are to be moved can be woken up and moved again accordingly.

In this exemplary embodiment, storage routes 62 are all arranged in parallel in the entire level 9 and marked in the figure by horizontal and solid lines. The rules and the configuration offer the advantage that material flows during storage and retrieval are unified and can thus run faster, more simply and freer from resource conflicts on the network 49.

The hanging bags 5 are symbolized by rectangles in the figure. In comparison to other regions of the hanging bag storage 1, in particular express routes and/or shunting routes, the storage routes 62 of the hanging bag storage 1 comprise a crossing-free length, in particular one by a factor of at least 1.5, preferably of at least 3, in particular at least 10, for example between 3 and 25, preferably of approximately 20. The crossing-free length can be, for example, between 3 and 20 meters, preferably approximately 15 meters. The length of the storage routes 62 can be made dependent on a use and/or optimization of the hanging bag storage 1, for example rather shorter for quick access and short dwell times of the storage articles 3 and longer for a relatively slow turnaround.

Furthermore, the hanging bag storage 1 has shunting routes 66, preferably at least one shunting route 66. The shunting routes 66 are arranged at an angle to the storage routes 62, preferably orthogonally to the storage routes 62. In the figure, the shunting routes 66 are marked by vertical and also solid lines. Preferably, at least one of the storage routes 62 ends in at least one of the shunting routes 66 at the angle, preferably orthogonally. In comparison to the storage routes 62, there must be no stopping for storage purposes on the shunting routes 66.

Wherein a reversal of the direction of motion is electively possible. In the present case, the storage routes 62, which are combined in blocks 76, end in two of the shunting routes 66, at least unilaterally, preferably respectively bilaterally and at the angle, in particular orthogonally. The blocks 76 each comprise a plurality of ones of the storage routes 62 arranged in parallel. In the present case respectively five. The number can vary, for example be between 2 and 30, preferably between 5 and 20, in particular approximately 15. The number can also be adapted to a task of the hanging bag storage 1.

It is electively conceivable that the blocks 76 are surrounded by a ring of shunting routes 66. In the present case, however, express routes 72 are provided at a top and/or at a bottom end of the respective blocks 76 and parallel to the storage routes 62, preferably respectively directly adjacent.

To achieve a good and quick outflow of the storage articles 3 and/or hanging bags 5, the express routes 72 allow for a relatively high speed and in particular a continuous traveling is provided, i.e. halting without a reason is not provided and/or to be avoided. Reasons for a halting can therefore preferably be limited to avoiding collisions. Particularly preferably, the express routes 72 can comprise a direction-based motion of the hanging bags 5 as a rule. Further, it is electively possible for the express routes 72 to be arranged in parallel at a certain distance, wherein the blocks 76 are arranged therebetween. Here, it is conceivable that ones of the express routes 72 arranged in parallel have opposite specifications for the direction of travel, i.e. at least one pair of the express routes 72 arranged in parallel with an opposite specification of the direction of motion is provided. What is more, the express routes 72 can be arranged at an angle to one another, preferably cross at the angle, for example be arranged orthogonally to one another. In this case, the express routes 72 can be arranged grid-like and preferably with alternating specifications of the direction of motion to one another. In this manner, ring routes surrounding at least one or multiple of the blocks 76 can be configured, which ring routes can be traveled on in one direction and particularly fast. The alternating directions are represented in the figure by arrows 78 and the express routes 72 by dashed lines.

It can be seen in the figure that particularly preferably the storage routes 62 are crossed at least unilaterally by one of the shunting routes 66, and one of the express routes 72 arranged at the angle to the storage routes 62 extends parallel to the respective one of the shunting routes 66. As marked in the figure, it is possible that one of the shunting routes 66 is arranged in parallel bilaterally of each of the express routes 72, with respectively one of the blocks 76 abutting thereon, wherein a plurality of connections and junctions connects the one of the shunting routes 66 with the respective express route 72 and again with the storage routes 62 of the respective blocks 76. Therefore, a grid-like arrangement of at least two, preferably three rails of the network 49 is configured, which rails extend in parallel, which network 49 comprises switches and/or crossings at a distance of the storage routes 62 to the hanging bags 5, which switches and/or crossings can be traveled on at least partially autonomously or autonomously, and limits the blocks 76 orthogonally to the alignment of the storage routes 62 and/or connects the blocks 76 to the remaining network 49 of the hanging bag storage 1. The configuration is divided into the shunting routes 66 and the express routes 72 by the traffic rules, wherein a physical structure can comprise identical parts of switches and rail sections in order to enable a favorable and easily mountable structure.

Below, possibilities of use for this grid-like configuration of the storage routes 62, shunting routes 66 and express routes 72 will be explained on the basis of the figure using the example of a relocating operation. One of the storage articles 3 stored in the hanging bag storage 1 is scheduled for the relocating, for example a retrieval, preferably first into the unloading station 55. The hanging bag 5 with the scheduled one of the storage articles 3 is represented by dotted lines in the figure, wherein the storage article 3 received in the hanging bag 5 itself cannot be seen. The scheduled one of the storage articles 3 can be identically provided at one or multiple locations of the hanging bag storage 1, wherein a selection on the basis of a criterion can take place before the scheduling.

As can be seen in the figure, there is a retrieval of the one of the hanging bags 5 represented by dotted lines, which is symbolized by a dashed and bold-print arrow 74.

Before this can take place, however, the one of the storage articles 3 represented by dotted lines is first scheduled for the retrieval. This can be executed using the control device 25.

To vacate a retrieval path 70 on which the scheduled one of the storage articles 3 can leave the series 60, other ones of the storage articles 3 are relocated into a shunting route 66, 68 of the hanging bag storage 1 represented by solid lines. The shunting route 66 is arranged orthogonally to the storage route 62 and intersects with the storage route 62 at a four-way switch at an end of the storage route 62. As soon as the retrieval path 70 is vacant, the relocating and/or retrieval of the scheduled one of the storage articles 3 along the retrieval path 70 can take place, which is symbolized in the figure by the bold-print dashed arrow 74. The scheduled one of the storage articles can then electively be stored temporarily or electively travel onward and/or be conveyed directly into the unloading station 55, preferably enter the circular conveying plant 23 and be conveyed into the unloading station using the circular conveying plant 23.

As can be seen in FIG. 14, there is a reversal of a direction of motion of the other ones of the storage articles 3 of the series 60 in order to vacate the retrieval path 70 and subsequently displace the other ones of the storage articles 3 back into the series 60 again. In the present case, three of the storage articles 3, are moved out of the series 60 into the storage route 62, preferably in a convoy. After the relocating of the scheduled one of the storage articles 3, there is a relocating of the three of the storage articles 3 of the series 60 in the opposite direction of motion back into the storage route 62. This operation with the reversal of the direction of motion is symbolized in FIG. 14 by a dashed bold-print arrow 80. A sequence of the three of the storage articles 3 remains in place. The shunting routes 66 can be traveled on in a consistent direction, whereby a more fluid traffic can be achieved.

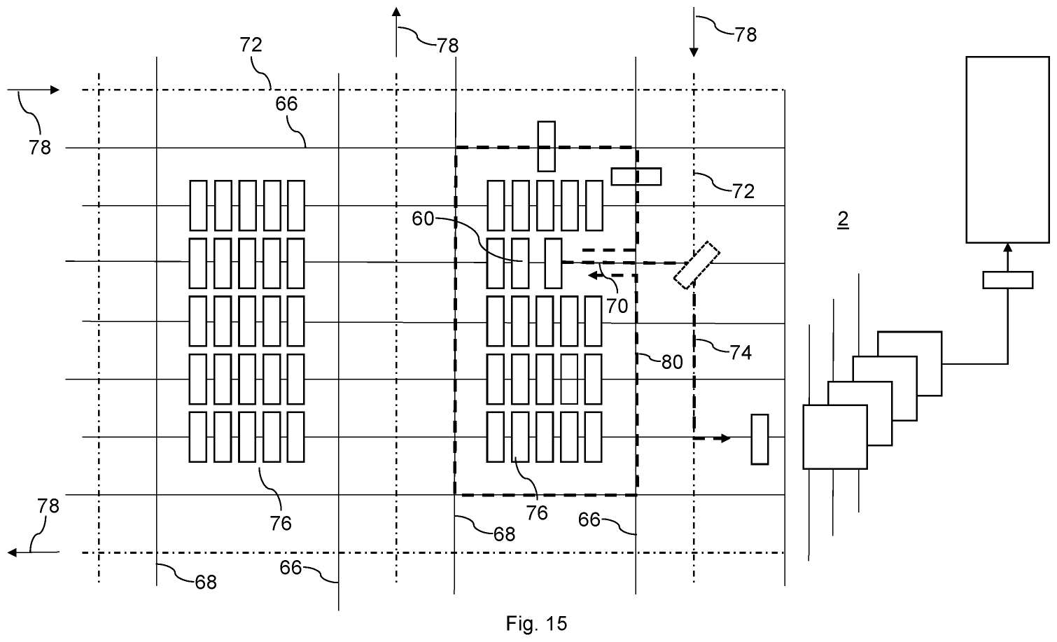

FIG. 15 shows a variant for the vacating of the retrieval path 70 and relocating of the scheduled one of the storage articles 3 on the retrieval path 70, wherein an encircling of the storage route 62 of the hanging bag storage 1 with the other ones of the storage articles 3 takes place while maintaining the direction of motion. The relocating of the other ones of the storage articles 3 of the series 60 is executed after the encircling into the storage route 62, i.e. in the same direction of motion. This enables the sequence of the other ones of the storage articles 3 to be reversed. The arrow 80 in FIG. 15 symbolizes the encircling of the storage route. It can be seen that the entire block 76 in which the scheduled one of the storage articles 3 is located, with a plurality of storage routes 62, is encircled here. This takes place on a total of four of the shunting routes 66, which are arranged so as to cross one another and surround the block 76. In this exemplary embodiment, at least one of the blocks 76, preferably the blocks 76, respectively, is/are therefore surrounded by a ring of shunting routes, i.e. the shunting route 66 and at least one other shunting route 68, preferably four of the shunting routes arranged orthogonally to one another.

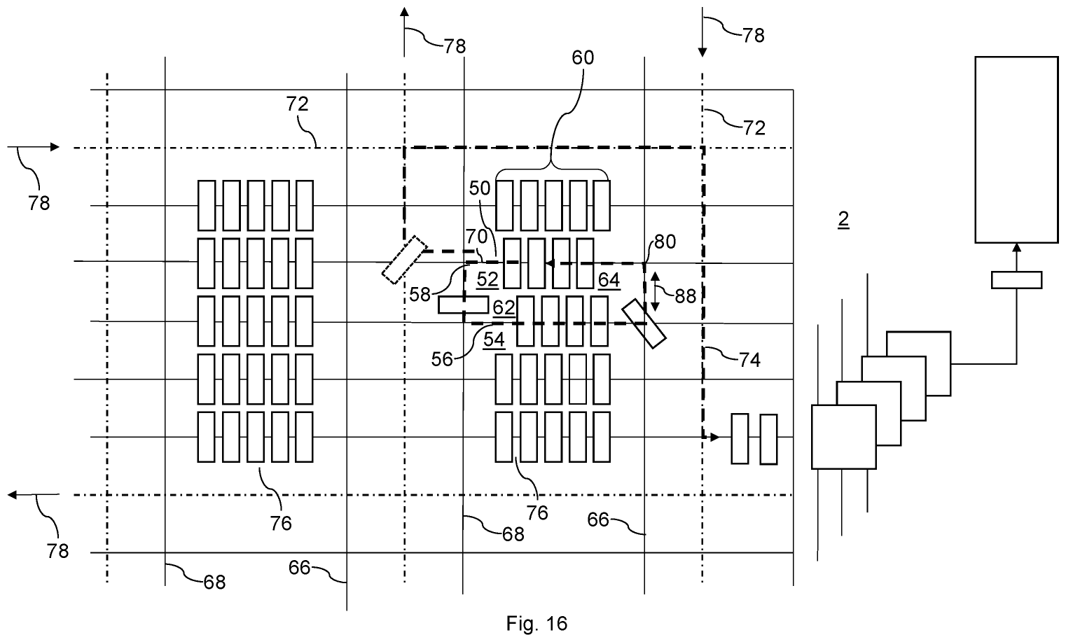

FIG. 16 shows another possibility for vacating the retrieval path 70 and relocating the scheduled one of the storage articles 3 on the retrieval path 70. To that end, the other ones of the storage articles 3 are moved circularly, which is symbolized by the arrow 80, or alternatively in a reciprocating motion, which is indicated by a double arrow 88. In contrast, not the entire block 76 is encircled to that end, but another storage route 64 is used, as marked in FIG. 16 by the dashed bold-print arrow 80. This can preferably take place in an adjacent one of the storage routes 62, as represented in FIG. 16, or in any other one of the storage routes 62 of the corresponding block 76. When the other storage route 64 is used, the shunting routes 66, 68 are traveled on on a particularly short section. This enables a relatively large number of these processes to run in parallel and a sorting and/or access time to be shortened further. As soon as the scheduled one of the storage articles 3 has arrived at an end of the storage route 62, the retrieval path 70 is vacant and the scheduled one of the storage articles 3 can be relocated, in particular retrieved, by crossing the shunting route 66 and using the express route(s) 72, which is symbolized in FIG. 16 by the dashed bold-print arrow 74.

Preferably, a rotation of the hanging bags 5 and/or of the storage articles 3 by 180 degrees takes place per retrieval. Preferably with an adjacent one of the storage routes 62. This means that the storage articles 3 are exchanged between the storage routes 62, preferably between the two of the storage routes 62 arranged adjacent to one another, wherein a sequence of the storage articles 3 is respectively reversed and/or mirrored while the retrieval takes place. This simplifies the management of the warehouse stock, as the contents of the respective ones of the storage routes 62, while being mirrored, are maintained in their entirety, with the exception of the scheduled one of the storage articles. Also the arrangement of the individual ones of the storage articles 3 inside the storage routes 62 is immaterial here. The scheduled one of the storage articles 3 can travel out autonomously and independent of the non-scheduled ones of the storage articles 3. It is also immaterial which of the storage routes 62 additionally participates in the rotation. What is important is only that the scheduled one of the storage articles 3 is communicated with and the storage route 62 with this scheduled one of the storage articles 3 and any other, in particular directly adjacent, one of the storage routes 62 participates in the at least half, preferably precisely half, rotation.

It can be seen that a half rotation is sufficient for each of the thus moved ones of the storage articles 3 of the two storage routes 62 to pass one of the shunting routes 66, 68, which are arranged bilaterally at front ends of the storage routes 62, precisely once. The scheduled one of the storage articles 3 leaves the circular motion at this moment, in particular onto the corresponding one of the shunting routes 66, 68 or by crossing directly onto the express route 72 arranged adjacent and/or in parallel. In this application, circular motion and/or rotation can also be understood to mean a motion on a closed travel path deviating from a purely circular shape.

The shunting routes 66 can be traveled on in a consistent direction and are relatively lightly burdened due to the circulating, whereby an overall more fluid traffic can be achieved.

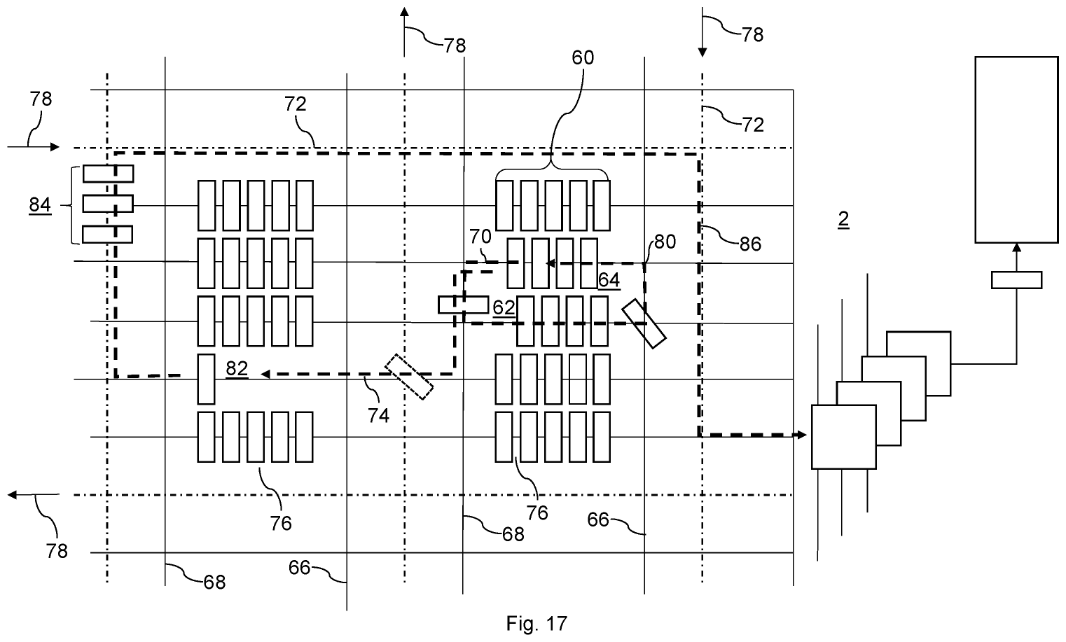

FIG. 17 shows another variant, in which the scheduled one of the storage articles 3 is first relocated and/or rearranged into an additional storage route 82. The additional storage route 82 can be arranged in the same block 76 or in a remote, preferably adjacent, block 76 of the hanging bag storage 1. This operation can be repeated any number of times in order to create a sequence in the additional storage route 82, for example the sequence 15 and/or subsequence 41. To that end, the additional storage route 82 is first empty or at least partially empty and is filled up in the new sequence 15. This enables the level 9, 13 of the hanging bag storage 1 to be cyclically resorted, at least partially or entirely. The operation can run in waves throughout the entire level 9, 13 and thus lead to a completely sorted state in all of the storage routes 62.

For the retrieving, the ones of the storage articles 3 now sorted in the additional storage route 82 can be moved to the circular conveying plant 23 in a convoy 84, which is symbolized in FIG. 17 by a dashed bold-print arrow 86. To that end, the express routes 72 can be used, as described above. A sorting in front of the circular conveying plant 23 can thereby be simplified accordingly or electively be relinquished entirely.

Analogously to the preceding figures, the retrieval operation for the rearranging can take place preferably by reciprocating or circulating as described in FIG. 16 or 17. Equally, at a later point in time, one of the storage articles 3 can be scheduled in the additional storage route 82 and the procedure described above can be followed.

Below, a preferred structure of the network 49 is described in more detail. The network 49 can essentially be structured so as to be horizontal, i.e. without gradients. A driving of the hanging bags can in particular be executed without gravity, preferably electrically. Further, the network 49 can be structured without pusher dogs and/or without trail chains. Branched routes can comprise multi-way crossings, in particular four-way crossings, at ramifications; in this application, crossings can be understood as purely passive ramifications of the network 49, wherein the crossings and/or the entire network, particularly preferably at least the block 76, can be structured without adjustment elements. In particular, the branched routes of the crossings can electively be traveled on by the hanging bags 5 using the cotraveling longitudinal and/or transverse dynamic controllers. As can be seen in the figure, the express routes 72 are directly connected to the shunting routes 66, 68 by a plurality of cross connections 96. The cross connections 96 can preferably be provided per storage route 62, 64, 82 and also connect the storage routes 62, 64, 82 directly to the respective one of the express routes 72, in particular at a front end of the respective block 76 adjacent one of the express routes 72, crossing the shunting routes 66, 68.

As can be seen in FIG. 16, at least the block 76 of the network 49 of the hanging bag storage 1 can particularly preferably comprise a plurality of the storage routes 62 arranged in parallel.

The storage routes 62 can be configured passive. Therefore without conveying devices, trail chains and/or pusher dogs. Hanging bags 5 located on the plurality of the storage routes 62 of the block 76 electively comprise at least one of the states of the following group:
stored without movement by halting if a front hanging bag 5 blocks the network 49 of the block 76 depending on, preferably only depending on, the cotraveling longitudinal dynamics control,
stored without movement and halted at the stopping point 50 or the imaginary stopping point 50 depending on the non-cotraveling control device 25 and/or stopped and provisioned there for leaving the closed route 56,
ready to receive from the non-cotraveling control device 25, in particular for traveling to the stopping point and/or to a new destination,
addressed for a retrieval operation depending on the non-cotraveling control device 25,
in motion for entering the closed route 56, in particular on the entry 54, depending on the non-cotraveling control device 25,
in motion for leaving the closed route 56, in particular in motion on or using the exit 52,
in motion for leaving the stopping point 50 or the imaginary stopping point 50 depending on the non-cotraveling control device 25, in particular on or using the exit 52,
supplied with an electrical energy,
in motion for the endless traveling on the closed route 56 after the entering, only yet depending on the cotraveling longitudinal and transverse dynamics control.

Transverse to the parallel storage routes 62, respectively one of the shunting routes 66, can be arranged unilaterally, preferably bilaterally, wherein each of the storage routes 62 ends in at least one of the storage routes 62 through respectively one or, in the bilateral case, through two of the preferably passive crossings. Respectively one express route 72 is arranged parallel to the shunting routes 66, wherein a plurality of connections between the respective shunting routes 66 and express routes 72 can be provided, preferably respectively one per storage route 62. This enables traveling maneuvers of the hanging bags 5 from the following group to be preferably electively controlled by the independent longitudinal and transverse dynamics control:
coming from the storage route 62 and turning into the shunting route 66, coming from the storage route 62 and crossing the shunting route 66 and subsequently turning into the express route 72, coming from the shunting route 66 and turning into the storage route 62, coming from the express route 72 and turning in a direction of the storage route 62, crossing the shunting route 66 and then turning into the storage route 62. A repetition of these traveling maneuvers enables the endless traveling on the closed route 56.

In another preferred configuration, it is conceivable that the hanging bags 5 can electively take the following states and/or states of motion which can be controlled by the independent longitudinal and transverse dynamics control:
automatic halting or decelerating if a front hanging bag 5 blocks the network 49,
storing a travel instruction for and/or endless traveling on a specified closed route 56, wherein the closed route 56 can preferably comprise the storage route 62, the shunting route 66 crossing the storage route 62, the other storage route 64 crossing the shunting route 66, and the other storage route 68,
halting at a specifiable or specified stopping point 58 of the closed route 56, in particular using the controller 25 or only depending on the controller 25,
leaving the closed route 56, preferably starting from the stopping point 58, in a direction of a specifiable or specified destination point, in particular using the control 25, in particular by crossing one of the shunting routes 66, 68 and/or turning into one of the express routes 72,
entering the closed route 56, in particular specified by the control device 25 and/or only depending on the control device 25.

The states of motion can be controlled by the cotraveling longitudinal and transverse dynamics control and/or the independent drive, wherein travel instructions can be sent and/or transmitted to the hanging bags 5 using the non-cotraveling control device 25.

Preferably, it is conceivable to provide a closed route also designed analogously to the closed route 56 in the handover configuration 10, as described in more detail in FIGS. 7, 8, 10 and 11. In particular in order to use the closed route to supply the downstream handover buffer 7, 11 with a sorted inflow analogously to the manner described above. An individual hanging bag 5 can therefore be relocated from a closed route 56 of one of the blocks 76 into another closed route of one of the handover configurations 10, from there into one of the handover buffers 7, 11 and from there finally into the conveyor, in particular vertical conveyor, in particular the circular conveying plant 23, while being sorted into the desired sequence 15. Here, one advantage is that the respective hanging bag 5 is brought to a standstill in between and is stored in the standstill while it can in particular be brought into a power saving mode. This can preferably be executed autonomously by the roll adapter 61 itself on which the hanging bag 5 is suspended.

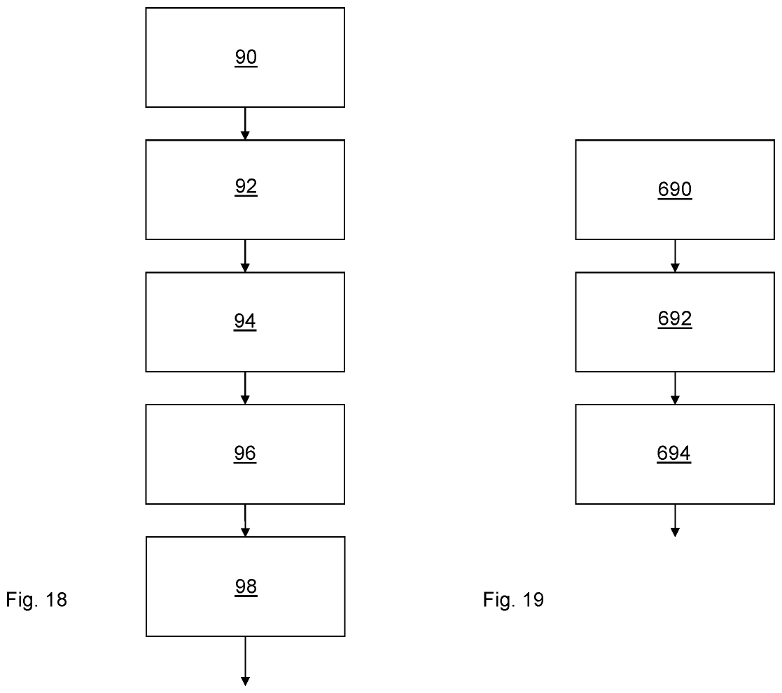

FIG. 18 shows a flow chart of a method for operating a hanging bag storage 1 with storage articles 3 received in hanging bags 5. The hanging bag storage 1 is preferably structured as described above. In this respect, reference is made also to the preceding figures.

In a first step 90, the storage articles 3 received in the hanging bags 5 are stored in the series 60 on the storage route 62 of the hanging bag storage 1. In a second step 92, there is a scheduling of the one of the storage articles 3 of the series 60 for a retrieval. As a third step 94, the retrieval path 70 is vacated for the scheduled one of the storage articles 3. This takes place in a fourth step 96 by relocating the other ones of the storage articles 3 of the series 60 into the shunting route 66 of the hanging bag storage 1. Finally, the scheduled one of the storage articles 3 is retrieved along the vacated retrieval path 70, fifth step 98.

FIG. 19 shows a flow chart of a method for operating a hanging bag storage 1 with storage articles 3 received in hanging bags 5. The hanging bag storage 1 is preferably structured as described above. In this respect, reference is made also to the preceding figures.

In a first step 690, the storage articles 3 received in the hanging bags 5 are stored in the series 60 on the storage route 62 of the hanging bag storage 1. In a second step 692, the one of the storage articles 3 of the series 60 is scheduled for the relocating and relocated. As a third step 694, the scheduled one of the storage articles 3 is inserted into the additional storage route 82 of the hanging bag storage 1 in the and/or for creating the specified or specifiable sequence 15.

Other than the drive, which is not represented in more detail, as well as a corresponding controller, the hanging bag 5 comprises a first transceiving device 205 and a second transceiving device 207, as can be seen in FIG. 2. The first transceiving device 205 and second transceiving device 207 can be configured electively individually or as an integrated component, preferably at least have different radio frequencies and/or transmission protocols.

The first transceiving device 205 and second transceiving device 207 enable the hanging bag to receive or send messages with other hanging bags 5 and/or the control device 25 using two communication paths. This means that the messages can be handed over to or sent wirelessly by the other hanging bags 5 and/or the control device 25. This can electively be executed using one of the transceiving devices 205 or 207, for example depending on a location inside the hanging bag storage 1 and/or on a current task of the respective hanging bag 5 such as storing, transporting, retrieving, depositing, buffering and/or sorting of the storage article 3.

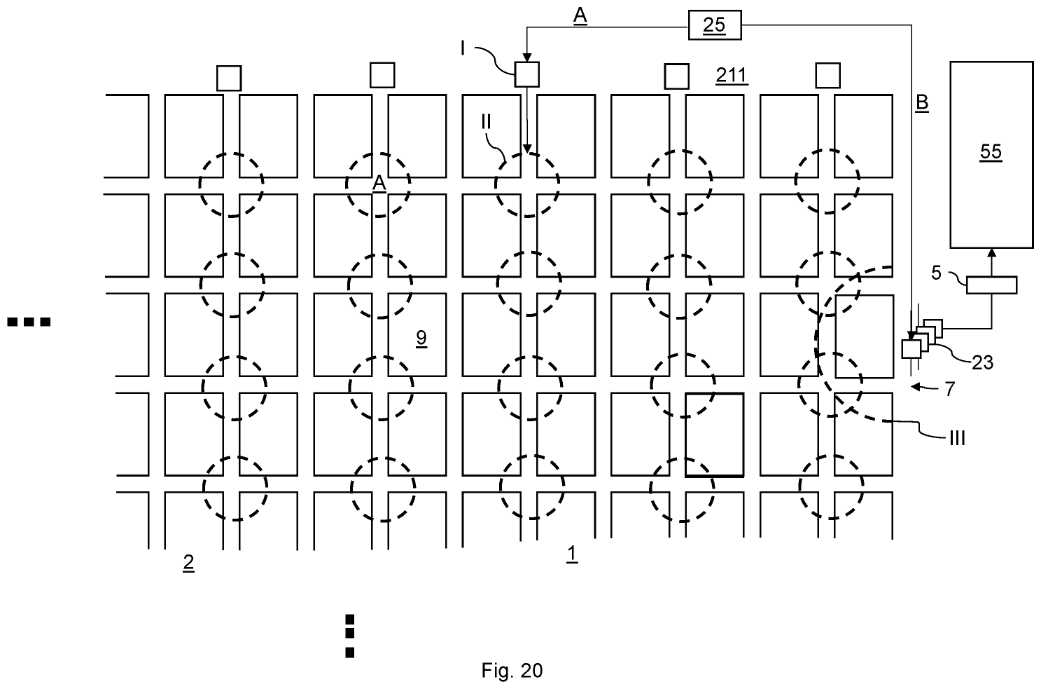

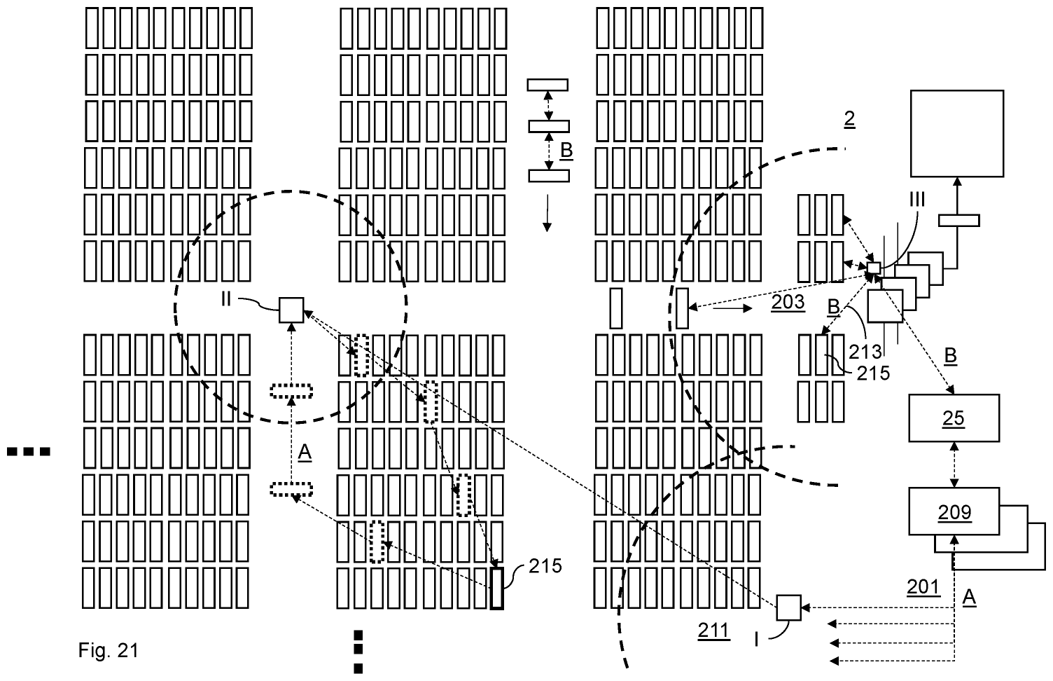

In FIGS. 20 to 23, the possible communication paths are described in more detail.

FIGS. 20 and 21 show a view of a part of the level 9 of the hanging bag storage 1 shown in the preceding figures, with two communication paths A and B. The remaining levels of the hanging bag storage 1 can be structured analogously, i.e. also comprise communication paths A and B.

The communication path A extends through a first communication configuration 201 from the central control device 25 via a plurality of intermediate controllers 209, a plurality of beacons I and a plurality of beacons II and/or individual ones of the hanging bags 5 located in the hanging bag storage 1 to an addressee 215. In this exemplary embodiment, the addressee 215 is also an addressed one of the hanging bags 5, for which the message 217 is intended, or by which the message is sent. One of the storage articles 3 can be received in the addressed one of the hanging bags 5 and/or in the addressee 215. For example, the communication path A can be used to send an instruction as to how to proceed with the storage article, in particular where the storage article is to be expected and/or transported. These tasks can then be taken over by the hanging bag 5 itself.

The involvement of the hanging bags 5 themselves as intermediaries enables a Meshnet to be formed and each individual one of the hanging bags 5 to be electively communicated with.

Particularly preferably, only a single storage article 3 is located in each of the hanging bags 5, so that the hanging bags 5 can be fetched individually. This enables a maximally flexible and quick handling and/or sorting. Preferably, the beacons II are permanently arranged at switches and the beacons I at peripheries 211 of the level 9. This enables a route formation for the communication path A to be simplified.

The communication path B extends from the central control device 25 through a second communication configuration 203 via a beacon III, using relatively short, preferably bidirectional, radio links, in particular of a few meters, in particular less than 10 meters, for example according to the BLE standard, to the addressee 215.

Preferably, the circular conveying plants 23 of the hanging bag storage 1 each comprise one of the beacons III per level 9, 13. This enables a retrieval, sorting and/or buffering as well as a handover from the level 9 into the circular conveying plant 23, i.e. preferably simultaneously a sorting of the hanging bags 5 and/or the storage articles 3 received therein. It is possible to communicate with and thus coordinate all hanging bags 5 located within a range of the respective beacon III quasi simultaneously with time multiplexing after a handshake via respectively one route 213, preferably radio link. Corresponding messages from and to the respective addressee 215 may also contain instructions for a relocating to a new location inside the hanging bag storage 1. Preferably, identically structured messages 217 for coordinating the hanging bags 5 are transmitted using the communication paths A and B, so that the controllers of the hanging bags 5 merely process different transmission protocols of the communication paths A and B but can be designed for only one type of messages.

It is conceivable to use the communication path B also bilaterally between at least two of the hanging bags 5, i.e. without an involvement of the central control device 25. This additionally enables the transmitting power density in the hanging bag storage 1 to be reduced, as this task thereby does not run through the central control device 25.

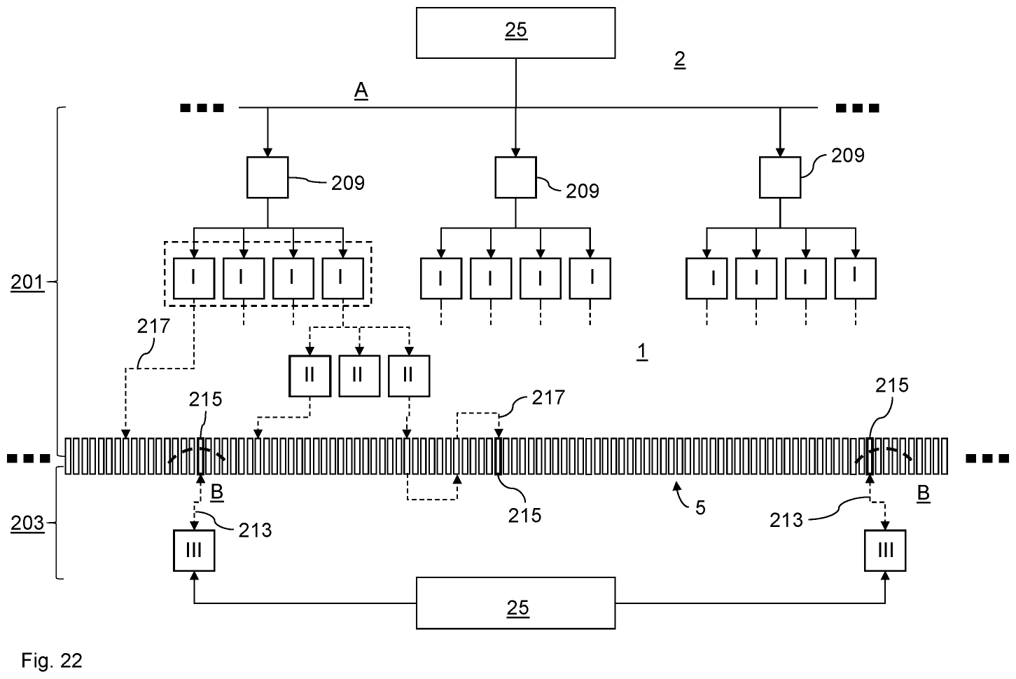

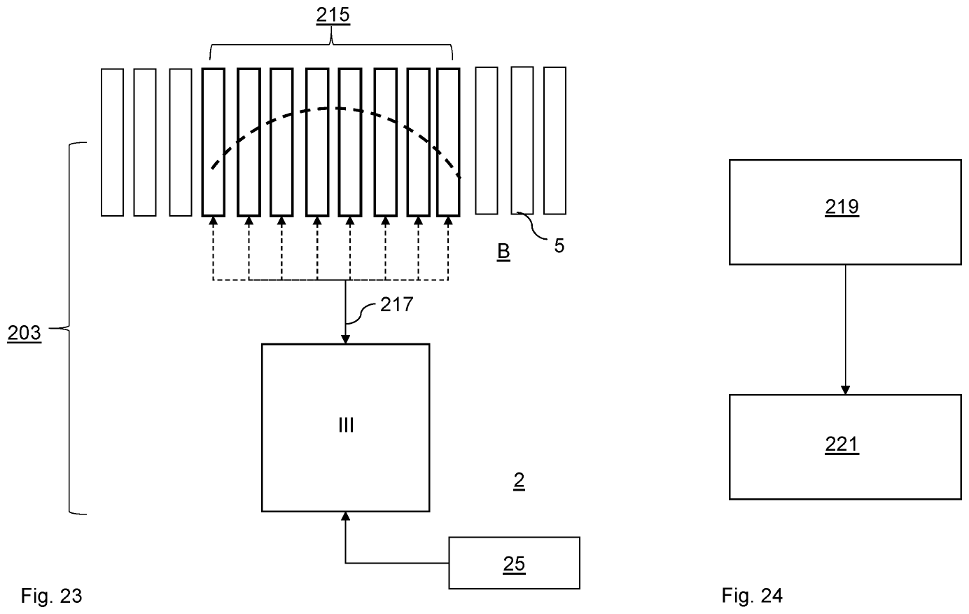

FIG. 22 shows a tree diagram of a hierarchical structure of the first and second communication configurations 201 and 203 to illustrate the thereby enabled communication paths A and B. FIG. 23 shows a partial view of the tree diagram shown in FIG. 22 with the communication path B.

In FIGS. 22 and 23, preferably hard-wired routes 213 are symbolized by solid lines and arrows and radio-based routes 213 by dashed lines and arrows.

The first communication configuration is segmented into five layers.

On a top first layer, the central control 25 is located, downstream of which a plurality of the intermediate controllers 209 is arranged.

The intermediate controllers 209 are interconnected, preferably in a wired manner, in a second layer. For example between two and 100 pieces, preferably approximately five pieces per level of the hanging bag storage 1. Preferably, the intermediate controllers 209 are equipped with an independent computing unit and/or computing capacity. The independent computing unit and/or computing capacity can be configured as a standard component. Therefore, tasks for the route formation, new route formation if a formed communication path A is disrupted, and/or control of the communication in the intermediate controllers 209 can be outsourced in order to unburden the central control device 25.

In a third layer subordinate to the second layer, a plurality of the beacons I is arranged. Here, preferably four of the beacons I are arranged downstream of respectively one of the intermediate controllers 209. Here, it is possible that the four combined beacons I are accommodated in a joint housing, which is indicated in FIG. 22 by a dashed rectangle. Further, it is conceivable to also accommodate the respective intermediate controller 209 in the housing. This means that four of the beacons I can be communicated with per intermediate controller 209.

The third layer enables a plurality of subordinate beacons II to be communicated with per beacon I, which plurality of subordinate beacons II are arranged in a fourth layer to that end. The communication from the first layer to the third layer is preferably wired, wherein preferably the components of the first, second and third layers are mounted on the hanging bag storage 1, preferably at the peripheral region 211, so as to be stationary.

As another particularity, the beacons II of the fourth layer are preferably also installed in or on the hanging bag storage 1 so as to be stationary, preferably inside or at crossings, preferably at transitions between a storage area and routes, in particular shunting routes for rearranging the hanging bags 5 and/or express routes for a faster transporting of the hanging bags 5.

Although the beacons II are preferably configured generally identically to each of the hanging bags 5 and the beacons I for setting up the respective communication path A, they are hierarchically arranged downstream of and/or communicated with exclusively only by a particular one of the beacons I. This takes place using the respective radio-based routes 213. The stationary assigning has the advantage that the route formation for the communication path A to one of the beacons II is always specified according to the hierarchy of the layers one to four and/or specifiable by an algorithm so as to be dynamic and/or self-learning. Preferably, the beacons and the hanging bags 5 are equipped with identical hardware units, wherein the respective function, in particular the routing of the messages 217, can be executed dynamically by a corresponding device and/or programming, in particular so as to be self-learning and/or self-optimizing. Therefore, any route of a message across the five layers is generally conceivable, however, useful routes will become apparent in the course of the use, which can then be used preferably and in particular extend via the stationary beacons I and II. Also these routes can depend on a location of the addressee 215 but are then respectively identical per location in the course of the learning operation, which saves resources with respect to routing and enables optimized routes for the respective messages 217.

Only in a fifth layer is the route formation and/or the routing for transmitting the message 217 completely free, in particular dependent on the respective location of the addressee 215 inside the hanging bag storage 1 per routing operation, and can be directed to the addressee 215 using any number of other ones of the hanging bags 5, which is marked by way of example for a message 217 in FIG. 22, wherein the message 217 is transmitted using two other ones of the hanging bags 5.

The segmentation of the first communication configuration 201 into a hard-wired part—layers one to three—a part comprising specified communication subroutes at least after a learning operation—layers one to four—and a part that is free in relation to the route formation—layer five—enables a particularly high number of the hanging bags 5 to be addressed at any location of the hanging bag storage 5 with a particularly low transmitting power density independent of location. Here, the transmitting power density is relatively low, as many short routes 213 are used and/or are structured partially hard-wired and partially flexibly for transmitting the respective message 217.

According to one possible alternative, it is conceivable to send messages directly from the third layer as required, i.e. from one of the beacons I directly to an addressee 215, i.e. directly to the fifth layer, bypassing the fourth layer, which is indicated on the left in FIG. 22. This can be limited to exceptions in which the addressee 215 is located particularly close to one of the beacons I.

The second communication configuration 203 is subdivided into three layers, wherein the first layer also comprises the central control device 25, i.e. matches the first layer of the communication path A and/or of the first communication configuration 201.

Arranged downstream of and/or subordinate to the first layer, a second layer of the second communication configuration 203 comprises at least one, preferably a plurality of, the beacons III, in particular respectively one per circular conveying plant 23 per level 9, 13, for example between two and 100 pieces, preferably approximately 10 pieces per circular conveying plant 23.

The hanging bags 5 and/or the addressees 215 are arranged in a third layer of the second communication configuration 203, wherein the third layer of the second communication configuration 203 matches the fifth layer of the first communication configuration 201.

The beacons III of the second layer of the second communication configuration 203 are arranged hard-wired downstream of the control device 25. The hanging bags 5 and/or the addressees 215 are communicated with directly by the second layer as soon as the hanging bags 5 and/or the addressees 215 are located within a range of the respective beacon III, which is indicated in FIGS. 22 and 23 by a partial circle line represented by dashed lines.

In FIG. 23, six of the hanging bags 5 are within the range of the beacon III by way of example, which is indicated by bold print. Here, the beacon III can communicate and exchange messages 217 with all six of the hanging bags 5 quasi simultaneously and/or in a time multiplexed manner.

FIG. 24 shows a flow chart of a method for operating a hanging bag storage equipped with at least partially autonomously or autonomously displaceable hanging bags.

In a first step 219, the hanging bags 5 are moved and/or displaced at least partially autonomously or autonomously on the network 49. The messages 217 can comprise destinations for controlling the at least partially autonomous traveling, which can be handed over, preferably wirelessly, to the addressees 215 in a second step 221, which then travel partially autonomously or autonomously toward these destinations. The messages 217 can electively be handed over using the communication path A or the communication path B independent thereof, in particular depending on a task and/or location in the hanging bag storage 1.

It is electively conceivable to execute a handshake as soon as a respective one of the hanging bags 5 is within a range of one of the beacons III and take over the control of the respective one of the hanging bags 5 using the communication path B, in particular for executing a sorting operation, retrieval operation and/or storage operation of the hanging bag storage 1 using this communication path B.

Further, it is conceivable to use the second transceiving devices 207 of the hanging bags 5 configured for the communication path B additionally for a travel dynamic control, a distance control and/or collision avoidance among one another.

It should be understood that this description may be subject to various modifications, alterations and adaptations which are within the range of equivalents of the appended claims.

List of reference numbers

| | | | |
|---|---|---|---|
| 1 | hanging bag storage | 60 | series |
| 3 | storage article | 62 | storage route |
| 5 | hanging bag | 64 | other storage route |
| 7 | first handover buffer | 66 | shunting route |
| 9 | first level | 68 | other shunting route |
| 10 | handover configuration | 70 | retrieval path |
| 11 | second handover buffer | 72 | express route |
| 13 | second level | 74, 78, 80, 86 | arrow |
| 15 | sequence | 76 | block |
| 17 | series | 82 | additional storage route |
| 19 | storage location | 84 | convoy |
| 21 | sequencing criterion | 88 | double arrow |
| 23 | circular conveying plant | 90 | first step |
| 25 | control device | 92 | second step |
| 27 | line | 94 | third step |
| 29 | first step | 96 | fourth step |
| 31 | second step | 98 | fifth step |
| 33 | third step | 101 | express track |
| 35 | fourth step | 103 | express circular conveying plant |
| 37 | fifth step | 105 | express handover configuration |
| 39 | sixth step | 107 | packing unit |
| 41 | seventh step | 109 | express handover buffer |
| 43 | eighth step | 111 | arrow |
| 45 | ninth step | 113 | express unloading station |
| 47 | query | A | communication path |
| 49 | network | B | communication path |
| 51 | double arrow | I, II, III | beacon |
| 53 | handover point | 201 | first communication |
| 55 | unloading station | | configuration |
| 57 | wheels | 203 | second communication |
| 59 | drive energy | | configuration |
| 61 | roll adapter | 205 | first transceiving device |
| 50 | stopping point | 207 | second transceiving device |
| 52 | exit | 209 | intermediate controller |
| 54 | entry | 211 | peripheral region |
| 56 | closed route | 213 | route |
| 58 | stopping point | 215 | addressee |
| 217 | message | 339 | exit rail |
| 219 | first step | 341 | subsequence |
| 221 | second step | 343 | hanging bag |
| 317 | first in, first out buffer | 345 | junction |
| 319 | pick buffer | 361 to 377 | arrow |
| 321 | reciprocating track | 379 to 393 | steps |
| 329 | first end position | 395 | arrow |
| 331 | second end position | 479 to 493 | steps |
| 333 | branch-off | 690 | first step |
| 335 | section of rail | 692 | second step |
| 337 | entry rail | 694 | third step |

1. A hanging bag storage system for storing, picking, sorting and retrieving storage articles, comprising:
a control device, by which the storing, picking and sorting of the storage articles can be controlled and/or a sequence of the storage articles for a retrieval of the storage articles can be specified,
a plurality of roll adapters, and hanging bags suspendible or suspended on the roll adapters, wherein the roll adapters or the hanging bags each comprise a cotraveling longitudinal and transverse dynamics control and a communication device and wherein at least one of the storage articles, respectively, can be received and retrieved again in the hanging bags,
a hanging bag storage, which cooperates with the plurality of hanging bags for storing, picking and sorting the storage articles, with:
a level, and
a network, on which the hanging bags can be displaced autonomously or at least partially autonomously using the respective cotraveling longitudinal and transverse dynamics control,
at least one block, into which the hanging bags can be deposited, stored without movement using the cotraveling longitudinal and transverse dynamics control and in a manner controlled by the control device, and fetched again for the retrieval by a fetch command which can be received by the communication device.

2. The hanging bag storage system according to claim 1, wherein the fetch command can be sent to the communication device of the respective hanging bag by the control device using a route or a wireless route.

3. The hanging bag storage system according to claim 1, wherein:
at least one second level, in which the hanging bags and thus the storage articles can be received, respectively, wherein the hanging bags with the storage articles can be provisioned in the respective level of the hanging bag storage for the imminent retrieval or in a respective subsequence, and
a conveying plant, vertical conveying plant and/or circular conveying plant arranged between the levels for conveying the storage articles between the levels.

4. The hanging bag storage system according to claim 1, wherein the network, or the block of the network, is designed so as to be horizontal.

5. The hanging bag storage system according to claim 3, wherein the specifiable or specified sequence of the storage articles for the retrieval can be created and/or is created across the level and the at least one second level using at least five elements of the hanging bag storage of the following group:
at least one of the blocks arranged in the level,
at least another one of the blocks arranged in the at least one second level,
at least one handover configuration for creating and provisioning the hanging bags for the retrieval in a subsequence of the handover configuration of the level, and/or which is arranged downstream of the one of the blocks,
at least one second handover configuration arranged in the at least one second level for creating and provisioning the hanging bags for the retrieval in a subsequence of the second handover configuration of the second level, and/or which is arranged downstream of the at least one other one of the blocks,
the conveying plant, vertical conveying plant and/or circular conveying plant arranged between the levels and/or arranged downstream of the handover configurations for conveying the storage articles between the levels.

6. The hanging bag storage system according to claim 5, wherein the sequence can be created and/or put together and/or assembled from the subsequences of the provisioning devices using the conveying plant, vertical conveying plant and/or circular conveying plant.

7. The hanging bag storage system according to claim 1, wherein the hanging bags are configured for being brought into a power-saving rest state in the at least one block.

8. The hanging bag storage system according to claim 1, wherein the block of the hanging bag storage comprises at least one or a plurality of closed routes, wherein the closed routes can be endlessly traveled on by the hanging bags or by the roll adapters with suspended hanging bags, an entry or the entry and an exit as well as a stopping point or an imaginary stopping point, at which one of the hanging bags can be stopped and/or be provisioned for a leaving of the closed routes depending on the control device and all other hanging bags in the respective closed route can also be stopped only depending on the state of the one of the hanging bags or only depending on the state of the one of the hanging bags and on respectively cotraveling longitudinal dynamics control of the roll adapters of the other hanging bags.

9. The hanging bag storage system according to claim 8, wherein the hanging bags or roll adapters with suspended hanging bags located in the block are configured for taking the states of the following group and comprise at least one of them in the block:
stored without movement by halting if a front hanging bag blocks the network of the block depending on the cotraveling longitudinal dynamics control,
stored without movement and halted at the stopping point or the imaginary stopping point depending on the non-cotraveling control device and/or stopped and provisioned there for leaving the closed route,
ready to receive from the non-cotraveling control device,
addressed for a retrieval operation depending on the non-cotraveling control device,
in motion for entering the closed route depending on the non-cotraveling control device,
in motion for leaving the closed route,
in motion for leaving the stopping point or the imaginary stopping point depending on the non-cotraveling control device,
supplied with an electrical energy,
in motion for the endless traveling on the closed route after the entering only depending on the cotraveling longitudinal and transverse dynamics control.

10. The hanging bag storage system according to claim 8, wherein the imaginary stopping point can be transmitted to the roll adapter as a destination point of an intermediate travel instruction or can be transmitted to the roll adapter as a destination point of the intermediate travel instruction using the control device and/or the stopping point is part of the network and can be controlled by the control device, and/or wherein the exit has a distance that is as great as possible, preferably a maximal distance, downstream of the entry and a distance that is as small as possible, preferably a minimal distance to the entry, upstream.

11. The hanging bag storage system according to claim 8, wherein the closed route comprises a storage route, a shunting route crossing the storage route, another storage route crossing the shunting route, and another storage route.

12. A roll adapter for a hanging bag, which cooperates with a hanging bag storage system according to claim 8, wherein the longitudinal dynamics control of the roll adapter comprises a distance control, which controls a speed of the roll adapter depending on an object and/or front roll adapter located in front of the roll adapter viewed in a direction of travel and/or controls a distance to the other roll adapter, and/or
regulates the speed to zero if the front roll adapter has a speed of zero and an actual distance of the roll adapter to the front roll adapter is below a specifiable or specified minimum distance.

13. The roll adapter according to claim 12, wherein the roll adapter has at least one of the following states and/or one of the following states can electively be taken by the roll adapter:
automatic halting or decelerating if the front roll adapter blocks the network,
storing an endless travel instruction for a specified or specifiable closed route and/or endless traveling on the specified or specifiable closed route,
halting at a specifiable or specified stopping point of the closed route or halting at the stopping point depending on the controller,
leaving the closed route, preferably starting from the stopping point, in a direction of a specifiable or specified destination point depending on the controller or crossing one of the shunting routes and/or turning into one of the express routes for leaving the closed route, or
entering the closed route depending on the control device.

14. A method for controlling a hanging bag storage system with a roll adapter, comprising:
entering a closed route by a roll adapter,
transmitting an endless travel instruction to the roll adapter which says that the closed route is to be traveled on endlessly,
endless traveling on the closed route,
transmitting a retrieval travel instruction to a retrieval destination to the roll adapter for a retrieval, and
leaving the closed route and traveling toward the retrieval destination according to the retrieval travel instruction for the retrieval of the roll adapter.

15. The method according to claim 14, including at least one of:
interrupting the endless traveling if the front roll adapter is located in front of the roll adapter and has a speed of zero,
resuming the endless traveling if the front roll adapter has a speed greater than zero again.

16. The method according to claim 14, including at least one of:
scheduling the roll adapter for the retrieval,
transmitting a intermediate travel instruction to the scheduled roll adapter with a stopping point as a destination,
moving the roll adapter to the stopping point,
halting the roll adapter at the stopping point.

17. The method according to claim 14, including at least one of:
scheduling the roll adapter for a retrieval,
transmitting a retrieval travel instruction to a retrieval destination to the scheduled roll adapter after transmitting an intermediate travel instruction,
leaving a stopping point and then leaving the closed route while traveling toward the retrieval destination according to the retrieval travel instruction.

18. The method according to claim 14, including at least one of:
transmitting an intermediate travel instruction to a random roll adapter traveling on the closed route if no scheduling for the retrieval has been or is currently being executed, and/or
transmitting the intermediate travel instruction to a stopping point as a destination, and/or
transmitting the endless travel instruction to the random roll adapter if the roll adapter is scheduled for the retrieval, and/or
leaving the stopping point by the random roll adapter, and/or
endless traveling on the closed route with the random roll adapter according to the endless travel instruction.

19. The method according to claim 14, including at least one of:
repeating the method for a plurality of retrievals,
transmitting the intermediate travel instruction to the random roll adapter traveling on the closed route or to the roll adapter scheduled for the retrieval,
transmitting the endless travel instruction to all remaining roll adapters traveling on the closed route.

20. A method for retrieving storage articles from a hanging bag storage having hanging bags or a hanging bag storage of a hanging bag storage system according to claim 1, including at least one of:
provisioning a first handover buffer in a first level of the hanging bag storage,
provisioning at least one second handover buffer in a second level of the hanging bag storage,
specifying a sequence of the storage articles for an imminent retrieval,
provisioning the storage articles in the handover buffers of the respective level of the hanging bag storage for the imminent retrieval,
provisioning a series of storage locations for receiving at least one of the storage articles,
directing the series of storage locations past the handover buffers while
handing over the storage articles provisioned in the handover buffers from the respective handover buffer into the storage locations and in the specified sequence, respectively.

21. The method according to claim 20, including at least one of:
assigning ordinal sequencing criteria of the sequence to the empty storage locations of the series,
assigning the same sequencing criteria to the individual storage articles,
sorting the storage articles into the series when being directed past as soon as the sequencing criteria of a storage location traveling past and of the storage article waiting in the respective handover buffer match.

22. The method according to claim 21, further comprising:
presorting the storage articles waiting in the respective handover buffers according to the ordinal sequencing criteria.

23. The method according to claim 20, including at least one:
provisioning the storage articles respectively located in one of the hanging bags of the hanging bag storage,
handing over the entire hanging bag along with the respective storage article from the respective handover buffer into the storage locations, and/or
autonomous driving, controlling and/or moving of the entire hanging bag before the provisioning, during the provisioning and/or handing over of the hanging bag.

24. The method according to claim 20, further comprising:
interlinking the series using a circular conveying plant.

25. The method according to claim 24, wherein:
vertically conveying the series using the circular conveying plant, and
arranging the handover buffers on top of one another in the levels of the hanging bag storage.

26. The method according to claim 20, including at least one of:
handing over more than one of the storage articles from the respective handover buffer into the corresponding one of the storage locations of the series, and/or
presorted handing over of the more than one of the storage articles.

27. A hanging bag storage system, configured, designed and/or programmed for executing a method according to claim 20.

28. The hanging bag storage system according to claim 27, including at least one of:
a first handover buffer in a first level of the hanging bag storage,
at least one second handover buffer in a second level of the hanging bag storage, wherein the storage articles can be provisioned for an imminent retrieval in the handover buffers of the respective level of the hanging bag storage,
a control device, by which a sequence of the storage articles provided for the retrieval can be specified,
a circular conveying plant for provisioning a series of storage locations for receiving at least one of the storage articles, wherein the series of storage locations can be directed past the handover buffers while the storage articles provisioned in the handover buffers can be handed over into the storage locations from the respective handover buffer and in the specified sequence, respectively.

29. The hanging bag storage system according to claim 28, wherein the hanging bags along with the storage articles located therein can be received and transported using the circular conveying plant, wherein the handover buffers are arranged in an imaginary line to one another, preferably in a vertical line.

30. A handover configuration for retrieving storage articles from a hanging bag storage of a hanging bag storage system, which hanging bag storage has hanging bags, according to claim 1, including at least one of:
a first in, first out buffer arranged downstream of the hanging bag storage for receiving the storage articles,
a pick buffer arranged downstream of the first in, first out buffer for receiving the storage articles from the first in, first out buffer,
a handover buffer arranged downstream of the first in, first out buffer for removing the storage articles from the pick buffer in a specified sequence and for provisioning the storage articles for a removal from the hanging bag storage.

31. The handover configuration according to claim 30, wherein a preferably vertically conveying conveying plant, for removing the storage articles from the hanging bag storage is arranged downstream of the handover buffer.

32. The handover configuration according to claim 30, wherein the pick buffer comprises a reciprocating track, on which the storage articles can be slidably relocated between two end positions, wherein the reciprocating track has a branch-off ending in the handover buffer between the two end positions.

33. The handover configuration according to claim 32, wherein the first in, first out buffers comprise sections of rails arranged in parallel, in which respectively one entry rail of a level of the hanging bag storage or entry rail of the hanging bag storage adjoining the level ends at the input side and ends in a joint exit rail at the output side, wherein the joint exit rail comprises the reciprocating track between the end positions of the pick buffer.

34. A method for retrieving storage articles from a hanging bag storage of a hanging bag storage system, which hanging bag storage has hanging bags, according to claim 1, including at least one of:
provisioning a first in, first out buffer arranged downstream of the hanging bag storage,
presorted receiving of the storage articles from the hanging bag storage in the first in, first out buffer,
provisioning a pick buffer arranged downstream of the first in, first out buffer,
complete or at least partial receiving of the storage articles buffered in the first in, first out buffer in the presorted state in the pick buffer,
provisioning a handover buffer arranged downstream of the pick buffer,
picking out the storage articles stored in the pick buffer into the handover buffer in the specified or specifiable sequence.

35. The method according to claim 34, including at least one of:
provisioning a preferably vertically conveying conveying plant, arranged downstream of the handover buffer,
removing the storage articles from the hanging bag storage by handing over the storage articles into the conveying plant.

36. The method according to claim 34, wherein:
relocating the storage articles between two end positions inside the pick buffer while
removing and handing over respectively one of the storage articles into the handover buffer for creating the sequence.

37. The method according to claim 34, including at least one of:
specifying the sequence,
assigning the sequence to the storage articles,
subdividing the sequence into subsequences,
unsorted depositing of all storage articles of one of the subsequences in the first in, first out buffer for presorting the storage articles.

38. A hanging bag storage system, configured, designed and/or programmed for executing a method according to claim 34.

39. The hanging bag storage system according to claim 38, wherein the hanging bag storage has a plurality of the handover configurations which are arranged on top of one another upstream of a joint, for removing the storage articles from the hanging bag storage.

40. The hanging bag storage system according to claim 1 for storing storage articles received in hanging bags, with a hanging bag storage including at least one of:
a handover configuration for sorting and handing over the storage articles located in the hanging bags in a specified or specifiable sequence,
a preferably vertically conveying conveying plant arranged downstream of the handover configuration for removing the storage articles received in the hanging bags from the handover configuration in the sequence,
an express track for retrieving individual ones of the storage articles independent of the specified or specifiable sequence.

41. The hanging bag storage system according to claim 40, wherein a vertically conveying other conveying plant arranged downstream only of the express track for transporting away the storage articles coming from the express track independent of the sequence.

42. The hanging bag storage system according to claim 40, wherein the express track is arranged upstream of the conveying plant, or is arranged upstream of the conveying plant as required, for transporting away the storage articles coming from the express track independent of the sequence.

43. The hanging bag storage system according to claim 40, wherein the handover configuration itself comprises the express track.

44. The hanging bag storage system according to claim 42, wherein the handover configuration comprises a first in, first out buffer arranged downstream of the hanging bag storage for receiving the storage articles, a pick buffer arranged downstream of the first in, first out buffer for receiving the storage articles from the first in, first out buffer and a handover buffer arranged downstream of the first in, first out buffer for removing the storage articles from the pick buffer in a specified sequence and for provisioning the storage articles for a removal from the hanging bag storage, wherein the first in, first out buffer, the handover buffer and/or the pick buffer comprise the express track as required and/or can be temporarily emptied and thereby used as the express track.

45. The hanging bag storage system according to claim 40, wherein the express track and the handover configuration are arranged in parallel.

46. A method for picking storage articles preferably received in hanging bags using a hanging bag storage system according to claim 40, including at least one of:
provisioning a handover configuration arranged downstream of the stored storage articles,
receiving a plurality of the storage articles in the handover configuration,
sorting the plurality of the received storage articles into a specified or specifiable sequence using the handover configuration,
selecting at least one other one of the storage articles,
at least partially or completely bypassing the plurality of the storage articles received in the handover configuration, and
directly picking the selected at least one of the storage articles.

47. The method according to claim 46, including at least one of:
provisioning a downstream conveying plant,
receiving and conveying the storage articles from the handover configuration into the conveying plant for the direct picking of the selected at least one of the storage articles.

48. The method according to claim 46, including at least one of:
provisioning the conveying plant and an express conveying plant,
conveying the plurality of the storage articles sorted in the handover configuration using the conveying plant,
receiving and conveying the at least one of the storage articles using the express conveying plant for directly picking the selected at least one of the storage articles.

49. The method according to claim 46, including at least one of:
emptying at least one component of the handover configuration,
using the emptied at least one component as the express track or as an additional express track.

50. A method for operating a hanging bag storage of a hanging bag storage system according to claim 1 with storage articles received in hanging bags, including at least one of:
storing the storage articles received in the hanging bags in a series on a storage route of the hanging bag storage,
scheduling one of the storage articles of the series for a retrieval,
vacating a retrieval path for the scheduled one of the storage articles by
relocating other ones of the storage articles of the series into a shunting route of the hanging bag storage, and
retrieving the scheduled one of the storage articles along the vacated retrieval path.

51. The method according to claim 50, including at least one of:
reversing a direction of motion of the other ones of the storage articles of the series,
relocating the other ones of the storage articles of the series into the storage route in the reverse direction of motion.

52. The method according to claim 50, wherein:
encircling the storage route of the hanging bag storage with the other ones of the storage articles in the direction of motion,
relocating the other ones of the storage articles of the series into the storage route in the same direction of motion after the encircling.

53. The method according to claim 50, including at least one of:
circulating or reciprocating the other ones of the storage articles of the series using the storage route, the shunting route, another storage route adjoining the shunting route and another shunting route adjoining the storage route and other storage route, and/or
singling out the scheduled one of the storage articles during the circulating or reciprocating along the retrieval path vacated thereby.

54. The method according to claim 50, including at least one of:
crossing the shunting route with the scheduled one of the storage articles,
entering the express route by the scheduled one of the storage articles after the crossing, and/or
relocating the scheduled one of the storage articles from the retrieval path vacated on the storage route using the express route of the hanging bag storage, a handover buffer of the hanging bag storage and a preferably vertically conveying conveying plant for retrieving the scheduled one of the storage articles.

55. The method according to claim 50, including at least one of:
storing a plurality of identical ones of the storage articles distributed over the entire hanging bag storage,
selecting one of the storage articles from the plurality of identical ones of the storage articles,
scheduling the selected one of the storage articles as the one of the storage articles of the series for the retrieval.

56. The method according to claim 50, including at least one of:
repeating the method for a plurality of scheduled ones of the storage articles and in a plurality of levels of the hanging bag storage,
specifying a sequence for the plurality of the scheduled ones of the storage articles,
presorting the plurality of the scheduled ones of the storage articles in the handover buffers of the levels,
finally sorting the plurality of the scheduled ones of the storage articles in the sequence by
handing over the plurality of the scheduled ones of the storage articles from the handover buffers of the levels into the conveying plant, and/or
autonomously or at least partially autonomously traveling by the hanging bags of the hanging bag storage on a network of the hanging bag storage comprising the storage routes, shunting routes and the express route and/or the retrieval path.

57. The method according to claim 50, including at least one of:
putting the hanging bags autonomously or at least partially autonomously displaceable on the network into a sleep mode during the storage of the storage articles,
waking up the hanging bags for the autonomous or at least partially autonomous traveling and retrieving of the storage articles.

58. A hanging bag storage system, configured, designed and/or programmed for executing a method according to claim 50.

59. The hanging bag storage for storing and sorting storage articles which can be received in hanging bags according to claim 58, including at least one of:
a plurality of levels, each with:
a network, on which the hanging bags can be displaced autonomously or at least partially autonomously,
a plurality of routes of the network arranged in parallel for storing the storage articles received in the hanging bags,
at least one shunting route, in which the plurality of the storage routes end and/or circularly surrounds the plurality of the storage routes,
at least one express route, which is arranged downstream of the plurality of storage routes and/or of the at least one shunting route,
a handover buffer arranged downstream of the network and/or of the express route of the network for presorting the storage articles, a preferably vertically conveying conveying plant arranged downstream of the handover buffers of the levels for finally sorting the storage articles in a specified or specifiable sequence.

60. The hanging bag storage system according to claim 1 for storing and sorting storage articles which can be received in hanging bags, with a hanging bag storage including at least one of:
a network, on which the hanging bags can be displaced autonomously or at least partially autonomously, wherein the network comprises
at least one express route, which can be traveled on by the hanging bags in a direction-based manner and with priority,
at least one shunting route arranged parallel to the express route, which can temporarily be used for sorting tasks of the hanging bags,
a plurality of storage routes arranged at an angle to the express route and to the shunting route and adjoining the express route and the shunting route by a retrieval path for storing the storage articles received in the hanging bags in a series.

61. The hanging bag storage system according to claim 60, wherein the at least one storage route and the at least one express route are interconnected by a plurality of cross connections which can be traveled on by the hanging bags.

62. The hanging bag storage system according to claim 60, wherein respectively one of the shunting routes is arranged bilaterally of the at least one express route and the plurality of storage routes are arranged so as to abut on the respective one of the shunting routes and end in the respective one of the shunting routes at the angle, respectively.

63. The hanging bag storage system according to claim 60, wherein the hanging bag storage comprises a plurality of the express routes, which are arranged at an angle to one another and crossing one another, wherein the express routes are arranged grid-like and preferably with alternating specifications of the direction of motion to one another.

64. A method for operating a hanging bag storage system according to claim 60 with storage articles received in hanging bags, including at least one of:
storing the storage articles received in the hanging bags in a series on a storage route of the hanging bag storage,
scheduling one of the storage articles of the series for a relocating,
relocating the scheduled one of the storage articles, and
inserting the scheduled one of the storage articles into an additional storage route of the hanging bag storage in a specified or specifiable sequence.

65. The method according to claim 64, including at least one of:
vacating a retrieval path for the scheduled one of the storage articles by
relocating other ones of the storage articles of the series into a shunting route of the hanging bag storage,
relocating the scheduled one of the storage articles along the vacated retrieval path into the other storage route of the hanging bag storage.

66. The method according to claim 64, including at least one of:
repeating the method for a plurality of scheduled ones of the storage articles and for a plurality of other storage routes,
specifying a sequence for the plurality of the scheduled ones of the storage articles,
respectively inserting the plurality of the scheduled ones of the storage articles in the plurality of other storage routes according to the sequence.

67. The method according to claim 64, including at least one of:
crossing over or crossing the shunting route with the scheduled one of the storage articles,
entering the express route by the scheduled one of the storage articles after the crossing.

68. The method according to claim 64, including at least one of:
storing a plurality of identical ones of the storage articles distributed over the entire hanging bag storage,
selecting one of the storage articles from the plurality of identical ones of the storage articles,
scheduling the selected one of the storage articles as the one of the storage articles of the series for the sorting.

69. The hanging bag storage system according to claim 1 with at least partially autonomously or autonomously displaceable hanging bags, wherein:
a network, on which a plurality of hanging bags can be displaced autonomously or at least partially autonomously, characterized by:
a control device, by which the hanging bag storage can be controlled and/or monitored,
a first communication configuration, using which a communication path A between the control device and an addressee such as a random, individual one of the hanging bags can be set up,
a second communication configuration, using which another communication path B, which is independent of the communication path A, can be set up between the control device and the addressee.

70. The hanging bag storage system according to claim 69, wherein the communication configurations comprise at least one or a plurality of elements from the following group:
a hanging bag with a cotraveling first transceiving device configured for the communication path A and a cotraveling second transceiving device configured for the communication path B,
a control device for centrally controlling the hanging bag storage, generating, sending and/or receiving messages using the communication paths A and B,
a plurality of intermediate controllers, which are arranged downstream of the control device, each equipped with an independent computing capacity and configured for the communication path A,
a cluster of two to 10, preferably two to six, preferably four, beacons I, which are arranged downstream of one of the intermediate controllers and wherein the beacons I are respectively configured for the communication path A,
a cluster of two to 10, preferably two to six, preferably three, beacons II, which are arranged downstream of one of the beacons I and wherein the beacons I are configured for the communication path A, or
a plurality of beacons III, which are arranged downstream of the control device and configured for the communication path B.

71. The hanging bag storage system according to claim 69, wherein the communication path A from the control device to the addressee can be set up using
one of the intermediate controllers,
one of the beacons I,
one of the beacons II,
or directly from one of the beacons I, using which respectively one route to the addressee and/or the beacon II can be set up, and/or
a plurality of the hanging bags can be directed to the addressee, and, independent of that, the communication path B can be directed from the control device via one of the beacons III to the addressee, wherein the communication paths A and B have different communication protocols and/or routes and/or radio frequencies.

72. The hanging bag storage system according to claim 69, wherein the hanging bag storage is designed for and/or comprises at least 500,000 hanging bags, wherein the hanging bags can be electively addressed, communicated with and/or controlled by the control device by and using the two communication paths A and B.

73. The hanging bag storage system according to claim 69, wherein the beacons I, the beacons II and the hanging bags each comprise a first transceiving device configured for the communication path A, which are electively configured for receiving, sending or relaying messages, wherein a number of the transceiving devices used for transmitting an individual message via the communication path A is flexible.

74. The hanging bag storage system according to claim 69, wherein the intermediate controllers are arranged hard-wired downstream of the control device, the clusters of the beacons I are arranged hard-wired downstream of the respective intermediate controller, the clusters of the beacons II are arranged or arrangeable downstream of the respective beacon I using a preferably establishable one of the routes or hard-wired and the addressee can be addressed and/or communicated with using one of the beacons II or from the beacon II using any number of other ones of the hanging bags.

75. The hanging bag storage system according to claim 69, wherein the beacons III and the second transceiving devices of the hanging bags have Bluetooth Low Energy standard and the communication path B can be established according to this standard.

76. A method for operating a hanging bag storage of a hanging bag storage system, which hanging bag storage is equipped with at least partially autonomously or autonomously displaceable hanging bags according to claim 69, including at least one of:
at least partially autonomous traveling of the hanging bags,
wireless handing over of messages to the hanging bags for controlling the at least partially autonomous traveling using a communication path A and a communication path B independent thereof.

77. The method according to claim 76, including at least one of:
executing a handshake as soon as a respective one of the hanging bags is within a range of one of the beacons III,
taking over the control of the respective one of the hanging bags using the communication path B for executing a sorting operation, retrieval operation and/or storage operation of the hanging bag storage.

78. The method according to claim 76, further including:
additionally using the second transceiving devices of the hanging bags configured for the communication path B for a travel dynamic control, a distance control and/or collision avoidance among one another.
